(19) United States
(12) Patent Application Publication
(10) Pub. No.: US 2024/0255224 A1
(43) Pub. Date: Aug. 1, 2024

(54) APPARATUS AND METHOD FOR PRODUCTION OF HIGH PURITY COPPER-BASED ALLOYS

(71) Applicant: Doggone Investment Co. LLC, Los Angeles, CA (US)

(72) Inventor: Timothy Frederick Strelitz, Long Beach, CA (US)

(21) Appl. No.: 18/626,219

(22) Filed: Apr. 3, 2024

Related U.S. Application Data
(63) Continuation-in-part of application No. 18/295,752, filed on Apr. 4, 2023.
(60) Provisional application No. 63/494,442, filed on Apr. 5, 2023.
(60) Provisional application No. 63/362,509, filed on Apr. 5, 2022.
(60) Provisional application No. 63/387,076, filed on Dec. 12, 2022.

(51) Int. Cl. F27B 3/22; C22B 9/05; C22C 1/02; F27B 3/20; F27D 7/02

(52) U.S. Cl. CPC F27B 3/22; C22B 9/05; C22C 1/02; F27D 7/02; F27B 3/205

(57) ABSTRACT

In an aspect, a method of manufacturing a high purity copper-based alloy comprises providing in a melting furnace a feedstock and melting the feedstock. The method additionally includes bubbling an inert gas into the molten copper-based alloy to form the high purity copper-based alloy. Aspects are also directed to an apparatus and a method of fabricating an apparatus for manufacturing the high purity copper-based alloy.

### CROSS-REFERENCE TO RELATED APPLICATIONS

This application claims the benefit of priority to U.S. Provisional Patent Application No. 63/494,442, filed Apr. 5, 2023, and is a continuation-in-part of U.S. application Ser. No. 18/295,752, filed Apr. 4, 2023, which claims the benefit of priority to U.S. Provisional Patent Application No. 63/362,509, filed Apr. 5, 2022, and to U.S. Provisional Patent Application No. 63/387,076, filed Dec. 12, 2022. The content of each of these applications is hereby incorporated by reference herein in its entirety.

### BACKGROUND

### Field

The disclosed technology relates generally to apparatuses and methods for manufacturing copper-based alloys, and more particularly to apparatuses for manufacturing high purity copper-based alloys with reduced impurities.

### Description of the Related Art

Copper can be alloyed with various elements to possess various properties of utility, including high toughness, high ductility, high thermal conductivity, high electrical conductivity and high corrosion resistance, to name a few. Because of these properties, copper-based alloys find many applications. For example, some copper-based alloys find uses in electrical components, fittings, locks, door handles, etc. Other copper-based alloys find uses in architecture, springs, connectors, terminals etc. Some uses of copper-based alloys demand improved mechanical and chemical properties.

### SUMMARY

For purposes of summarizing the disclosure and the advantages achieved over the prior art, certain objects and advantages of the disclosure are described herein. Not all such objects or advantages may be achieved in any particular embodiment. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments will become readily apparent to those skilled in the art from the following detailed description of the preferred embodiments having reference to the attached figures, the invention not being limited to any particular preferred embodiment(s) disclosed.

In one aspect, an apparatus for manufacturing a copper-based alloy comprises an enclosed melting furnace configured to form a molten copper-based alloy comprising at least 50 weight % copper under an enclosed inert atmosphere and to bubble an inert gas through the molten copper-based alloy. The apparatus additionally comprises a transfer ladle configured to receive the molten copper-based alloy from the melting furnace under the enclosed inert atmosphere and to transfer the molten copper-based alloy into one or more molds or a shot pit configured to solidify the molten copper-based alloy.

In another aspect, an apparatus for manufacturing a copper-based alloy comprises an enclosed melting furnace configured to form a molten copper-based alloy comprising at least 50 weight % copper under an enclosed inert atmosphere and to bubble an inert gas through the molten copper-based alloy. The apparatus additionally comprises a transfer ladle configured to receive the molten copper-based alloy from the melting furnace through a velocity control element, and to transfer the molten copper-based alloy into one or more molds or a shot pit configured to solidify the molten copper-based alloy.

In another aspect, a method of manufacturing a copper-based alloy comprises providing in a melting furnace a plurality of feedstock pieces having a combined composition configured to form a molten copper-based alloy comprising at least 50 weight % copper. The method additionally includes flowing an inert gas through gaps between the feedstock pieces prior to heating and heating the feedstock pieces while flowing the inert gas therethrough, thereby melting the feedstock pieces to form the molten copper-based alloy. The method additionally includes bubbling the inert gas through the molten copper-based alloy. The method further includes transferring the molten copper-based alloy into a transfer ladle.

In another aspect, a method of manufacturing a copper-based alloy comprises providing in a melting furnace a plurality of feedstock pieces having a combined composition configured to form a molten copper-based alloy comprising at least 50 weight % copper. The method additionally includes heating the feedstock pieces to form the molten copper-based alloy. The method additionally includes bubbling the inert gas through the molten copper-based alloy. The method further includes transferring the molten copper-based alloy into a transfer ladle. One or more of heating the feedstock pieces, bubbling the inert gas and transferring the molten copper-based alloy is performed at least partly under an enclosed inert atmosphere configured to substantially exclude outside ambient air from mixing with the enclosed inert atmosphere.

In another aspect, a method of manufacturing a copper-based alloy comprises providing in a melting furnace a plurality of feedstock pieces having a combined composition configured to form a molten copper-based alloy comprising at least 50 weight % copper. The method additionally includes heating the feedstock pieces to form the molten copper-based alloy. The method additionally includes bubbling the inert gas through the molten copper-based alloy. The method further includes transferring the molten copper-based alloy into a transfer ladle, wherein transferring comprises limiting a velocity of the molten copper-based alloy that is transferred from the melting furnace to the transfer ladle to less than 100 in/sec.

In another aspect, an apparatus for manufacturing a copper-based alloy comprises a melting furnace configured to form a molten copper-based alloy comprising at least 50 weight % copper. The melting furnace comprises a diffusive lining comprising an aluminum-silicate ceramic having a porous structure adapted for bubbling an inert gas through the molten copper-based alloy.

In another aspect, an apparatus for manufacturing a copper-based alloy comprises a melting furnace configured to form a molten copper-based alloy comprising at least 50 weight % copper. The melting furnace comprises a diffusive lining substantially covering a bottom inner surface thereof and having a porous structure adapted for bubbling an inert gas into the molten copper-based alloy.

In another aspect, an apparatus for manufacturing a copper-based alloy comprises a melting furnace configured to form a molten copper-based alloy comprising at least 50 weight % copper. The melting furnace comprises a diffusive lining having a porous structure. The diffusive lining is formed on at least two different inner surfaces of the melting furnace such that the diffusive lining is adapted for bubbling an inert gas into the molten copper-based alloy from the at least two different inner surfaces.

In another aspect, a method of manufacturing an apparatus for fabricating a copper-based alloy comprises providing a melting furnace chamber configured to form a molten copper-based alloy comprising at least 50 weight % copper. The method additionally comprises forming a diffusive lining on an inner surface of the melting furnace chamber, the diffusive lining comprising an aluminum-silicate ceramic material having a porous structure adapted for bubbling an inert gas through the molten copper-based alloy.

In another aspect, a method of manufacturing an apparatus for fabricating a copper-based alloy comprises providing a melting furnace chamber configured to form a molten copper-based alloy comprising at least 50 weight % copper. The method additionally comprises forming a diffusive lining substantially covering a bottom inner surface of the melting furnace and having a porous structure adapted for bubbling an inert gas into the molten copper-based alloy.

In another aspect, a method of manufacturing an apparatus for fabricating a copper-based alloy comprises providing a melting furnace chamber configured to form a molten copper-based alloy comprising at least 50 weight % copper. The method additionally comprises forming a diffusive lining having a porous structure on at least two different inner surfaces of the melting furnace such that the diffusive lining is adapted for bubbling an inert gas into the molten copper-based alloy from the at least two different inner surfaces.

In another aspect, a method of manufacturing an apparatus for fabricating an alloy comprises providing a melting furnace chamber and disposing a compacted powder layer on an inner surface of the melting furnace chamber. The compacted powder comprises a mixture of silica and alumina. The method additionally comprises sintering the compacted powder in the melting furnace to form a diffusive lining on the inner surface. The diffusive lining comprises an aluminum-silicate ceramic material having a porous structure adapted for diffusing gas therethrough.

In another aspect, a method of manufacturing an apparatus for fabricating an alloy comprises providing a melting furnace chamber and disposing a compacted powder layer on an inner surface of the melting furnace chamber. The method additionally comprises selectively sintering a surface portion of the compacted powder, thereby forming a diffusive lining on the inner surface comprising a sintered ceramic layer on an unsintered ceramic layer.

In another aspect, a method of manufacturing an apparatus for fabricating an alloy comprises providing a melting furnace chamber and disposing a compacted powder layer on an inner surface of the melting furnace chamber. The method additionally comprises sintering the compacted powder using heat from a heated material disposed in the melting furnace chamber, thereby forming a diffusive lining on the inner surface.

In another aspect, a method of manufacturing a copper-based alloy comprises providing in a melting furnace a feedstock having a composition configured to form a molten copper-based alloy comprising at least 50 weight % copper and heating the feedstock to melt the feedstock to form the molten copper-based alloy. The method additionally includes bubbling an inert gas into the molten copper-based alloy using a diffusive lining formed on an inner surface of the melting furnace chamber. The diffusive lining comprises an aluminum-silicate ceramic material having a porous structure adapted for bubbling the inert gas through the molten copper-based alloy.

In another aspect, a method of manufacturing a copper-based alloy comprises providing in a melting furnace a feedstock having a composition configured to form a molten copper-based alloy comprising at least 50 weight % copper and heating the feedstock to melt the feedstock to form the molten copper-based alloy. The method additionally includes bubbling an inert gas through the molten copper-based alloy using a diffusive lining formed in the melting furnace chamber. The diffusive lining substantially covers a bottom inner surface of the melting furnace and having a porous structure adapted for bubbling the inert gas into the molten copper-based alloy.

In another aspect, a method of manufacturing a copper-based alloy comprises providing in a melting furnace a feedstock having a composition configured to form a molten copper-based alloy comprising at least 50 weight % copper and heating the feedstock to melt the feedstock to form the molten copper-based alloy. The method additionally includes bubbling an inert gas through the molten copper-based alloy using a diffusive lining having a porous structure. The diffusive lining is formed on at least two different inner surfaces of the melting furnace such that the diffusive lining is adapted for bubbling the inert gas into the molten copper-based alloy from the at least two different inner surfaces.

In another aspect, an apparatus for manufacturing a copper-based alloy comprises a melting furnace configured to form a molten copper-based alloy comprising at least 50 weight % copper, wherein the melting furnace is configured to rotate around a central axis. The apparatus additionally comprises one or more diffuser blocks comprising a porous diffusing material adapted for bubbling an inert gas through the molten copper-based alloy.

In another aspect, an apparatus for manufacturing a copper-based alloy comprises a melting furnace configured to form a molten copper-based alloy comprising at least 50 weight % copper, wherein the melting furnace is configured to rotate around a central axis extending in a lengthwise direction of the melting furnace. The apparatus additionally comprises one or more diffuser blocks adapted for bubbling an inert gas through the molten copper-based alloy in a direction crossing the central axis.

In another aspect, an apparatus for manufacturing a copper-based alloy comprises a melting furnace configured to form a molten copper-based alloy comprising at least 50 weight % copper. The apparatus additionally comprises a flame injector configured to direct a stream of flame along a central axis of the melting furnace that serves as a heat source for forming the molten copper-based alloy. The apparatus further comprises one or more diffuser blocks comprising a porous structure adapted for bubbling an inert gas through the molten copper-based alloy.

In another aspect, a method of manufacturing a copper-based alloy comprises providing in a melting furnace a feedstock having a composition configured to form a molten copper-based alloy comprising at least 50 weight % copper, wherein the melting furnace is configured to rotate around a central axis. The method additionally comprises heating the feedstock to melt the feedstock to form the molten copper-based alloy. The method further comprises bubbling an inert gas through the molten copper-based alloy using one or more diffuser blocks comprising a porous diffusing material.

In another aspect, a method of manufacturing a copper-based alloy comprises providing in a melting furnace a feedstock having a composition configured to form a molten copper-based alloy comprising at least 50 weight % copper. The method additionally comprises rotating the melting furnace such that the one or more diffuser blocks are positioned under the feedstock. The method additionally comprises heating the feedstock to melt the feedstock to form the molten copper-based alloy. The method further comprises bubbling an inert gas through the molten copper-based alloy.

In another aspect, a method of manufacturing a copper-based alloy comprises providing in a chamber of a melting furnace a feedstock having a composition configured to form a molten copper-based alloy comprising at least 50 weight % copper. The method additionally comprises injecting a stream of flame along a central axis of the melting furnace to heat and melt the feedstock to form the molten copper-based alloy. The method further comprises bubbling an inert gas through the molten copper-based alloy.

### BRIEF DESCRIPTION OF THE DRAWINGS

FIG. 1 is a schematic illustration of an apparatus for manufacturing a copper-based alloy having low impurity content, according to some embodiments.

FIG. 1A is a schematic side view illustration of an enclosed configuration of a melting furnace for manufacturing a copper-based alloy, according to some embodiments.

FIG. 1B is a schematic side view illustration of an open configuration of a melting furnace for manufacturing high purity copper-based alloys, according to some embodiments.

FIG. 2 is a schematic illustration of an apparatus for manufacturing a copper-based alloy having low impurity content, according to some other embodiments.

FIG. 3A is a schematic illustration of an apparatus for manufacturing a copper-based alloy having low impurity content, according to some other embodiments.

FIG. 3B is a detailed perspective view of a portion of the apparatus illustrated in FIG. 3A including a transfer wheel for manufacturing a copper-based alloy having low impurity content, according to some other embodiments.

FIG. 3C is a detailed side view of the portion of the apparatus illustrated in FIG. 3A including a transfer wheel for manufacturing a copper-based alloy having low impurity content, according to some other embodiments.

FIG. 4A illustrate a schematic cross-sectional view of a diffuser according to embodiments.

FIG. 4B is a photograph of a diffuser according to embodiments.

FIG. 4C is a photograph of a diffuser installed at a bottom of a melting furnace, according to embodiments.

FIG. 5 illustrates method of manufacturing a copper-based alloy having low impurity content, according to embodiments.

FIG. 6A is a schematic side view illustration of a melting furnace comprising a diffusive lining for manufacturing high purity copper-based alloys, according to some embodiments.

FIG. 6B is a schematic side view illustration of a melting furnace comprising a diffusive lining for manufacturing high purity copper-based alloys, according to some other embodiments.

FIG. 6C is a cross sectional view of the diffusive lining for a melting furnace illustrated in FIGS. 6A and 6B.

FIG. 7A illustrates a method of forming a diffusive lining in a melting furnace for manufacturing high purity copper-based alloys, according to various embodiments.

FIG. 7B is a schematic side view illustration of a melting furnace at a stage of forming a diffusive lining therein for manufacturing high purity copper-based alloys, according to the method illustrated in FIG. 7A.

FIG. 7C is a schematic side view illustration of a melting furnace at another stage of forming a diffusive lining therein for manufacturing high purity copper-based alloys, according to the method illustrated in FIG. 7A.

FIG. 7D is a schematic side view illustration of a melting furnace at another stage of forming a diffusive lining therein for manufacturing high purity copper-based alloys, according to the method illustrated in FIG. 7A.

FIG. 7E are schematic side view illustration of a melting furnace at another stage of forming a diffusive lining therein for manufacturing high purity copper-based alloys, according to the method illustrated in FIG. 7A.

FIG. 7F are schematic side view illustration of a melting furnace at another stage of forming a diffusive lining therein for manufacturing high purity copper-based alloys, according to the method illustrated in FIG. 7A.

FIG. 8 illustrates method of manufacturing a copper-based alloy having low impurity content using a diffusive lining, according to embodiments.

FIG. 9A is a schematic perspective illustration of a rotary furnace system for manufacturing a copper-based alloy having low impurity content, according to some embodiments.

FIG. 9B is a schematic side view of a rotary furnace system shown in FIG. 9A along a cylindrical axis from a first base side.

FIG. 9C is a schematic side view of a rotary furnace system shown in FIG. 9A along a cylindrical axis from a second base side.

FIG. 10 is a schematic cross-sectional illustration of a diffuser block, according to some embodiments.

FIG. 11 is a schematic cross-sectional illustration of a rotary furnace for manufacturing a copper-based alloy having low impurity content in a loading configuration, according to some embodiments.

FIG. 12A is a schematic cross-sectional illustration of a rotary furnace for manufacturing a copper-based alloy having low impurity content in a melting configuration, according to some embodiments.

FIG. 12B is another schematic cross-sectional illustration of a rotary furnace for manufacturing a copper-based alloy having low impurity content in a melting configuration, according to some embodiments.

FIG. 13 is a schematic cross-sectional illustration of a rotary furnace for manufacturing a copper-based alloy having low impurity content in a pouring configuration, according to some embodiments.

FIG. 14 illustrates a method of manufacturing a copper-based alloy having low impurity content using a diffusive lining, according to embodiments.

### DETAILED DESCRIPTION

The present disclosure may be understood by reference to the following detailed description. It is noted that, for purposes of illustrative clarity, certain elements in various drawings may not be drawn to scale, may be represented schematically or conceptually, or otherwise may not correspond exactly to certain physical configurations of embodiments.

Various impurities in copper-based alloys can degrade advantageous properties thereof. The presence of various unwanted impurities in various components formed of copper-based alloys can be caused by the presence of these impurities in the feedstock material, such as copper-based turnings, e.g., copper-based alloy scrap. For example, various impurities in copper-based turnings or copper-based alloy scrap that serve as feedstock materials can negatively affect the mechanical and chemical properties of the cast copper-based components and can lead to high failure rates during fixture casting as well as shorter life expectancy of the components, which in turn leads to higher replacement cost. This increased failure rate can lead to increased production cost for copper-based components, e.g., copper-based fixtures such as water fixtures. Thus, there is a need for improved apparatuses and methods for reducing the impurity content in copper feedstock materials, and thereby limiting the incorporation of impurities into final products. Thus, there is a need for technologies for manufacturing copper-based alloys, e.g., copper-based ingots or copper-based shot, with low levels of impurities for improved mechanical properties, while also moderating cost, improving casting efficiency and increasing component lifetime simultaneously.

The inventors have discovered that oxygen and oxygen-related defects can be particularly detrimental to copper-based alloys. Oxygen-related defects include, e.g., trapped oxygen-containing voids or pockets as well as oxides in the copper-based alloys. Without being bound to any theory, such oxygen-containing void or pocket formation can be caused by relatively high amounts of oxygen that become dissolved in a molten copper-based alloy. For example, as the molten copper-based alloy cools to solidify, the solubility of oxygen in the copper-based alloy decreases, leading to nucleation of oxygen-containing voids or pockets therein. Thus formed voids or pockets that do not escape to the atmosphere become trapped in the solidified copper-based alloy, leading to voids and pores that can in turn lead to degradation of mechanical properties such as yield strength and toughness. In particular, the oxygen-containing voids or pockets can serve as stress concentration centers that serve as initiation locations for fracture. Other oxygen-related impurities can include oxygen compounds, such as copper oxides, which may precipitate in the copper-based alloy to degrade the mechanical properties thereof.

The inventors have discovered that, in order to effectively reduce oxygen and oxygen-related impurities in copper-based alloys, oxygen content should be reduced from the copper-based alloy starting with the melting process and in the molten state. In addition, after forming the molten copper-based alloy with reduced oxygen content, oxygen and oxygen-related impurities should be prevented from being introduced or re-introduced thereinto, prior to solidification. Thus, to improve the mechanical properties of copper-based alloys, e.g., by reducing the oxygen content thereof, the disclosed embodiments relate to an apparatus and method for reducing oxygen content starting with the melting process and in the molten copper-based alloy, and preserving the low oxygen content through the solidification process including transferring to a mold. According to various embodiments, the apparatus for manufacturing a copper-based ingot or copper-based shot comprises an enclosed melting furnace configured to form a molten copper-based alloy under an enclosed inert atmosphere and to bubble an inert gas through the molten copper-based alloy. The apparatus additionally comprises a transfer ladle configured to receive the molten copper-based alloy from the melting furnace under the enclosed inert atmosphere and to transfer the molten copper-based alloy into one or more molds, e.g., an ingot mold or a component mold, configured to solidify the molten copper-based alloy, e.g., into a copper-based ingot or copper-based component. The transfer ladle may be configured to receive the molten copper-based alloy from the melting furnace through a velocity control element. The transfer ladle may also be configured to transfer the molten copper-based alloy into a shot pit configured to solidify the molten copper-based alloy into shot. The transfer ladle may be enclosed or not enclosed, depending on the tolerance for the amount of oxygen and oxygen-related impurities in the solidified copper alloy. As described herein, bubbling an inert gas through a molten alloy may be referred to as sparging. The furnace according to the disclosure may provide for reduced impurity content in copper-based alloys and components made thereof, e.g., ingots, shots, or components such as fixtures, which may be attributed to the sparging of the molten copper-based alloy within the furnace as described herein. By reducing the oxygen and oxygen-related impurity content in copper-based alloys and components made thereof, in particular by reducing the amount of oxygen or oxygen-related impurities by sparging, certain mechanical properties of the copper can be improved, including tensile strength and ductility.

According to various embodiments, a sparging furnace comprises a melting furnace which is configured to melt a copper-based feedstock. The melting furnace is configured to flow an inert gas through the feedstock material prior to melting and during heating, and to bubble an inert gas through the molten alloy within the melting furnace through, e.g., a diffuser. The melting furnace may be under an atmosphere of the inert gas. As configured, bubbling an inert gas through the molten copper-based alloy can entrain unwanted impurities and remove them from the molten copper-based alloy. The unwanted impurities may include, but not limited to, e.g., oxygen or oxygen-related impurities. As described herein, oxygen or oxygen-related impurities include bound and unbound oxygen such as atomic oxygen (O), molecular oxygen (O₂, O₃) and any compound formed with or by oxygen including, without limitation, water, metal and non-metal hydroxides, metal and non-metal oxyhydrides and metal and non-metal oxides. After being entrained by the inert gas, unwanted oxygen-related impurities, e.g., oxides, may form a slag layer or islands on top of the molten copper-based alloy. The slag layer may be removed from the melt, thereby removing oxide impurities from the molten alloy.

The inventors have found that thus configured sparging furnace effectively removes impurities including oxygen and oxygen-related impurities from the molten copper-based alloy. As described herein, while impurity removal may be described in the context of removing oxygen-related impurities, it will be appreciated that embodiments are not so limited, and other impurities can be removed in a similar manner. Without being bound to any theory, sparging removes impurities such as oxygen from the molten alloy in accordance with Henry's Law, which states that, under equilibrium, the concentration of a gas in a liquid is proportional to the partial pressure of that gas in contact with the liquid. In accordance with Henry's Law, because the inert gas bubbles initially contain no oxygen, as they pass through the molten alloy, the oxygen dissolved in the molten alloy is removed therefrom and forms a gas mixture with the inert gas before escaping the alloy into the surrounding atmosphere. Moreover, oxide particles and other oxygen-related impurities may be removed through electrostatic forces. Without being bound to any theory, when small inert gas bubbles travel through the molten alloy, small oxide particles and oxygen-related impurities can adhere to the inert gas bubbles via electrostatic forces. Removing oxygen or oxygen-related impurities with inert gas bubbling may be preferable to methods that rely on chemical reactions between a reactive element, e.g., a reducing gas and oxygen or oxygen-related impurities in the molten copper-based alloy. Powerful reducing gases may not be suitable for some manufacturing facilities, as they may pose an increased risk to workers and necessitate heightened safety precautions. In addition, while some elements serve as deoxidizers, e.g., Zr, there may be a need to reduce the amount used during processing, e.g., to reduce the cost of manufacturing. The inventors have found that removing and suppressing impurities including oxygen and oxygen-related impurities from the molten alloy as described herein according to embodiments is correlated to improved mechanical performance of cast copper-based alloys, ingots, or copper-based shot.

The inventors have further found that, once a molten alloy with low impurities content, e.g., low oxygen content, is thus formed, the impurities including oxygen and oxygen-related impurities should be prevented from being reintroduced into the molten alloy. To this end, in some embodiments, the melting furnace is enclosed and disposed under an atmosphere of the inert gas. A controlled atmosphere can effectively prevent or reduce the reintroduction of oxygen or oxygen-related impurities into the metal alloy. However, embodiments are not so limited, and where some reintroduction of oxygen or oxygen-related impurities can be tolerated, or where inert gas can be flushed though the system at a high enough flow rate to substantially suppress outside air from mixing with the inert atmosphere inside the melting furnace, the melting furnace can be open to the surrounding atmosphere.

The inventors have further found that, as the molten alloy is transferred from the furnace to a transfer ladle, the velocity thereof should be carefully controlled to reduce any excessive turbulence, which can also lead to reintroduction of impurities such as oxygen or oxygen-related impurities including any slag that may have formed at the surface of the molten alloy, back into the molten alloy. Thus, according to some embodiments, a velocity control device, e.g. a ramp or launder, connects the melting furnace to a transfer ladle. The velocity control device is configured to transfer the copper-based alloy to a transfer ladle without excessive turbulence and entrainment of atmospheric gasses, including oxygen, or other oxygen-related impurities, including oxides, which may be present in the system.

The inventors have further found that, to further reduce or effectively prevent reintroduction of impurities including oxygen or oxygen-related impurities into the molten alloy, the transfer conduit between the melting furnace and the transfer ladle, and optionally the transfer conduit between the transfer ladle and the molds, can be at least partially enclosed and disposed under an inert atmosphere. Thus, in some embodiments, the transfer ladle is at least partially encapsulated and configured to receive molten copper-based alloy from the velocity control device. In some embodiments, the transfer ladle and the velocity control device may be enclosed under a common inert atmosphere as the melting furnace. In some embodiments, the transfer ladle is configured to transfer, e.g. inject or pour, the molten copper-based alloy into molds, e.g., ingot molds or component molds. After being poured in the molds, the sparged molten copper-based alloy may cool and harden into sparged copper-alloy in a solid form.

### Systems and Methods for Manufacturing High Purity Copper-Based Alloys Using Inert Gas

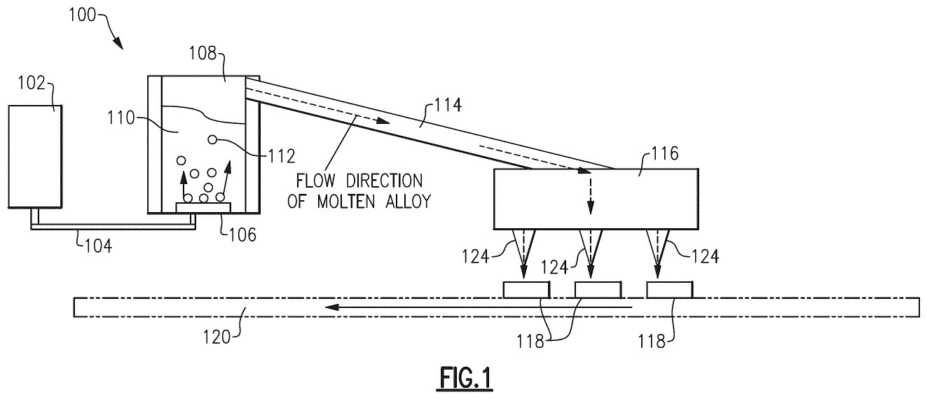

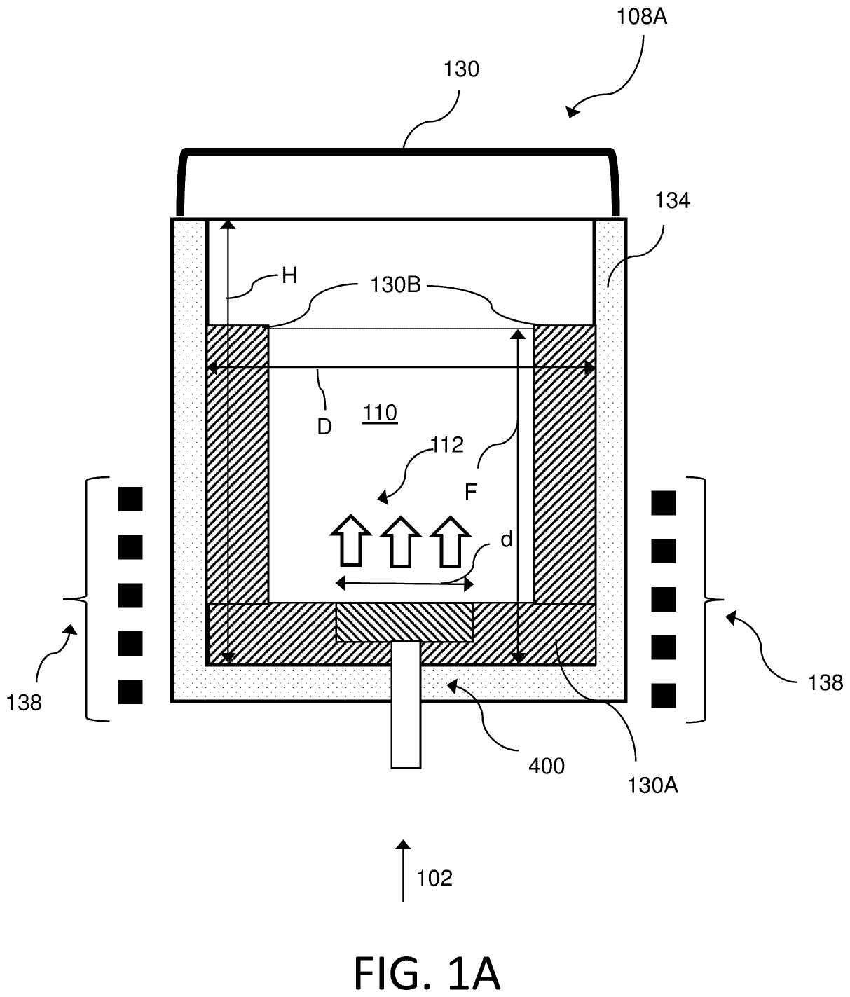

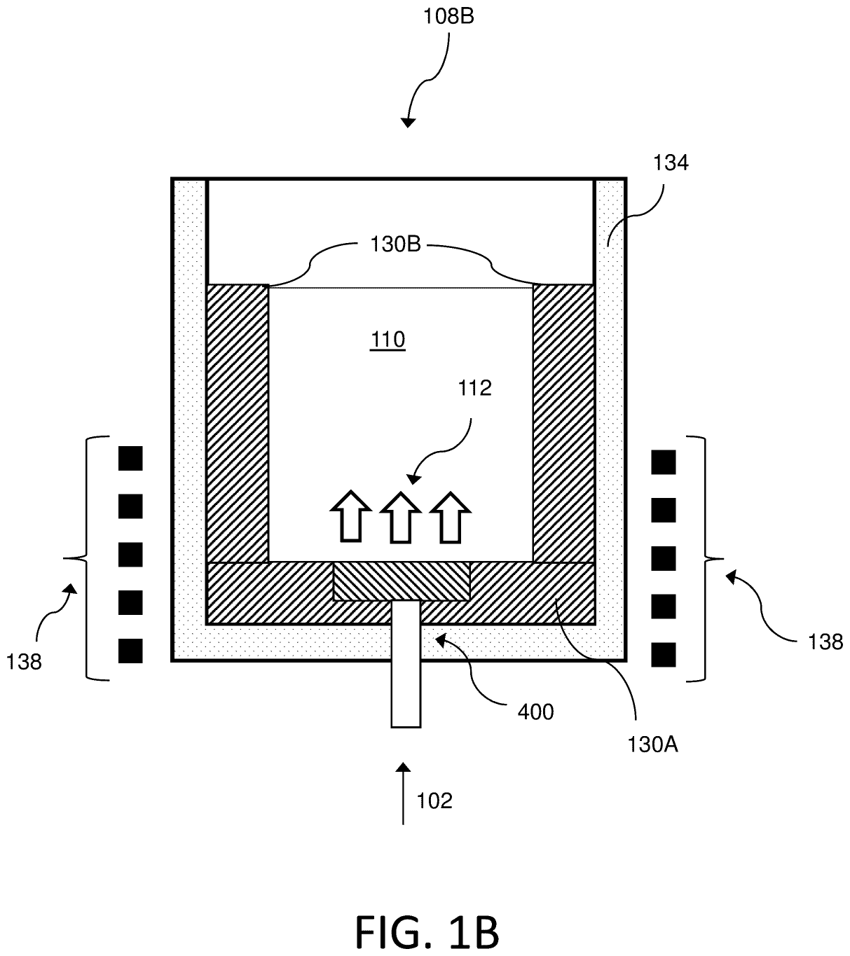

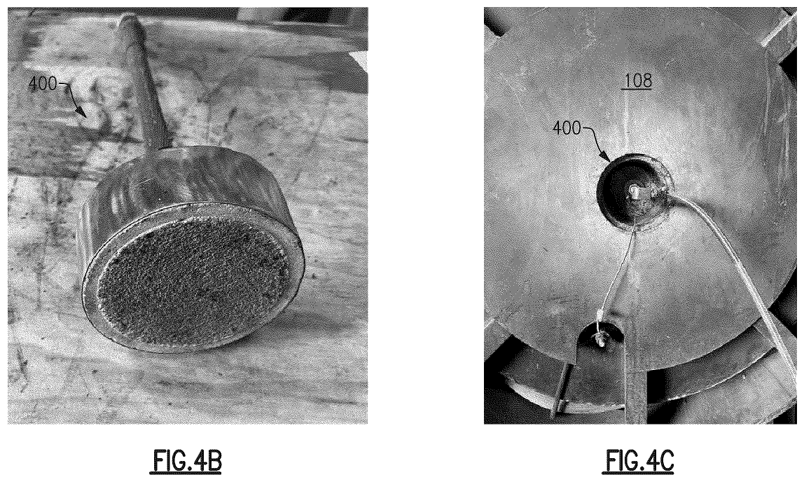

FIGS. 1-3 illustrate furnace systems configured for manufacturing a copper-based alloy with reduced impurity content, including oxygen or oxygen-related impurities content, according to various embodiments disclosed herein. FIGS. 1A and 1B illustrate two different configurations of a melting furnace of the furnace systems for manufacturing a copper-based alloy, according to some embodiments. FIG. 5 illustrates a method of manufacturing a copper-based alloy using one of the furnace systems illustrated in FIGS. 1-3, according to embodiments. Each of the furnace systems 100, 200 and 300 illustrated in FIGS. 1, 2 and 3, respectively, comprises a melting furnace, which can be in an enclosed configuration (FIG. 1A) or an open configuration (FIG. 1B). Each of the melting furnaces 108A (FIG. 1A), 108B (FIG. 1B) is configured to form a molten copper-based alloy comprising at least 50 weight % copper, to flow inert gas through the feedstock prior to melting and during heat up, and to bubble an inert gas through the molten copper-based alloy. Each of the furnace systems 100, 200 and 300 additionally comprises a transfer ladle configured to receive the molten copper-based alloy from the melting furnace and to transfer the molten copper-based alloy into one or more molds or a shot pit configured to solidify the molten copper-based alloy.

Using any one of the furnace systems 100, 200 and 300, the method 500 illustrated in FIG. 5 can be performed. The method 500 of manufacturing a copper-based alloy comprises providing 504 in a melting furnace a plurality of feedstock pieces having a combined composition configured to form a molten copper-based alloy comprising at least 50 weight % copper. The method 500 additionally comprises flowing 508 an inert gas through gaps between feedstock pieces and heating 512 the feedstock pieces while flowing the inert gas therethrough, thereby melting the feedstock pieces to form a molten copper-based alloy. The method 500 additionally comprises bubbling 516 the inert gas through the molten copper-based alloy. The method 500 further comprises transferring 520 the molten copper-based alloy into a transfer ladle. In the following, details of the furnace systems 100, 200 and 300 illustrated in FIGS. 1, 2 and 3 are described along with the method 500 illustrated in FIG. 5.

FIG. 1 is a schematic view of a sparging furnace system 100 for manufacturing a copper-based alloy, e.g., an ingot, ingot shot, or copper-based component, having low impurity content including oxygen or oxygen-related impurities, according to one embodiment. The sparging furnace system 100 includes a melting furnace 108, which can be configured as an enclosed melting furnace 108A (FIG. 1A) or an open melting furnace 108B (FIG. 1B). As disclosed herein, unless indicated contrariwise, a reference made to the melting furnace 108 will be understood to apply to one or both of the melting furnaces 108A FIG. 1A), 108B (FIG. 1B).

The melting furnace 108 is connected to a gas supply 102 via a gas line 104 and a diffuser 106. Referring to FIGS. 1A and 1B, the melting furnace 108 is enclosed by a chamber wall 134. The melting furnace 108 comprises a refractory lining 130A, 130B comprising a suitable refractory material at least at inner surfaces thereof. The refractory lining 130A lines a bottom inner surface of the melting furnace 108 and the refractory lining 130B lines a sidewall surface of the melting furnace 108. When the melting furnace 108 is an enclosed melting furnace 108A, the melting furnace 108A further incudes a lid 130. As shown in FIG. 1, the melting furnace 108 includes an opening for transferring out the molten copper-based alloy 110. For example, in FIG. 1, the opening is disposed at an upper portion of the melting furnace 108. The opening may be connected to a channel, e.g., a velocity control element 114. The diffuser 106 is configured to bubble an inert gas through a molten copper-based alloy 110 formed in the melting furnace 108. The diffuser 106 has a surface area that covers a portion of a cross-sectional area of the molten copper-based alloy 110 formed in the melting furnace 108, thereby removing impurities in the path of bubbles passing through the cross-sectional area. The melting furnace 108 is configured to produce the molten copper-based alloy 110 from a copper-based feedstock material. As an inert gas flows through the diffuser 106, it forms gas bubbles 112 that pass through the molten copper-based alloy 110. The gas bubbles 112 pass through the molten copper-based alloy 110 and entrain impurities, including oxygen and oxygen-related impurities, from the molten copper-based alloy 110.

After the impurities are removed from the melting furnace 108, the molten copper-based alloy 110 is transferred through the opening formed through a sidewall 134 of melting furnace 108, as shown in FIG. 1 (not shown in FIGS. 1A and 1B for clarity). For example, the molten copper-based alloy 110 may be transferred by tilting the melting furnace to pour the copper-based alloy 110 out of the melting furnace 108. In the illustrated configuration, the molten copper-based alloy 110 is transferred from the melting furnace 108 to the transfer ladle 116 via a first velocity control element 114 at a controlled velocity. As described herein, the velocity may be controlled using, among other structures, a sloped ramp or launder that utilizes the gravity force. In some embodiments, the transfer ladle 116 comprises one or more injectors 124. After being transferred to the transfer ladle 116, the molten copper-based alloy 110 is transferred, e.g. poured or injected through the injectors 124, into one or more ingot molds 118. The molten copper-based alloy 110 solidifies in the molds 118, thereby forming a solidified copper-based alloy ingot. The molds 118 can be moved via a conveyer belt 120 where they may be further processed, e.g., cooled, prior to being collected.

Still referring to FIG. 1, in some embodiments, the molds 118 could be any suitable mold, including ingot molds and fixture molds. In some embodiments, molds 118 could be molds for a final component, e.g., fixture molds. In some embodiments, fixture molds could be molds for any suitable water fixture, e.g., faucets, valves, or pipes.

Still referring to FIG. 1, in some embodiments, the molds 118 can be replaced by hardware suitable for producing metal shots. For example, some shot production methods include passing the molten copper-based alloy through a screen, e.g., a stainless steel screen, and into a fluid, e.g., water, in which the molten copper-based alloy is quenched and solidified into metal shots. In some other shot production methods, air or other suitable gas is passed through a molten copper-based alloy and the molten copper-based alloy is quenched in a fluid such as water. Although two example methods of suitable shot production methods are described, it should be understood that other known methods of shot production are also within the scope of this disclosure.

Still referring to FIG. 1, the gas supply system supplies an inert gas to the melting furnace. In some embodiments, the inert gas can include, e.g., argon (Ar) or any other noble gas. In some other embodiments, the inert gas includes nitrogen (N₂). In some embodiments, the inert gas is any one or combination of suitable inert gases. In some embodiments, the inert gas may be substantially or essentially free or reactive gases including reducing or oxidizing gases, e.g., hydrogen. In these embodiments, the inert gas is reactive gas-free, e.g., hydrogen-free, except for impurity-level amounts of such gases such as hydrogen.

Still referring to FIG. 1, the gas supply system is configured to purge or begin flowing the inert gas through the feedstock material prior to substantially melting the feedstock. The inventors have discovered that it can be important to reduce the presence of ambient oxygen and/or moisture in the melting furnace 108 not only during melting of the feedstock, but also prior to forming the molten alloy 110, e.g., prior to and during heating-up. Otherwise, unwanted oxidation of the feedstock from the ambient oxygen and/or moisture can be accelerated at elevated temperatures during the heat-up, prior to forming the molten alloy 110. Thus formed oxide on the surfaces of the feedstock, which can be relatively stable at the temperature of the molten alloy 110, can remain in oxide form or release oxygen in the molten alloy 110, thereby contributing to the oxygen and oxygen-related impurities in the molten alloy 110, which can detrimentally affect the mechanical properties of the resulting ingot or shot. Furthermore, the inventors have discovered that oxides can also form from surface-adsorbed oxygen or moisture, which can also be effectively removed by flowing the inert gas through the feedstock. Thus, prior to substantially heating up the feedstock and throughout the melting process, inert gas is purged through the feedstock in the furnace 108. In some embodiments, flowing the inert gas comprises flowing at a sufficient flow rate such that the feedstock is substantially under a flowing inert gas atmosphere prior to and during melting.

As described above, the melting furnace 108 can be in an enclosed configuration (108A, FIG. 1A) or an open configuration (108B, FIG. 1B). Referring to FIG. 1A, under the enclosed configuration of the melting furnace 108A, a lid 130 or a comparable device may be used to enclose the furnace 108A. Under the enclosed configuration, the surfaces of the feedstock and the molten alloy 110 may be placed under a substantially inert atmosphere. As disclosed herein, a substantially inert atmosphere refers to an atmosphere under substantially reduced ambient air over the molten alloy 110, e.g., less than 50%, 40%. 30%, 20%, 10% or a value in a range defined by any of these values, relative to a normal atmosphere. It will be appreciated that, while the enclosed configuration illustrated in FIG. 1A, e.g., using the lid 130, is an effective way place the surface of the molten alloy 110 under a substantially inert atmosphere, embodiments are not so limited. For example, the inventors have discovered that, without the lid 130, in the open configuration of the melting furnace 108B (FIG. 1B), a substantially inert atmosphere can still be achieved, by increasing the inert gas flow rate to suppress the presence of ambient air. Under sufficiently high flow or purge rate of the inert gas, surfaces of the feedstock and the molten alloy 110 may be subjected under a substantially inert gas atmosphere, even without a lid or a lid partially enclosing the inner volume of the furnace 108.

In some embodiments, purging or flowing the inert gas through the feedstock material prior to substantially melting the feedstock can be, e.g., 5, 10, 30, 60 minutes or more before substantial heating to initiate the melting may commence. During the purging, prior to initiating the melting of the feedstock material, the melting furnace 108 may be heated to a relatively low temperature substantially below the melting temperature that is sufficient to accelerate the removal of moisture, e.g., less than 200° C., while insufficient to substantially oxidize the feedstock.

As described herein, an enclosed system or a component thereof refers to an arrangement in which the enclosed sparging furnace system 100 or sub-components thereof are substantially physically sealed or isolated from the outside atmosphere at least part of the time during operation thereof. For example, during loading of the feedstock that may comprise a plurality of feedstock pieces, the volume occupied by the feedstock will decrease as the feedstock pieces melt. As such, during the loading process of the melting furnace 108, a chamber lid, when present, may be opened one or more times before the molten alloy 110 reaches a fill line of the melting furnace 108 representing a liquid level of a fully loaded melting furnace 108. According to embodiments, the inert gas may be flowed into the melting furnace and through the molten alloy 110 throughout the entire filling process until the molten alloy 110 reaches the fill line, which may include several cycles of adding solid feedstock pieces into the pool of molten alloy 110. It will be appreciated that, even while the chamber lid may be opened during the addition of the feedstock to fill the melting furnace 108, the inert gas may be flowing into the melting furnace 108 and through the additional feedstock, thereby reducing or substantially preventing the oxidation of the additional feedstock. However, once the melting furnace 108 is fully loaded, the system 100 including at least the gas supply 102, the gas line 104, the melting furnace 108, the first velocity control element 114 and the transfer ladle 116 may be enclosed or sealed from the outside atmosphere, at least temporarily, while being purged with the inert gas from the gas supply 102 to suppress the introduction of oxygen thereinto. As such, in the method 500 (FIG. 5), one or more of flowing 508 the inert gas, heating 512 feedstock pieces and bubbling 516 the inert gas through the molten copper-based alloy is performed at least partly under an enclosed inert atmosphere configured to substantially exclude outside air from mixing with the enclosed inert atmosphere. In the illustrated configuration of FIG. 1, transferring the molten alloy 110 into the transfer ladle 116 through the first velocity control element 114 can also be performed at least partly under an enclosed inert atmosphere configured to substantially exclude outside air from mixing with the enclosed inert atmosphere. The enclosure to isolate relevant portions of the enclosed sparging furnace system 100 from the outside air may be performed using, e.g., one or more valves disposed therein, e.g., between the melting furnace 108 and the transfer ladle 116, and/or between the transfer ladle 116 and the outside world. For example, the injectors 124 may comprise a valve or other shutoff mechanisms that serves to isolate the transfer ladle 116 and the melting furnace 108 prior to being opened to eject molten alloy therethrough.

The feedstock can be present in a variety of forms, including one or more alloy pieces and/or elemental metal pieces. The feedstock pieces may or may not have the same composition. However, the pieces have a combined composition configured to form a molten copper-based alloy having a target composition of the alloy to be formed, and comprises at least 50 weight % copper. Depending on the sizes of the feedstock pieces, the inventors have further discovered that the amount or flow rate of the inert gas that is effective to suppress oxidation of the feedstock prior to melting as described above can be different. The amount or flow rate of the inert gas can depend on, among other things, the relative amount of open space between the feedstock pieces, or the permeability of the copper-based alloy feedstock material, that form the raw material to create the molten alloy 110. A relatively high amount of open space or permeability, which may be present when the feedstock comprises relatively large feedstock pieces, may have a relatively small amount of surface area of alloy exposed to the inert gas. For instance, in some embodiments, the feedstock material may comprise feedstock pieces having a relatively large size and correspondingly higher amount of open space or permeability. For feedstocks with high permeability, relatively high flow rates of inert gas, e.g. greater than or about 5 liters/minute, may be suitable to remove various impurities including the oxygen and oxygen-related impurities from the feedstock. In some embodiments, the feedstock material may comprise feedstock pieces having a relatively small size and correspondingly lower amount of open space or permeability. For example, the feedstock may be relatively small copper-based alloy turnings (e.g., copper based scrap). For feedstocks with low permeability, relatively low flow rates of inert gas, e.g. less than about 5 liters/minute, may be suitable to remove the impurities including oxygen and oxygen-related impurities from the feedstock. The flow rate of inert gas prior to melting as described herein can have any value that is the same or different relative to the flow rate of inert gas during bubbling of the inert gas through the molten alloy 110, as described below, which values are not repeated herein for brevity.

The inventors have discovered that, for effective removal of impurities including oxygen and oxygen-related impurities from the molten alloy 110 as described above, particular combinations of various process parameters can be effective. In particular, the inventors have discovered that the size, density and velocity distributions of the gas bubbles 112 traveling through the molten alloy 110 can be correlated to the effectiveness of the impurity removal process. When the size, density per unit volume and velocity of the gas bubbles 112 are too small or low, the bubbles can be too slow or ineffective at removing oxygen or oxygen-related impurities. On the other hand, when the size, density and velocity of the gas bubbles 112 are too large or high, the bubbles can create substantial turbulence as the bubble rise and break at the surface of the molten alloy 110. The inventors have discovered that such turbulence, when substantial, can not only negate any removal of oxygen or oxygen-related impurities, but can even increase the content of oxygen or oxygen-related impurities. As such, the inventors have discovered that controlling the size, density and velocity distributions of the inert gas bubbles can be critical. The size, density and velocity distributions of the bubbles can be optimized based on a variety of factors, including the viscosity of the molten alloy 110, flow rate of the inert gas though the molten alloy 110, the cross-sectional flow area of the molten alloy 110 through which the inert gas flows, the porosity of the diffuser 106, and the volume of the molten alloy 110 that is in part defined by the dimensions of the furnace 108, to name a few. It will be appreciated that these parameters can be inter-dependent. For example, the flow rate of the inert gas and the cross-sectional flow area through the diffuser determine the flux of the inert gas. In addition, certain values of flow parameters such as the flow rate can be particularly relevant when there is a proportional relationship to the overall volume of the molten alloy 110.

The viscosity of the molten alloy 110 depends, among other things, on the composition and temperature thereof. For a given composition of the various compositions of the molten alloy 110 described herein, including molten copper-based alloy compositions comprising at least 50 weight % copper, the viscosity can be controlled by controlling the temperature of the molten alloy 110 above a melting temperature, e.g., a liquidus temperature. For this and other reasons, the inventors have discovered that the methods described herein can be effective at removal of impurities including oxygen and oxygen-related impurities from the molten alloy 110 when the molten alloy 110 is heated to a temperature greater than the liquidus temperature of the alloy by 100-400° C. According to various embodiments, the molten alloy 110 is heated to a temperature greater than 50° C., 100° C., 150° C., 200° C., 250° C., 300° C., 350° C., 400° C., 450° C. or any temperature in a range defined by any of these values.

As discussed above, inventors have discovered that the flow rate of inert gas during bubbling should be optimized such that the size, density and velocity distributions of the inert gas bubbles are effective at reducing various impurities including oxygen and oxygen-related impurities while not creating excessive turbulence, which can have negative effects. Further, as described above, the optimized flow rate is different depending on whether the melting furnace 108 is in an enclosed configuration (FIG. 1A) or an open configuration (FIG. 1B). According to various embodiments, when the melting furnace 108A (FIG. 1A) is in an enclosed configuration, the inert gas is bubbled into the melting furnace 108A at a flow rate greater than 10 liters/minute, 9 liters/minute, 8 liters/minute, 7 liters/minute, 6 liters/minute, 5 liters/minute, 4 liters/minute, 3 liters/minute, 2 liters/minute, 1 liter/minute or any value in a range defined by these values, such as 1-10 liters/minute or 2-6 liters/minute, for instance about 4 liters/minute. According to various embodiments, when the melting furnace 108B (FIG. 1B) is in an open configuration, the inert gas is bubbled into the melting furnace 108B at a higher flow rate than the flow rate under the enclosed configuration. For example, the flow rate under an open configuration may be greater than 13 liters/minute, 12 liters/minute, 11 liters/minute, 10 liters/minute, 9 liters/minute, 8 liters/minute, 7 liters/minute, 6 liters/minute, 5 liters/minute, 4 liter/minute or any value in a range defined by these values, such as 4-13 liters/minute or 5-9 liters/minute, for instance about 7 liters/minute. When the configurations of the enclosed melting furnace 108A and the open melting furnace 108B are otherwise the same, the optimized flow rate of the inert gas in the open melting furnace configuration 108A is higher, relative to the enclosed melting furnace 108A, by 2 liters/minute, 3 liters/minute, 4 liters/minute, or a value in a range defined by any of these values.

To further control the size, density and velocity distributions of the inert gas bubbles, the inert gas is flowed into the melting furnace through the diffuser 106 having an effective diffuser area, thereby controlling the flux. According to various embodiments, the inert gas is diffused through the diffuser 106 having a diameter d (FIG. 1A) greater than 5 cm, 10 cm, 15 cm, 20 cm, 25 cm, 30 cm, 35 cm, 40 cm, 45 cm, 50 cm or a value in a range defined by any of these values.

The size, density and velocity distributions of inert gas bubbles can also be controlled by the pores of the diffuser 106. The pore size of the diffuser 106 should be controlled so that the bubbles have suitable size, density and velocity distributions, while preventing molten liquid alloy from infiltrating. The diffuser 106 can have an average pore size of greater than 20 mm, 30 mm, 40 mm, 50 mm, 60 mm, 70 mm, 80 mm, 90 mm, 100 mm, or a value in a defined by any of these values. Further, the diffuser 106 has a porosity, defined as a ratio of void space to the overall macroscopic volume, which is greater than 10%, 15%, 20%, 25%, 30%, 35%, or a value in a range defined by any of these values.

In the illustrated embodiment, the diffuser 106 is disposed at a bottom surface of the melting furnace. However, embodiments are not so limited and the diffuser 106 may be formed at other surface locations, including side surfaces.

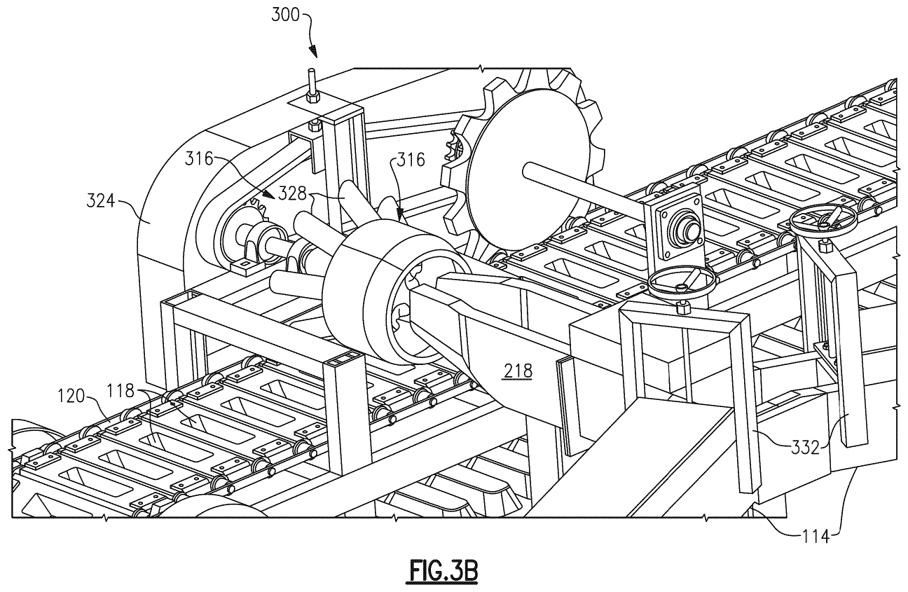

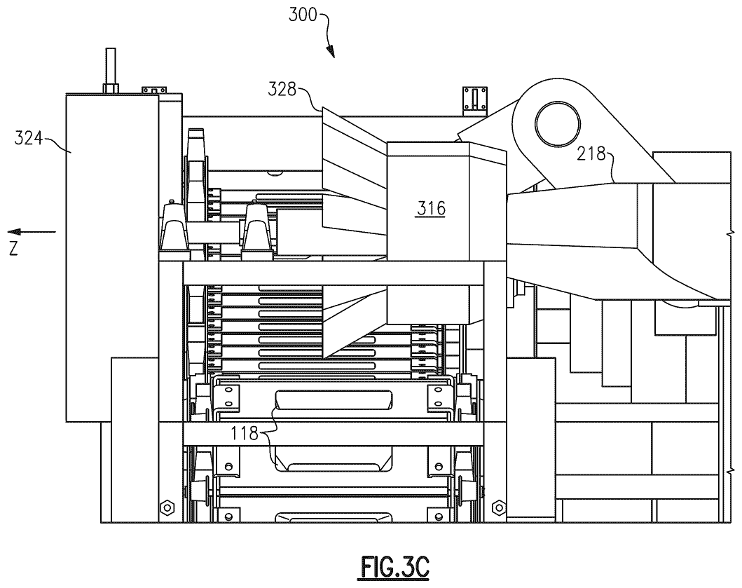

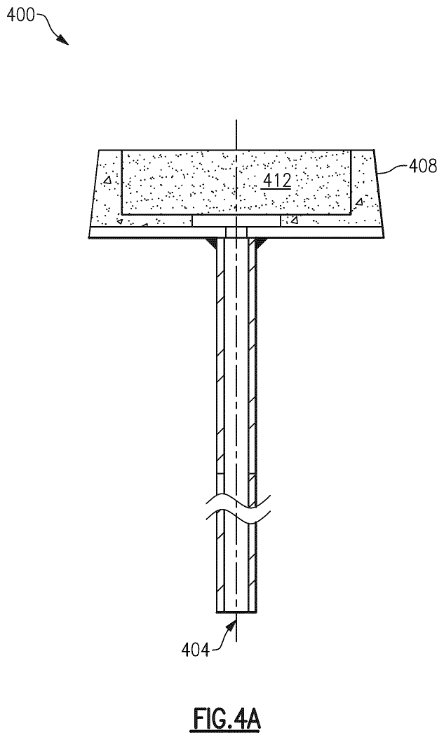

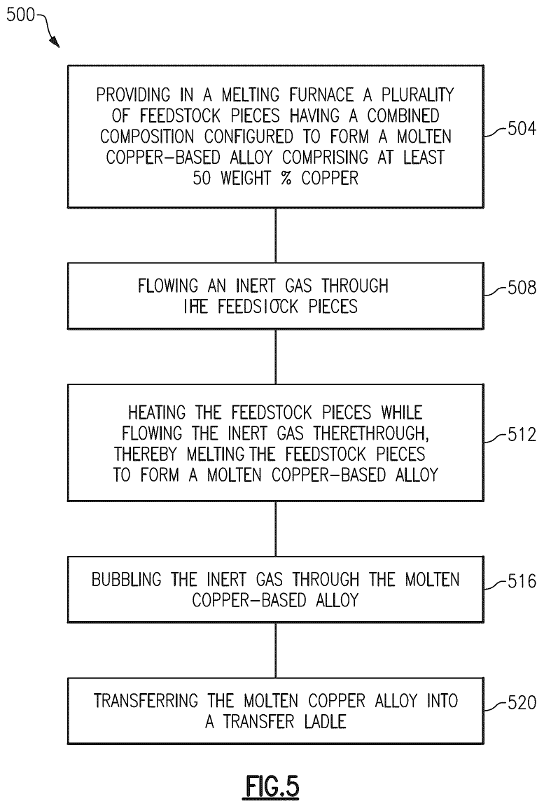

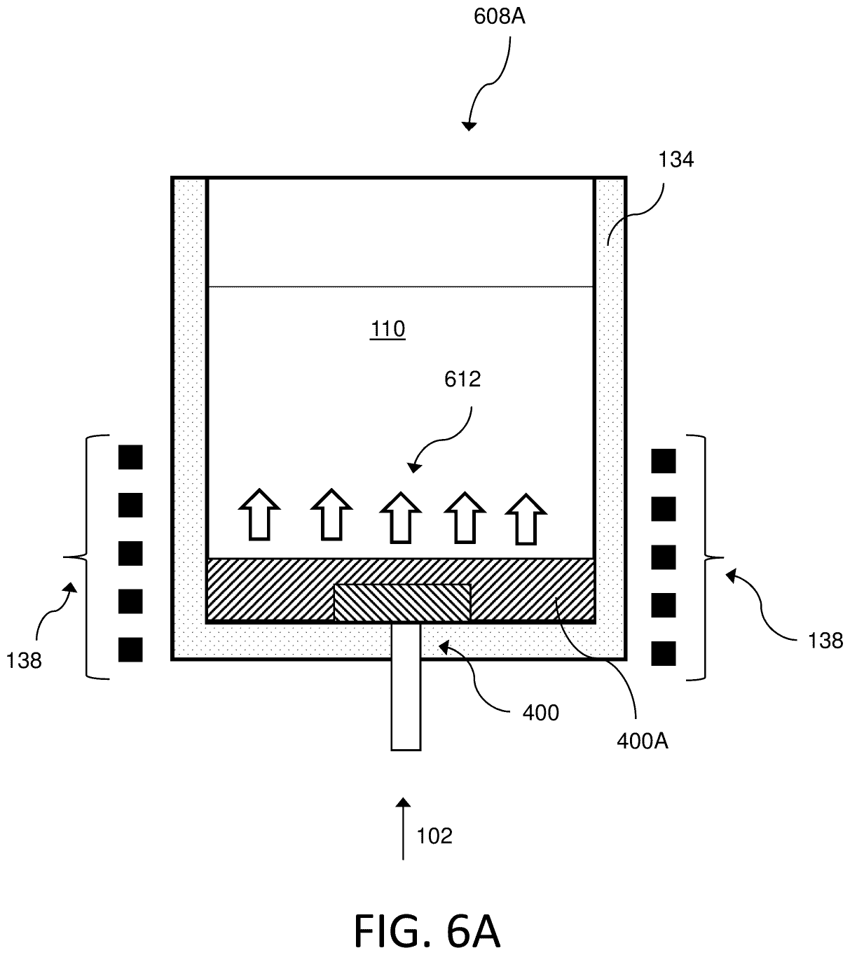

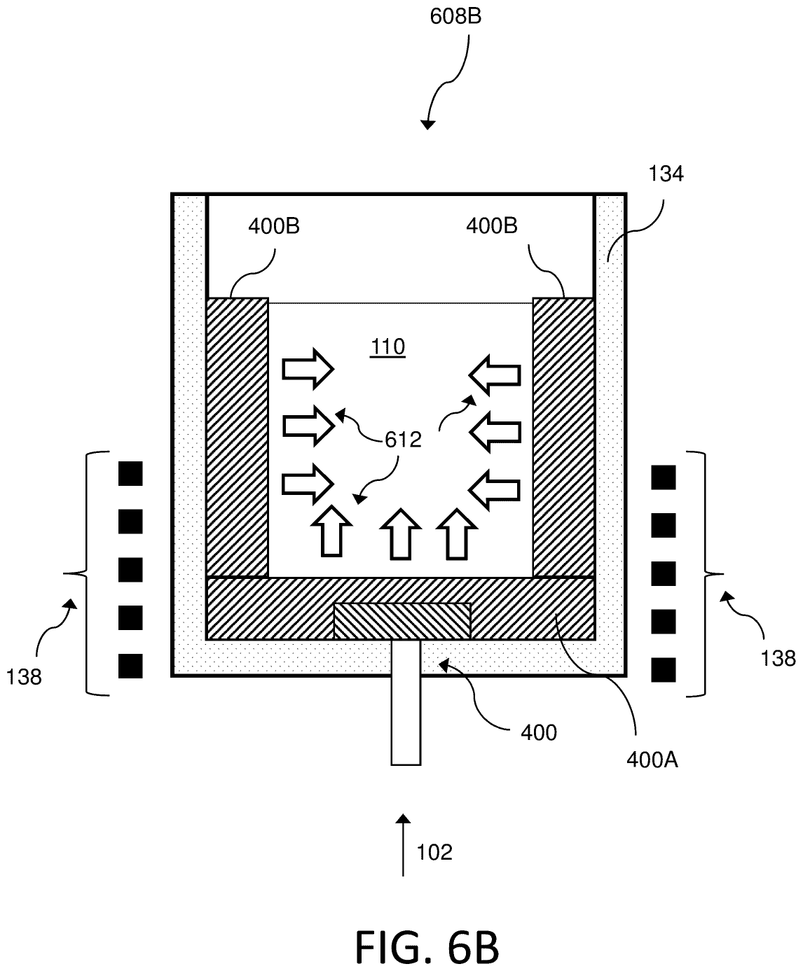

FIGS. 4A and 4B illustrate a schematic cross-sectional view and a photograph, respectively, of a diffuser which meets the criteria described herein, according to embodiments. FIG. 4C is a photograph of a diffuser installed at a bottom of a melting furnace 108, according to embodiments. As illustrated in FIG. 4A, the diffuser 400 comprises a gas inlet 404 through which the inert gas is introduced, and a container 408 for holding a diffuser material or medium 412. The illustrated diffuser material or medium 412 comprises a porous refractory ceramic material. FIG. 4B is a photograph of one example of a diffuser 400 having a diffuser material or medium formed primarily of porous alumina and silica. The diffuser material or medium 412 comprises alumina in an amount of 50-80 mol %, 55-75 mol %, 60-70 mol %, or a mol % in a range defined by any of these values, for instance 65 mol %. The diffuser material or medium 412 further comprises silica in an amount of 10-35 mol %, 15-30 mol %, 20-25 mol %, or a mol % in a range defined by any of these values, for instance 24 mol %. The diffuser material or medium can have various properties and structures described below with respect to the diffusive lining described in FIGS. 6A and 6B. For example, the diffuser material 412 has a porosity of 27.6% and a density of 2.45 g/cm³. The diffusive material or lining 412 can also have a two layer structure described with respect to FIGS. 6A and 6B.

Still referring to FIGS. 4A-4C, according to embodiments, the inert gas is bubbled into the melting furnace 108 at a flow rate as described above, e.g., 1-10 liters/minute, through the diffusive material or medium 412 (FIG. 4A) having a diameter (d in FIG. 1A) of 5-50 cm, in a furnace having a capacity to melt alloys in an amount greater than 1000 lbs., 2000 lbs., 5000 lbs., 10,000 lbs., 20,000 lbs. 50,000 lbs., 100,000 lbs. or a value in a range defined by any of these values. For instance, the inert gas is bubbled into the melting furnace at a flow rate between 1-10 liters/minute in a 4000 lbs. furnace, or a furnace having a capacity to melt alloys in am an amount of about 4000 lbs.

Referring back to FIGS. 1A and 1B, in addition to the capacity of the melting furnace 108A, 108B, the furnace may have a volume, defined by an area e.g., a cylindrical area, and a height. In various embodiments, the furnace may have a cylindrical volume defined by an inner diameter D greater than 50 cm, 100 cm, 150 cm, 200 cm, 250 cm, 300 cm, 350 cm, 400 cm, 450 cm, 500 cm, or a value in a range defined by any of these values. The melting furnace 108A, 108B may further have a height H such that, when fully loaded with molten alloy 110, the molten metal may have a fill line F at a height, measured from a bottom surface of the furnace, that is greater than 50 cm, 100 cm, 150 cm, 200 cm, 250 cm, 300 cm, 350 cm, 400 cm, 450 cm, 500 cm, or a value in a range defined by any of these values.

The inventors have discovered that, in conjunction with various other configurations of the melting furnace 108, the disclosed inert gas flow rate generates a combination of gas bubble size, density per unit volume and velocity distributions that are suitable to produce the various advantageous effects described herein. The density of bubbles is such that excessive coalescence of the bubbles within the molten metal is largely avoided, and the velocity and size are such that excessive turbulence is avoided. In some embodiments, the diffuser 106 can have an average pore distribution that are correlated to the bubble size and density per unit volume such that the inert gas bubbles do not substantially coalesce or have excessive velocity.

When enclosed, the atmosphere in contact with the molten alloy 110 in the melting furnace 108 can be determined by the inert gas introduced by the gas supply system. In some embodiments, the atmosphere in the melting furnace is argon. In some embodiments, the atmosphere in the melting furnace is nitrogen. In some embodiments, the atmosphere in the melting furnace is any suitable inert gas.

Referring to FIGS. 1A and 1B, the melting furnace 108 (108A, 108B) is configured to melt a feedstock material. As illustrated in FIGS. 1A, 1B, without limitation, the melting furnace 108 may be an induction-type furnace. The melting furnace 108 can be configured to have a variable internal temperature to accommodate various copper-based alloy systems. In some embodiments, the temperature of the melting furnace 108 is between 700° F. and 3000° F. In some embodiments, the temperature of the melting furnace 108 is 900°, 1000° F., 1200° F., 1400° F., 1600° F., 1800° F., 2000° F., 2200° F., 2400° F., 2500° F., or 3000° F. or a value in a range defined by any of these values.

Still referring to FIGS. 1A and 1B, the melting furnace 108 (108A, 108B) configured as an induction type includes an induction coil 138 surrounding at least a portion of the melting furnace 108A, 108B. An induction heating system includes an induction power supply which converts line power to an alternating current, delivers it to the coil 138 to create an electromagnetic field within the coil. The feedstock disposed in the coil where this field induces a current therein, which in turn generates the heat sufficient to melt the feedstock. Advantageously, the inventors have realized that, under some circumstances, for optimum results, the uppermost winding of the coil 138 should remain below the fill line (F). Such configuration allows the lower region of the molten alloy 110 to be at a higher temperature relative to the upper region of the molten alloy 110. The inventors have found that such configuration results in higher effectiveness in removing impurities. Without being bound to any theory, the improved effectiveness may be due in part to the fact that, impurity removal may occur with higher effectiveness at the hotter lower region due to increased local solubility of the impurities. Subsequently, in the upper region, the impurities become incorporated into a slag at the topmost surface of the molten alloy 110, thereby being removed from the molten copper-based alloy 110. According to embodiments, the uppermost winding of the induction coil 138 is disposed at or below a vertical level corresponding to the top surface of the molten copper-based alloy 110, or the fill line F. The induction coil 138 may have a height, relative to a height of the molten copper-based alloy 110, corresponding to 90%, 80%, 60%, 50%, 40%, 30%, or a percentage in a range defined by any of these values, as measured from a bottom inner surface of the melting furnace 108.

The operating frequency for an induction heating system may be affected by the range of feedstock sizes for the application. Without being bound to any theory, this may be due to the “skin effect,” which is related to the depth below the surface in the metal feedstock in which a current is induced by the electromagnetic field. Generally, higher operating frequency corresponds to a shallower skin depth, and lower operating frequency corresponds to a deeper skin depth. The skin depth is in turn correlated to the penetration of the heating effect. Skin depth or penetrating depth is dependent on the operating frequency, material properties and the temperature of the feedstock. As a general rule, for a given material, heating smaller feedstock pieces by induction can be performed at higher operating frequencies, while heating larger feedstock pieces can be performed at lower operating frequencies. According to various embodiments, the feedstock can have a smallest major dimension, e.g., a width, which is greater than 2 cm, 5 cm, 10 cm, 20 cm, 30 cm, 40 cm, 50 cm, or a value in a range defined by any of these values. The inventors have found that, for melting copper-based alloy feedstock pieces according to embodiments, the optimum frequency of the melting furnace 108 is set at less than 10 kHz, 5 kHz, 2 kHz, 1 kHz, 500 KHz, or a frequency in a range defined by any of these values, for instance 600 kHz.

As described above, the inventors have found that, for enhanced removal of impurities including oxygen and oxygen-related impurities from the molten alloy 110, the molten alloy 110 is heated to a temperature greater than a melting temperature, e.g., the liquidus temperature, of the alloy by 100-400° C. On the other hand, the inventors have found that, prior to transferring the molten alloy 110 to a mold, it is advantageous to lower the temperature of the molten metal in the furnace close to liquidus. Thus, according to various embodiments, the molten alloy 110 is, immediately prior to being transferred out of the melting furnace 108, cooled down, relative to the temperature at which the inert gas has been bubbled therethrough, by a temperature greater than 50° C., 100° C., 150° C., 200° C., 250° C., 300° C., 350° C., 400° C., 450° C. or any temperature in a range defined by any of these values. However, the temperature inside the melting furnace 108 remains above the melting temperature of the alloy.

After forming the molten alloy 110 having low content of impurities including oxygen or oxygen-related impurities, the molten alloy is transferred to the transfer ladle 116. The inventors have found that the content of oxygen or oxygen-related impurities may not be constant as a function of depth of the molten alloy 110. In general, the inventors have discovered that the content of oxygen or oxygen-related impurities tend to be higher towards the surface of the molten alloy 110. Thus, advantageously, when a portion of the molten alloy 110 containing less than average content of oxygen is desired, the molten alloy 110 at a lower portion of the melting furnace may be preferentially transferred to the transfer ladle 116. This can be achieved, e.g., by connecting the first velocity control element 114 at a lower portion, e.g., within bottom 10% 20%, 30%, 40%, 50% or 60% of the melting furnace 108. Alternatively, a mechanical pump may be employed to preferentially pump the molten alloy 110 from a bottom portion thereof, which is then transferred to the transfer ladle 116.

Still referring to FIG. 1, as described above, after a molten alloy 110 having low content of impurities including oxygen or oxygen-related impurities is formed in the melting furnace 108, the molten alloy 110 can be transferred to the transfer ladle 116 via the first velocity control element 114, e.g., a launder or a ramp, which may be under an enclosed and/or inert atmosphere to reduce the reintroduction of oxygen or oxygen-related impurities thereinto. In some embodiments, bubbling the inert gas through the molten alloy 110 can continue throughout the process of transferring the molten copper-based alloy into the transfer ladle 116. When the first velocity control element 114 is enclosed or isolated from the surrounding atmosphere as illustrated, the atmosphere within the first velocity control element can be the same as that of the melting furnace. As such, the atmosphere within the first velocity control element is argon, nitrogen, and/or any suitable inert gas.

The first velocity control element 114 is configured to introduce the molten alloy 110 into the transfer ladle 116 at a controlled velocity to suppress turbulence, which may introduce or reintroduce impurities including oxygen or oxygen-related impurities. The inventors have discovered that the controlling the velocity at this stage can also be critical to prevent or suppress introduction or reintroduction of oxygen and oxygen-related impurities into, and to suppress void formation in, the molten alloy 110 as it cools. The first velocity control element 114 can be, e.g., a launder or a ramped channel, which can be enclosed and shielded from the external atmosphere as illustrated. In some embodiments, the first velocity control element 114 is configured to transfer the molten alloy 110 from the melting furnace 108 to the transfer ladle 116 at a velocity of 1 in/s, 2 in/s, 5 in/s, 10 in/s, 15 in/s, 16 in/s, 17 in/s, 18, in/s, 19 in/s, 20 in/s, 21 in/s, 22 in/s, 23 in/s, 24 in/s, 25 in/s, 26 in/s, 27 in/s, 29 in/s, 30 in/s, 35 in/s, 40 in/s, 45 in/s, 50 in/s, 55 in/s, 60 in/s, 65 in/s, 70 in/s, 75 in/s, 80 in/s, 85 in/s, 90 in/s, 95 in/s, 100 in/s, 105 in/s, 110 in/s, 115 in/s, or 120 in/s or a value in a range defined by any of these values. In some embodiments, the first velocity control element 114 is configured to transfer the molten alloy 110 from the melting furnace 108 to the transfer ladle 116 at a velocity between 5 and 30 in/s. In some embodiments, the first velocity control element 114 controls the velocity of the molten copper-based alloy as it is being transferred from the melting furnace 108 to the transfer ladle 116.

Still referring to FIG. 1, in some embodiments, to control the velocity of the molten alloy 110 within a speed range disclosed above, the enclosed sparging furnace system 100 is configured to transfer the molten alloy 110 from the melting furnace 108 to the transfer ladle 116 using the first velocity control element 114 that is configured to control the velocity of the flowing molten alloy 110 using gravity by being arranged to have, e.g., about a 0.5 to 5 inches of vertical drop over about 3-5 feet of horizontal length. In some embodiments, the first velocity control element 114 is configured to have 0.5 to 2 or 1 to 2 inches drop over a length of 3, 4, 5, or 3-5 feet of length. The first velocity control element can have an angle, relative to a horizontal plane parallel to ground of 5-10 degrees, 10-20 degrees, 20-30 degrees, 30-40 degrees, 40-50 degrees, 50-60 degrees, or a value in a range defined by any of these values.

As described above, after the molten alloy 110 having a low content of impurities including oxygen or oxygen-related impurities is formed in the melting furnace 108, the molten alloy 110 can be transferred to the transfer ladle 116 under an enclosed and/or inert atmosphere to further suppress reintroduction of the impurities thereinto. Thus, as illustrated, according to various embodiments, the transfer ladle 116 as well as the first velocity control element 114 connecting the melting furnace 108 and the transfer ladle 116 may be enclosed. When the transfer ladle 116 is enclosed from the surrounding atmosphere, the atmosphere within the transfer ladle 116 can be common or shared with that of the melting furnace 108 and/or the first velocity control element 114. As such, the atmosphere within the transfer ladle is argon, nitrogen, and/or any suitable inert gas.

Still referring to FIG. 1, after the molten alloy 110 is transferred to the transfer ladle 116 at a controlled velocity using the first velocity control element 114, the molten ally 110 is injected into the molds 118 using the injectors 124. The injectors 124 may, e.g., be gravity-driven injectors in which the molten alloy 110 is injected therethrough solely by force of gravity. For example, the injectors 124 may comprise a piston which normally rests on a valve seat having an opening that is smaller than a diameter of the piston. In this configuration, the injectors 124 are closed, and the system 100 including one or more of the transfer ladle 116, the first velocity control element 114 and the melting furnace 108 may be enclosed within and connected by a common inert atmosphere. When the piston is lifted up from the valve seat, the molten alloy 110 is allowed to flow through the valve seat opening, thereby ejecting the molten alloy 110 into the molds 118 by gravity. The inventors have discovered that the distance between the injecting tip of the injectors 124 and the molds 118 should not exceed 0.5″, 1.0″, 1.5″, 2.0″. 2.5″, 3.0″, 3.5″ or have a value in a range defined by any of these values, in order to prevent excessive turbulence, which again may cause introduction or reintroduction of oxygen or oxygen-related impurities as the molten alloy 110 solidified.

FIG. 2 is a schematic view of an enclosed sparging furnace system 200 for manufacturing a copper-based alloy, e.g., ingot, copper-based shot, or copper-based component, having low content of oxygen or oxygen-related impurities, according to one embodiment. The enclosed sparging furnace system 200 shares various components that are broadly configured similarly to the corresponding components of the enclosed sparging furnace system 100 described above, and a detailed description of some of those components may be omitted herein for brevity. The enclosed sparging furnace system 200 includes a gas supply 102 connected via a gas line 104 to a diffuser 106 configured to bubble a gas through a molten copper-based alloy 110 in the melting furnace 108. In a similar manner as described above with respect to FIG. 1, as an inert gas flows through the diffuser 106, the system 200 is configured to form inert gas bubbles 112 that pass through the molten copper-based alloy 110. The gas bubbles 112 pass through the molten copper-based alloy 110 and entrain impurities, including oxygen and oxygen-related impurities, from the molten copper-based alloy 110, as described above. After the impurities are removed from the melting furnace 108, the molten copper-based alloy 110 is transferred from the melting furnace 108 to the transfer ladle 116 via a first velocity control element 114 at a first controlled velocity. In some embodiments, the transfer ladle 116 comprises one or more injectors 124.

The inventors have discovered that, under some circumstances, in addition to advantageously controlling the velocity of the molten alloy 110 being delivered from the melting furnace 108 to the transfer ladle 116 using the first velocity control element 114, it may be further advantageous to additionally control the velocity of the molten alloy 110 being delivered from the transfer ladle 116 to the molds 118. To address these and other needs, in the system 200 illustrated in FIG. 2, unlike the system 100 of FIG. 1 in which the molten alloy 110 is transferred directly to the molds 118 from the transfer ladle 116, after being transferred to the transfer ladle 116, the molten copper-based alloy 110 is transferred to the molds 118 via a second velocity control element 218. The second velocity control element 218 can be, e.g., a launder or a ramped channel, and can be enclosed and shielded from the external atmosphere. The molten alloy 110 solidifies in the molds 118 creating a solidified copper-based alloy. The molds 118 can be moved via a conveyer belt 120 where they may be further processed.

In addition to the first velocity control element 114, which may be configured as described above with respect to FIG. 1, the system 200 illustrated in FIG. 2 includes the second velocity control element 218. The added velocity control element provides added velocity control to further reduce reintroduction of oxygen or oxygen-related impurities into the molten copper-based alloy 1204 as it is introduced into the ingot molds 118. The second velocity control element 218 may be configured according to various configuration parameters described above with respect to the first velocity control element 114, including the dimensions and the slope, the detailed description of which is omitted herein for brevity.

Thus configured, in the system 200 illustrated in FIG. 1, after the molten alloy 110 having reduced content of oxygen or oxygen-related impurities is formed in the melting furnace 108 and transferred to the transfer ladle 116 using the first velocity control element 114 at a first velocity, the molten alloy 110 may be transferred to the ingot molds 118 using the second velocity control element 218 at a second velocity that is further reduced relative to the first velocity. In some embodiments, the velocity control element 218 is enclosed from the surrounding atmosphere. However, embodiments are not so limited and in some other embodiments, the second velocity control element 218 may be open to the surrounding atmosphere. In some embodiments, the atmosphere within the second velocity control element 218 can the same as that of the melting furnace 108 and/or the first velocity control element 114 and/or the transfer ladle 116. As such, the atmosphere within the second velocity control element 218 may be argon, nitrogen, and/or any suitable inert gas.

The second velocity control element 218 is configured to transfer the molten alloy 110 from the transfer ladle at a velocity having any value as described above with respect to the velocity of the molten copper-based alloy 110 as controlled by the first velocity control element 114. However, it will be appreciated that, because the velocity of the molten alloy 110 arriving the second velocity control element 218 is already reduced by the first velocity control element 114, the velocity of the molten alloy 110 arriving at the mold 118 will be substantially lower than that of the molten alloy 110 arriving at the molds 118 without the presence of the second velocity control element 218, e.g., as illustrated in FIG. 1. According to various embodiments, the second velocity of the molten alloy 110 at the terminal end of the second velocity control element 218 is 20%, 30%, 40%, 50%, 60%, 70%, or a value in a range defined by any of these values, of the first velocity of the molten alloy at the terminal end of the first velocity element 112.

As discussed above with respect to FIG. 1, the inventors have discovered that the turbulence caused by vertically dropping molten alloy 110 can introduce or reintroduce oxygen or oxygen-related impurities in the molten alloy 110. As such, the vertical drop between the injecting tip of the injectors 124 and the second velocity control element 218, as well as the vertical drop between the second velocity control element 218 and the molds 118 should not exceed 0.5″, 1.0″, 1.5″, 2.0″ or have a value in a range defined by any of these values, in order to prevent excessive turbulence.

Thus configured, the second velocity control element 218 is configured to transfer the molten copper-based alloy 110 from the transfer ladle 216 to the ingot molds 118 at a substantially reduced velocity and without a vertical drop.

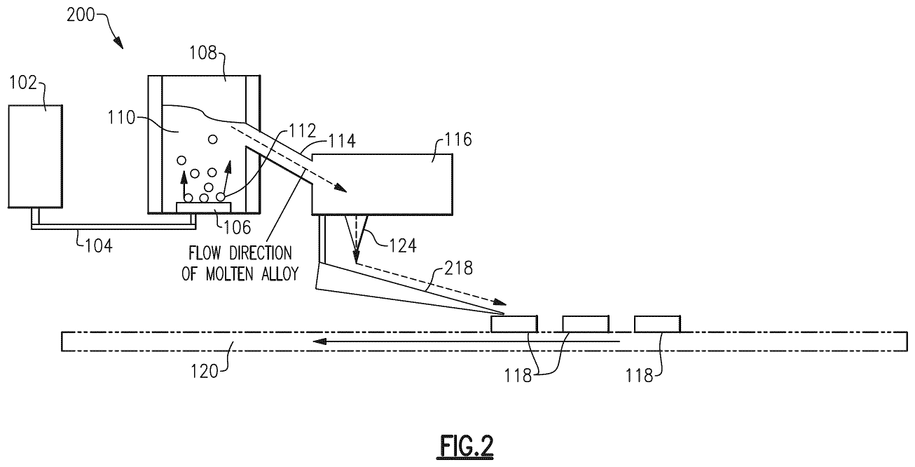

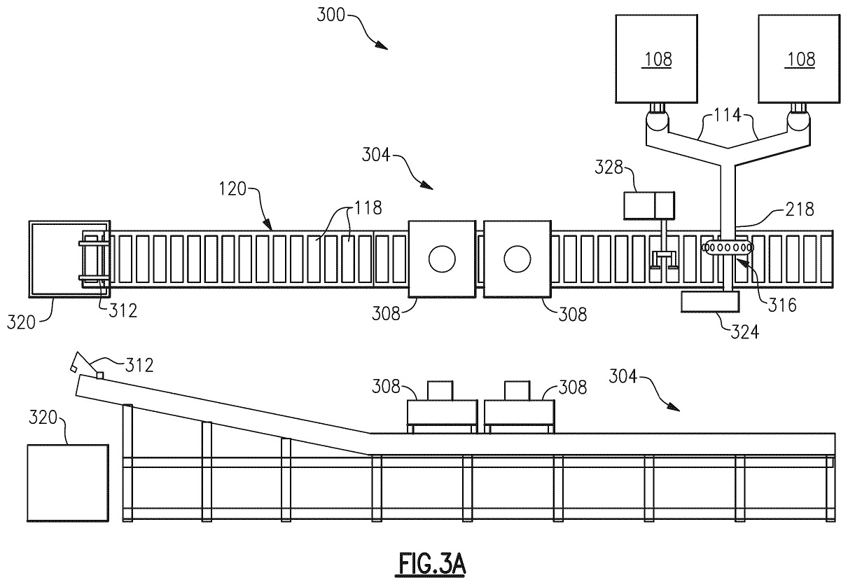

FIG. 3A is a schematic illustration of an enclosed sparging furnace system 300 for manufacturing a copper-based alloy, e.g., ingot, copper-based shot, or copper-based component, having low content of oxygen or oxygen-related impurities, according to another embodiment. In particular, the system 300 illustrates one example implementation of a conveyor system 304. The upper illustration represents a top-down view of the system 300 including the conveyor system 304 and the lower illustration represents a side view of the conveyor system 304. The enclosed sparging furnace system 300 shares various components that are broadly configured similarly to the corresponding components of the enclosed sparging furnace system in 100 and 200 described above with respect to FIG. 1 and FIG. 2 respectively, and a detailed description of those components may be omitted herein for brevity. Unlike the systems 100 and 200 described above with respect to FIGS. 1 and 2, the system 300 comprises two melting furnaces 108 for higher productivity. However, embodiments are not so limited and it will be appreciated that any one of the systems 100, 200 and 300 can have a suitable number of melting furnaces 108, e.g., one or more. After the oxygen-related impurities are removed from the melting furnaces 108 in a similar manner as described above, the molten copper-based alloy 110 is transferred from the melting furnace 108 to a transfer wheel 316 via a first velocity control element 114 at a first controlled velocity and optionally further via a second velocity control element 218 at a second controlled velocity, which may be the same as or lower than the first velocity. Unlike the systems 100 and 200 described above with respect to FIGS. 1 and 2, the second velocity control element 218, when present, is connected directly to the first velocity control element 114, without being separated by a transfer ladle. Thereafter, the molten alloy 110 is ejected into one or more molds 118. Further unlike the systems 100 and 200 (FIGS. 1 and 2), in the illustrated system 300, the molten alloy 110 is ejected into the molds 118 using the transfer wheel 316, also referred to as a casting wheel, described further in detail with respect to FIGS. 3B and 3C. Thus ejected molten alloy 110 is dropped into one or more molds 118 and are conveyed by a conveyer belt 120 of the conveyor system 304. The conveyor belt 120 may be driven by a suitable driver assembly, which may include, e.g., a motor drive 324. The conveyor system 304 may optionally include, e.g., cooling fans 308 and knockers 312 to loosen the ingots from the molds, to be collected into a collection bin 320.

FIG. 3B and FIG. 3C show a detailed perspective view and a side view, respectively, of a portion of the system 300 illustrated in FIG. 3A for manufacturing a copper-based alloy having low content of oxygen or oxygen-related impurities, according to some other embodiments. The portions of the system 300 illustrated in FIGS. 3B and 3C show additional details of the system 300 including the arrangements of the transfer wheel 316 and the conveyor belt 120. The side view of FIG. 3C is that along the direction of movement of the conveyor belt 120. Notably, as described above with respect to FIG. 3A, in the system 300, the molten alloy 110 is ejected into the molds 118 via a transfer wheel 316 instead of a transfer ladle 116 described with respect to FIGS. 1 and 2. Unlike the transfer ladle 116 (FIGS. 1 and 2), in which the injectors 124 are separated by a linear distance, e.g., along a bottom surface of the transfer ladle 116, in the transfer wheel 316, the injectors 328 are separated by an arc defined by an angle of separation therebetween, and extend in different directions. As shown in FIGS. 3B and 3C, the transfer wheel 316 is configured to rotate about a central radial (z) axis. Without limitation, in the illustrated transfer wheel 316, the z axis extends generally in the direction of flow of the molten metal 110 in the second velocity control element 218.

The plurality of injectors 328 of the transfer wheel 316 are sloped to radially extend at oblique angles relative to the z axis. The oblique angles of extension of the injectors 328 are such that, instead of ejecting the molten metal 110 vertically into the molds 118 as described above with respect to the arrangement shown in the systems 100 and 200 (FIGS. 1 and 2), the slopes of the injectors 328 allow for further reduction of the velocity of the molten alloy 110 as it is delivered to the molds 118.

A motor drive 324 is configured to synchronize the motion of the transfer wheel 316 and the conveyor belt 120. The motor drive 324 is configured to rotate the transfer wheel 316 about the z axis at a predetermined angular velocity, and to linearly translate the molds 118 disposed at regular intervals such that adjacent ones of the sloped injectors 328 of the transfer wheel 316 are separated by an arc corresponding to the linear distance between adjacent ones of the mols 118. Thus, as the transfer wheel 316 rotates, the adjacent ones of the molds 118 are filled with the molten metal 110 by the corresponding ones of the injectors 328.

Referring to FIG. 3B, disposed at the end each arm of the first velocity control element 114 is a gate valve 332. The gate valve 332 is configured to keep the molten metal 110 enclosed and under an inert atmosphere until it is ready to be transferred to the transfer wheel 316. For illustrative purposes, the second velocity control element 218 is shown as being open at the top portion thereof. However, in operation, the second velocity control element 218 may also be enclosed under an inert atmosphere, to benefit therefrom as described above.

According to various embodiments, the apparatus is configured such that a molten copper-based alloy that is formed and finally solidifies in the molds 118 according to embodiments has substantially lower oxide content relative to copper-based alloys produced using conventional copper furnaces. In some embodiments, the solidified copper-based alloy has an oxide content 5%, 10%, 15%, 20%, 25%, 30%, 50%, 75%, or up to 99% or any values therebetween lower than solidified copper-based alloys produced by a conventional reference furnace using the same feedstock material.

According to various embodiments, the apparatus according to embodiments is configured such that one or more testing results obtained using an ASTM E8/E8M-21 method from the solidified copper-based alloy has, relative to a reference solidified copper-based alloy formed from a reference apparatus configured to be the same as the apparatus except for the melting furnace and the transfer ladle being under the same enclosed inert atmosphere, one or more of an ultimate tensile strength that is increased by at least 10, 20, 40, 50 ksi or a value in a range defined by any of these values; 0.5% yield strength that is increased by at least 1, 2, 3, 6, 8, 10 ksi or a value in a range defined by any of these values; an elongation that is increased by at least 3%, 5%, 10%, 20%, 30%. 40%, 50%, or a value in a range defined by any of these values; and a reduction in cross-sectional area that increased by at least 3, 5, 10% or a value in a range defined by any of these values.

### Systems for Manufacturing High Purity Copper-Based Alloys Including Enhanced Diffuser Assembly

In the above, various aspects of furnace systems configured for manufacturing a copper-based alloy with reduced impurity content, and methods of manufacturing a copper-based alloy using such systems, have been described. As described above, among other things, controlling the inert gas bubble characteristics can be critical for producing an optimized condition for reducing the impurity content from the molten copper-based alloy 110. The bubble characteristics include the bubble size, density per unit volume and velocity distributions. These bubble characteristics are in turn determined by various flow characteristics, including the flow rate, the flux and the pore size distribution through the diffuser 106.

In the illustrated melting furnaces 108A, 108B (FIGS. 1A and 1B), the diffuser 106 has a diameter d (FIG. 1A) that is smaller than the diameter D of the melting furnace 108. The diffuser 106 is described further with respect to FIGS. 4A-4C. As illustrated in FIG. 4A, the diffuser material or medium 412 is connected to the inlet 404 for flowing inert gas therethrough. The diameter d of the diffuser 106 in contact with the molten copper-based alloy 110 may be optimized to flow the inert gas uniformly out of its outer surface. The porosity may be optimized to control the size of the inert gas bubbles. The inventors have discovered that, because the diameter d or the area of the diffuser 106 is smaller than the diameter D or the area of the melting furnace 108A, 108B, the inert gas bubbles 112 may not flow substantially across the entire cross section of the molten copper-based alloy 110. As a result, depending on the diffusivities of impurities, the molten copper-based alloy 110 outside of the path of the inert gas bubbles 112 may not be as effectively purified. As such, the inventors have recognized a need to increase the cross-sectional area of the molten copper-based alloy 110 through which the inert gas bubbles traverse towards a surface thereof.

To address these and other needs, to further improve upon various embodiments disclosed herein, further embodiments of an apparatus for manufacturing a copper-based alloy comprises a melting furnace configured to form a molten copper-based alloy comprising at least 50 weight % copper. According to embodiments the melting furnace 108 comprises a diffuser assembly comprising one or more diffuser lining. The diffuser assembly comprises a diffusive lining formed on a surface of the melting chamber wall. The diffusive lining can be employed in addition to or in lieu of the diffuser 106 described above.

FIGS. 6A and 6B are schematic side view illustrations of a melting furnace comprising a diffuser assembly for manufacturing high purity copper-based alloys, according to some embodiments. The diffuser assembly includes one or both of a diffuser 400 and a diffusive lining 400A, 400B. Unlike the melting furnace 108A, 108B described above with respect to FIGS. 1A and 1B, in which the diffuser 400 is configured to contact the molten copper-based alloy 110, in the illustrated embodiments in FIGS. 6A and 6B, the diffuser 400 is disposed at a depth inside the diffusive lining 400A, 400B. As configured, the inert gas diffusing out of the diffuser 400 traverses the diffusive lining 400A disposed thereover, such that inert gas is further diffused by the diffusive lining 400 before being introduced into the molten copper-based alloy 110. According to various embodiments, the diffusive lining 400A, 400B comprises a porous high temperature refractory ceramic material. The ceramic material comprises an aluminum-silicate having a porous structure adapted for bubbling an inert gas through the molten copper-based alloy. It will be appreciated that, while the refractory lining 130A, 130B described above with respect to FIGS. 1A, 1B can have a similar structure as the diffusive lining 400A, 400B and/or be formed using a similar method, as described herein, the diffusive lining 400A, 400B serves an important function of further diffusing the inert gas before being introduced into the molten metal 110 to form the inert gas bubble therein.

FIG. 6A illustrates a melting furnace 600A including a diffusive lining 400A, which substantially covers a bottom inner surface thereof and having a porous structure adapted for bubbling an inert gas into the molten copper-based alloy 110. FIG. 6B illustrates a melting furnace 600B including a diffusive lining 400A, 400B formed on at least two different inner surfaces thereof, e.g., bottom and sidewall surfaces of the melting furnace 608B.

The melting furnace 608A includes various features described above with respect to the melting furnace 108 (FIGS. 108A, 108B) described above with respect to FIGS. 1, 1A. 1B and 2. The melting furnace 608A can be configured as an enclosed melting furnace similar to the melting furnace 108A (FIG. 1A) or an open melting furnace 108B (FIG. 1B). As disclosed herein, unless indicated contrariwise, a reference made to the melting furnace 108 will be understood to apply to one or both of melting furnaces 108A, 108B. As described above with respect to FIGS. 1A and 1B, the melting furnace 608A, 608B receives the inert gas supply 102 through diffuser 400. The melting furnace 608A, 608B is enclosed by a chamber wall 134 comprising a suitable refractory material\. The chamber wall 134 may be formed of relatively airtight refractory material, such that ambient air does not contaminate the molten copper-based alloy 110. The melting furnace 608A, 608B is surrounded by a coil 138 for inductive heating of the feedstock, as described above.

In the melting chamber 608A illustrated in FIG. 6A, the diffuser assembly according to embodiments includes the diffuser 400 and the diffusive lining 400A. Advantageously, the diffusive lining 400A envelopes the diffuser 400 covers a larger area relative to the diffuser 400. As configured, the upper surface of the diffuser 400 is disposed below an upper surface of the diffusive lining 400A. The inert gas diffusing out of the diffuser 400 traverses and further diffuses over a thickness of the diffusive lining 400A formed over the diffuser 400. As a result, the diffusive lining 400A substantially increases the cross-sectional area of the molten copper-based alloy 110 through which inert gas bubbles 612 travers in a vertical direction, relative to having the diffuser 400 alone, e.g., as described above with respect to FIGS. 1A and 1B. The inventors have found that, when the inert gas enters the molten copper-based alloy 110 directly from a diffuser 400, due to the limited thickness and surface area of the diffuser 400, the inert gas bubbles may not enter the molten copper-based alloy 110 uniformly across a cross section thereof, but rather through an effective area that is much smaller than that of the cross sectional area of the molten copper-based alloy 110. On the other hand, with the illustrated two stage diffuser assembly, the inert gas first diffuses through the diffuser 400 and further diffuses through the diffusive lining 400A. Because the inert gas exiting the diffuser 400 already flows out through an increased cross-sectional area relative to the cross-sectional area of the gas line, further diffusing the inert gas through the diffusive lining 400A is facilitated, and the inert gas exiting the diffusive lining 400A can flow substantially uniformly through substantially the entire cross-sectional area of the molten copper-based metal 110. As a result, as illustrated in FIG. 6A, the inert gas bubbles 612 cover a substantially larger cross-sectional area relative to a cross-sectional area covered by the diffuser 400 alone. The inventors have discovered that the impurity removal efficiency for a given flow rate of inert gas can be substantially improved by using the two-stage diffuser assembly.

In the melting chamber 608B illustrated in FIG. 6B, the diffuser assembly according to embodiments includes the diffuser 400 and the diffusive lining 400A, in a similar manner as illustrated in the melting chamber 608A (FIG. 6A). Advantageously, in addition to the diffusive lining 400A covering the bottom surface of the melting chamber 608B, the melting chamber 608B further includes a diffusive lining 400B covering sidewalls of the melting chamber 608B. The diffusive lining 400A, 400B covering bottom and sidewall inner surfaces is adapted for further increasing the cross-sectional area of the molten copper-based alloy 110 through which inert gas bubbles 612 passes. In addition to the diffusive lining 400A covering a larger area of the molten copper-based alloy 110 through which inert gas bubbles pass through in a vertical direction relative to having the diffuser 400 alone, the diffusive lining 400B further allows for inert gas bubbles 612 to enter the molten copper-based alloy 110 in a lateral or horizontal direction at side surfaces of the molten coper-based alloy 110. With the illustrated three stage diffuser assembly, the inert gas first diffuses through the diffuser 400 and further diffuses through the diffusive lining 400A as described above with respect to FIG. 6A. In addition, a portion of the inert gas exiting the diffusive lining 400A that is not bubble through the molten copper-based alloy 110 enters the diffusive lining 400B. The inert gas entering the diffusive lining 400B diffuses further therein, before entering the molten copper-based alloy 110 at the sidewalls in a lateral direction. As a result, as illustrated in FIG. 6B, the inert gas bubbles 612 cover a substantially larger cross-sectional area relative to having the diffuser 400 alone, the diffusive lining 400A alone, or a combination of the diffuser 400 and the diffusive lining 400. The inventors have discovered that the impurity removal efficiency for a given flow rate of inert gas can be substantially improved by using the three-stage diffuser assembly.

It will be appreciated that, in addition to increased surface area of the molten copper-based alloy 110 through which inert gas is introduced for improved removal of impurities that are already present in the feedstock, the diffusive lining 400A, 400B allows for removal of excess moisture or oxygen that may be absorbed on the chamber walls of the melting furnace 608A, 608B prior to melting the feedstock. Because substantial surface area of the melting furnace 608A, 608B is covered with the diffusive lining 400A, 400B, flowing the inert gas through the diffuser 400, diffusive lining 400A, 400B prior to melting the feedstock material can substantially prevent oxygen and/or moisture from the chamber walls from entering the molten copper-based alloy 110. Without the diffusive lining 400A, 400B, the oxygen and/or moisture that is absorbed on the inner surfaces the melting furnace 608A, 608B can be released and introduced into the molten copper-based alloy 110, which has detrimental effect on the resulting copper-based alloy as described above, including ingots and shots.

Various parameters associated with the operation of the melting furnaces 608A, 608B are substantially similar to those described above with respect to FIGS. 1, 1A, 1B and 2, and the details of the same features are not repeated herein for brevity.

FIG. 6C is a cross sectional view of the diffusive lining 400A, 400B according to various embodiments. The diffusive lining 400A, 400B according to various embodiments includes a refractory material including alumina, silica and aluminosilicate. The composition is such that the molten copper-based alloy 110 is not contaminated at high temperatures. In addition to the chemical composition adapted for high temperature melting of copper-based alloys, the diffusive lining 400A, 400B has physical structure adapted for mechanical strength in addition to optimized porosity for controlling the inert gas bubble characteristics, in a similar manner as described above with respect to the diffuser 400.

The inventors have discovered that the various chemical and physical characteristics adapted for effective sparging as described herein can be satisfied using a diffusive lining 400A, 400B having at least two different layers or regions. The diffusive lining 400A includes an upper layer or region 400A-2 and a lower layer or region 400A-1. and the diffusive lining 400B includes an upper layer or region 400B-2 and a lower layer or region 400B-1. The upper layer 400A-2, 400B-2 is configured to be closer to, e.g., to contact, the molten copper-based alloy 110, and is configured to be interposed between the lower layer 400A-1, 400B-1 and the molten copper-based alloy 110.

According to embodiments, the upper layer 400A-2, 400B-2 is formed of a sintered ceramic layer, while the lower layer 400A-1, 400B-1 is formed of an unsintered ceramic layer. In particular, the upper layer 400A-2, 400B-2 may be a partly or locally sintered ceramic layer, where neighboring ceramic grains are partially fused while leaving gaps therebetween, to retain a porous surface for diffusing the inert gas therethrough. In contrast, the lower layer 400A-1, 400B-1 may be an unsintered ceramic layer, e.g., a compacted ceramic power layer, where neighboring ceramic grains contact each other without being fused by sintering, also having gaps therebetween, for diffusing the inert gas therethrough. Such two layer structure provides mechanical stability to the diffusive lining 400A, 400B, while providing the high porosity adapted for diffusing the inert gas into the molten copper-based alloy 110.

While embodiments are not so limited, in some embodiments, the upper layer 400A-2, 400B-2 and the lower layer 400A-1, 400B-1 are formed from the same initial compacted ceramic powder layer. As described further below, a surface portion of a compacted ceramic powder layer may be partially sintered to form the two-layer structure. In these embodiments, the sintered upper layer 400A-2, 400B-2 and the unsintered lower layer 400A-1, 400B-1 have substantially the same chemical composition while having different phases. That is, the initial compacted ceramic powder layer may include component ceramic compounds that form a new phase of the upper layer 400A, 400B-2 upon sintering. The inventors have found that one ceramic powder composition that is particularly suitable is a mixture of alumina and silica configured to form mullite upon sintering.

Mullite (3Al₂O₃·2SiO₂) is particularly suitable as the upper layer 400A-1, 400B-1 because of its low density, high thermal stability, high chemical stability in severe environments, low thermal conductivity and favorable strength and creep behavior. Mullite is the only thermodynamically stable crystallized compound in the phase diagram of the alumina-silica (Al₂O₃—SiO₂) system. The compound incongruently melts at a temperature of 1828±10° C. Thus, according to embodiments, the initial compacted powder layer includes a mixture having a composition that can form a substantial volume fraction of mullite.

The two-layer structure is formed by, as described further below, locally subjecting the surface of a compacted ceramic powder layer to a sintering temperature sufficient to form mullite from the power composition. The resulting two-layer structure includes an upper sintered layer 400A-2, 400B-2 comprising mullite, and a lower unsintered layer 400A-1, 400B-1 formed predominantly alumina and silica. According to some embodiments, the two-layer structure is formed using a powder composition comprising alumina in an amount of 50-80 mol %, 55-75 mol %, 60-70 mol %, or a mol % in a range defined by any of these values, for instance about 65 mol %. The powder composition further comprises silica in an amount of 10-35 mol %, 15-30 mol %, 20-25 mol %, or a mol % in a range defined by any of these values, for instance about 24 mol %. The powder composition may further comprise SiC in an amount of 2-8 mol %, 4-6 mol % or about 5 mol %, TiO₂ in an amount of 1-3 mol %, 1.5-2.5 mol % or about 2.2 mol %, and Fe₂O₃ in an amount of 0.5-2 mol %, 1-1.5 mol % or about 1.2 mol %. It will be appreciated that substantial deviation from a mullite-forming composition can lead to insufficient mechanical, thermal or chemical stability. For example, the Al₂O₃—SiO₂ system has eutectic composition with melting points 1587±10° C., corresponding to the composition of approximately 6 mol % Al₂O₃, which may lead to lower performance with respect to various properties described above.

The inventors have discovered that a suitable average particle size of the starting powder for forming the diffusive lining 400A, 400B can be defined using what is known in the industry as the phi (f) scale, which is based on the relationship D=D₀(2^{-f}), where D₀ is a reference diameter of 1 mm. For example, f scales of 2 to 1, 3 to 2, 4 to 3 and 8 to 4 correspond to 0.25-0.5 mm, 125-250 mm, 62.5-125 mm and 3.9-62.5 mm, respectively. The inventors have determined that a suitable average particle size of the mullite-forming powder is less than 125 mm, 100 mm, 75 mm, 50 mm, for instance less than 63 mm corresponding to a f number of 4.

According to various embodiments, the diffusive lining 400A, 400B has a suitable thickness such that the inert gas diffuses out of the diffusive lining 400A, 400B through substantial area portions thereof. The diffusive lining 400A, 400B according to various embodiments has a thickness greater than 2 inches, 3 inches, 4 inches, 5 inches, 6, inches, 7 inches, or a thickness in a range defined by any of these values. In FIGS. 6A and 6B, this thickness corresponds to the thickness of the diffusive lining 400A above the surface of the diffuser 400, and in FIG. 6B, this thickness corresponds to the thickness of the diffusive lining 600B. For instance, the diffusive material or medium of the diffuser 400 can be about 2 inches, and the thickness of the diffusive lining 400A above the suffer 400 can be about 3-4 inches, for a combined thickness of 5-6 inches. Similarly, the thickness of the diffusive lining 400B can be about 3-4 inches. It will be appreciated that if the thickness of the diffusive lining 400A, 400B is too thin, insufficient spreading of the inert gas may occur, leading to localized bubble formation as opposed to bubble formation across substantial cross-sectional area of the molten copper-based metal 110.

Still referring to FIG. 6C, according to various embodiments, the sintered top layer 400A-2, 400B-2 has a thickness less than 1 inch, 0.8 inch, 0.6 inch, 0.4 inch, 0.2 inch, 0.1 inch, or a value in a range defined by any of these values. The remainder of the diffusive lining 400A, 400B can be the unsintered bottom layer 400A-1, 400B-1.

Further, the diffusive lining 400A, 400B has a porosity, defined as a ratio of void space to the overall macroscopic volume, which is greater than 10%, 15%, 20%, 25%, 30%, 35%, or a value in a range defined by any of these values.

According to some embodiments, the diffusive lining 400A, 400B has the same structure and/or composition as the diffuser 400. That is, the diffuser 400 may have the same mullite forming composition and may have a two-layer structure including a sintered ceramic layer and an unsintered ceramic layer. Advantageously, matching the composition and/or structure of the refractory material between the diffuser 400 and the diffusive lining 400A, 400B can allow optimized flow of the inert gas through the diffuser 400, further through refractory lining 400A, 400B and into molten copper-based metal 110. However, embodiments are not so limited, and in other embodiments, the diffusive lining 400A, 400B can have a composition and structure that is different from those of the diffuser 400.

Referring back to FIGS. 6A and 6B, while in illustrated embodiments the diffusive lining 400A and 400B cover substantially the entire bottom and sidewall surfaces of the melting furnace 608A, 608B, respectively, embodiments are not so limited. For example, the diffusive lining 400A may have a diameter that is greater than that of the diffuser 400 while being smaller than that of the inner diameter D (FIG. 1A) of the melting furnace 608A, 608B. For example, the diameter of the diffusive lining 400A may be less than 0.8 D, 0.6 D, 0.4 D or a value in a range defined by any of these values. Similarly, the diffusive lining 400B may have a height that is smaller relative to that of the fill line height F (FIG. 1A) of the melting furnace 608A, 608B. For example, the height of the diffusive lining 400B may be less than 0.8 F, 0.6 F, 0.4 F or a value in a range defined by any of these values.

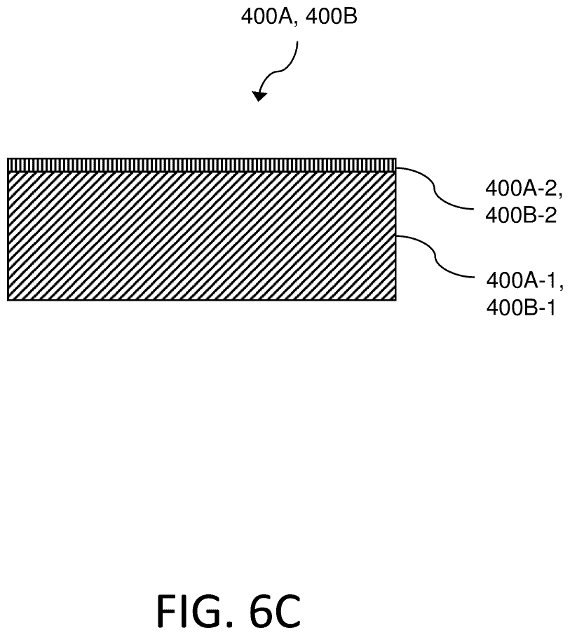

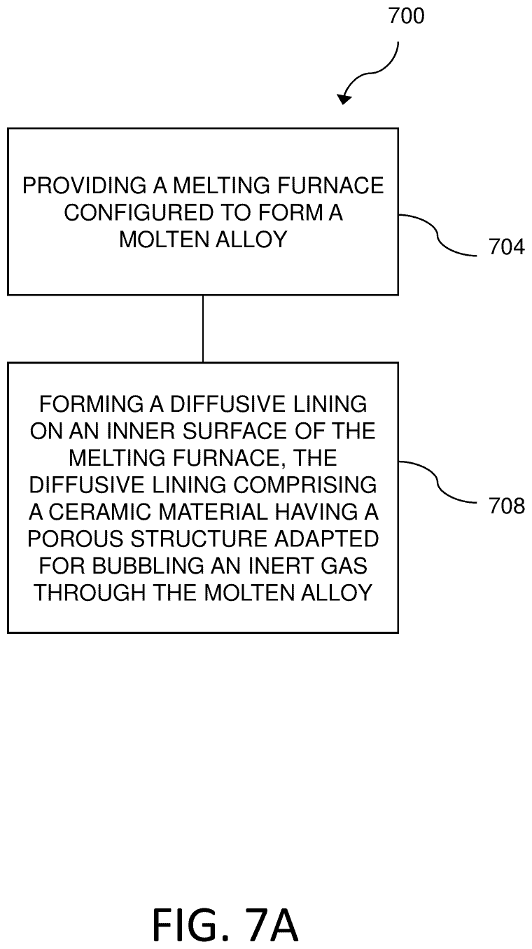

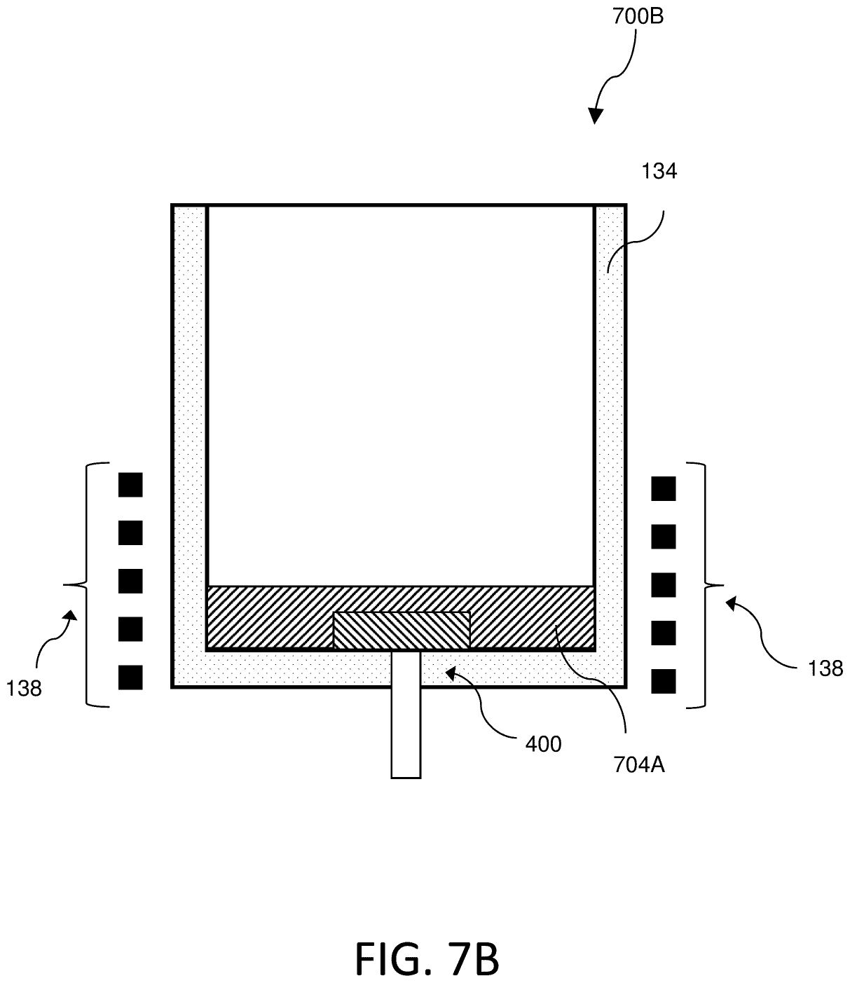

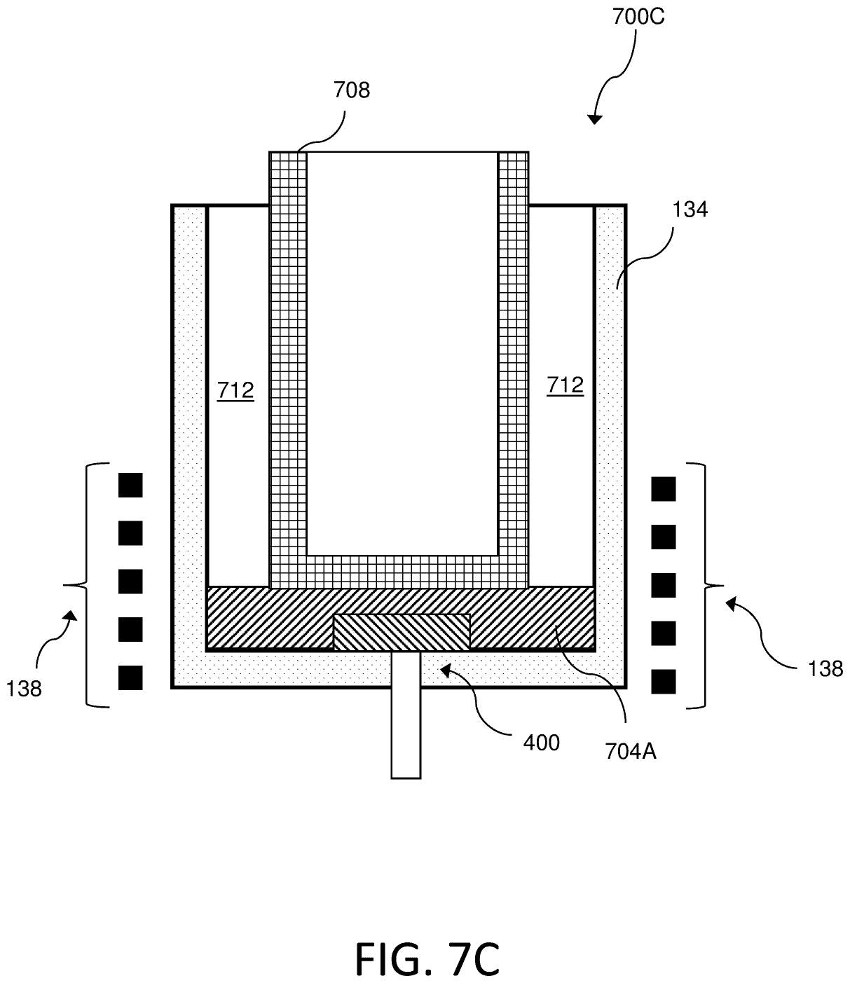

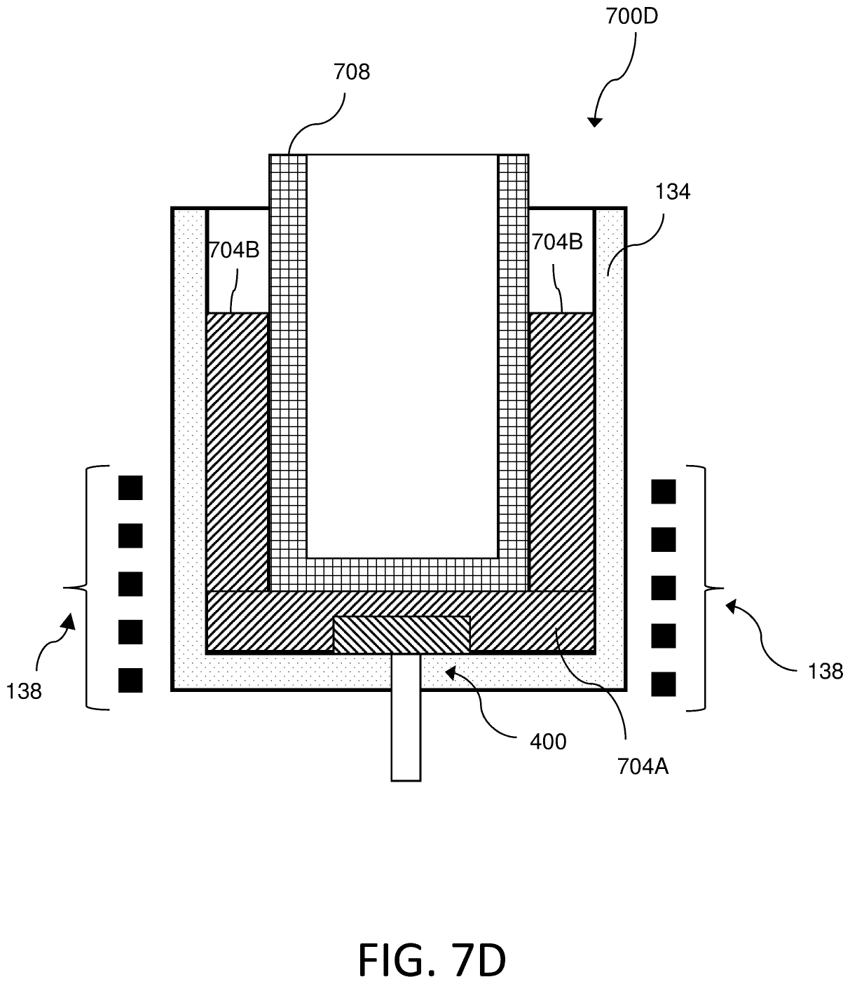

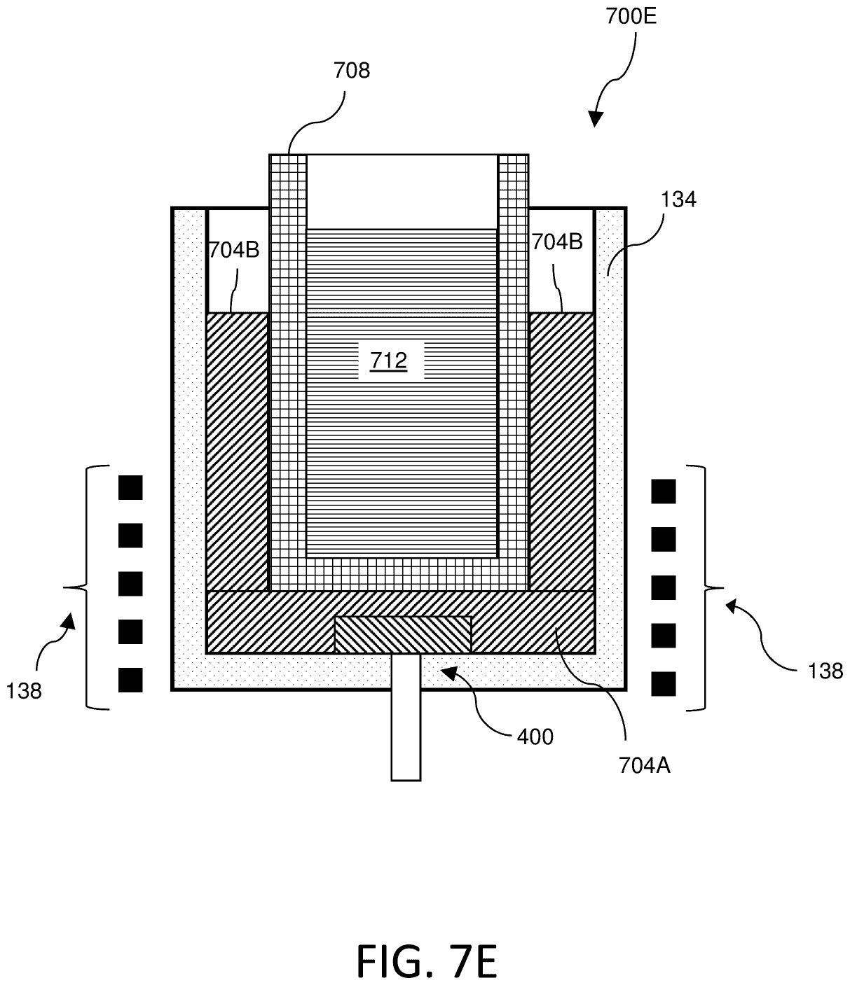

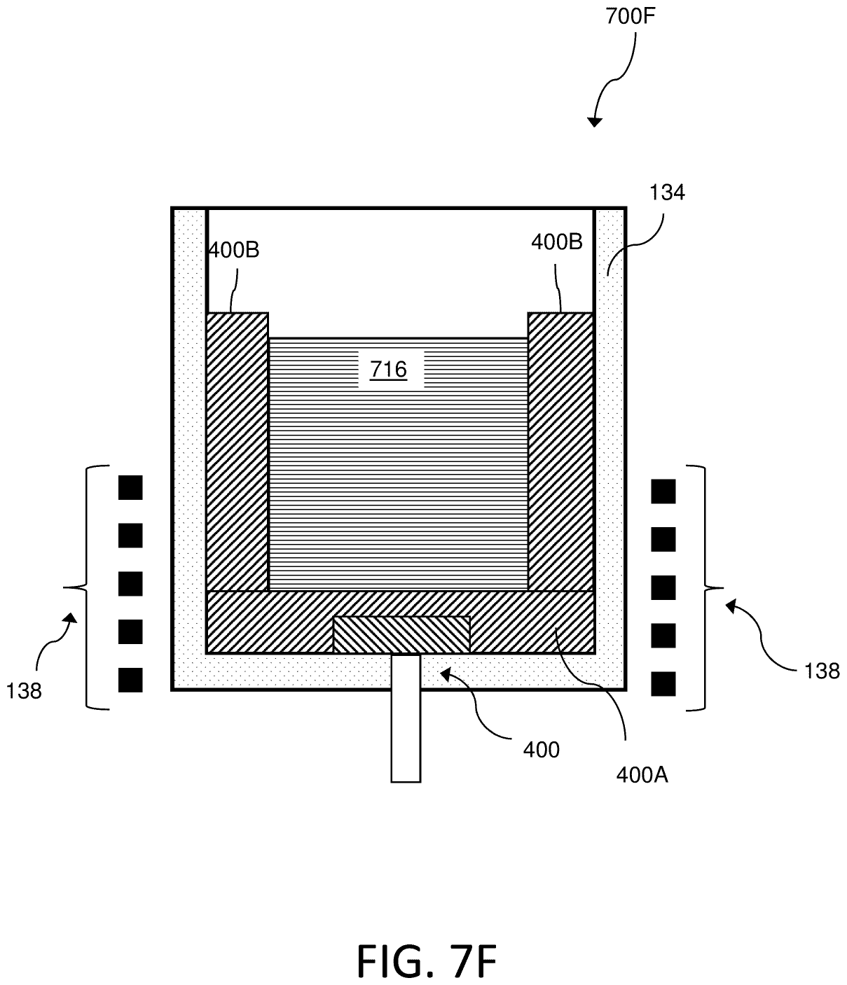

In the following, a method of manufacturing a melting furnace including a diffusive lining is described. FIG. 7A illustrates a method of forming a diffusive lining in a melting furnace for manufacturing high purity copper-based alloys, according to various embodiments. The method 700 includes providing 704 a melting furnace chamber configured to form a molten alloy. The method additionally includes forming 708 a diffusive lining on an inner surface of the melting furnace chamber, where the diffusive lining comprises a ceramic material having a porous structure adapted for bubbling an inert gas through the molten copper-based alloy.

According to various embodiments, providing 704 the molten alloy comprises providing a copper-based alloy comprising at least 50 weight % copper. According to various embodiments, forming 708 the diffusive lining comprises providing the diffusive lining comprising a ceramic material such as an aluminum-silicate ceramic material having a porous structure adapted for bubbling an inert gas through the molten copper-based alloy. According to various embodiments, forming 708 the diffusive lining comprises substantially covering a bottom inner surface of the melting furnace and having a porous structure adapted for bubbling an inert gas into the molten copper-based alloy. According to various embodiments, providing 708 the diffusive lining comprises forming a diffusive lining having a porous structure on at least two different inner surfaces of the melting furnace such that the diffusive lining is adapted for bubbling an inert gas into the molten copper-based alloy from the at least two different inner surfaces.

According to various embodiments, forming 708 the diffusive lining comprises disposing a compacted powder layer on an inner surface of the melting furnace chamber. The compacted ceramic powder layer comprises a mixture of silica and alumina. Forming 708 the diffusive lining further comprises sintering the compacted ceramic powder layer in the melting furnace to form a diffusive lining on the inner surface. According to embodiments, sintering includes selectively sintering a surface portion of the compacted ceramic powder layer, thereby forming a diffusive lining on the inner surface comprising a two layer structure, which includes a sintered ceramic layer on an unsintered ceramic layer. According to embodiments, sintering the compacted ceramic powder layer includes in situ sintering using power from the melting furnace itself. In particular, sintering the compacted ceramic powder layer includes using heat from a heated material disposed in the melting furnace chamber, to form the diffusive lining on the inner surface. Thus formed diffusive lining comprises an aluminum-silicate ceramic material having a porous structure adapted for diffusing the inert gas therethrough. The method 700 is further described herein with respect to FIGS. 7B-7F.

FIGS. 7B-7F are schematic side view illustration of a melting furnace at various stages of forming a diffusive lining therein, to configure the melting furnace for manufacturing high purity copper-based alloys, according to the method 700 illustrated in FIG. 7A.

Referring to FIG. 7B, providing 704 the melting chamber comprises providing a melting furnace 700B that is similar to the melting chamber 108A, 108B described above with respect to FIGS. 1A and 1B. The melting furnace 700B includes a frame including a chamber wall 134 formed of a suitable refractory material that is relatively airtight. A diffuser 400 is installed over a central region of the bottom inner surface of the melting furnace 700B. The inert gas is introduced into the molten copper-based alloy 110 via the gas inlet 404 formed through a bottom plate of the melting furnace 700B, as shown above with respect to FIG. 4C.

After installing the diffuser 400, a compacted ceramic powder layer 704 for forming the diffusive lining 400A (FIGS. 6A-6C) is formed over the bottom inner surface of the melting furnace 700B. To form the compacted ceramic powder layer 704A, a ceramic powder having the composition and particle size as described above with respect to FIGS. 6A-6C is poured on the bottom surface of the melting furnace 700B and over the diffuser 400. The ceramic powder is tapped to remove air pockets and densify into a compacted ceramic powder layer 704A having a thickness described above with respect to FIGS. 6A-6C.

Referring to FIGS. 7C and 7D, after forming the compacted ceramic powder layer 704A at the base or the bottom surface of the melting furnace 700B (FIG. 7B), further compacted ceramic powder layer 704B for forming the diffusive lining 400B (FIGS. 6B-6C) is formed on the sidewall surface of the melting furnace 700C. Referring to FIG. 7C, a heating can 708 is disposed on the compacted ceramic powder layer 704A. The heating can 708 is formed of a metal that can form a molten metal liquid by in-situ inductive heating thereof using the induction coil 138. The heating can 708 is configured to be heated to a temperature sufficient for it to be melted. along with a feedstock disposed therein, to provide the heat for partially or locally sintering the compacted ceramic powder layer 704A, 704B in contact therewith. According to embodiments, without limitation, the heating can 708 can be formed of an iron-based alloy such as a mild steel. The heating can 708 has dimensions such that the width of a gap 712 formed between the outer surface of the heating can 708 and the inner sidewall of the melting furnace 700C corresponds to the final thickness of the diffusive lining 400B.

Referring to FIG. 7D, to form the compacted ceramic powder layer 704B, a ceramic powder having the composition and particle size as describe above with respect to FIGS. 6A-6C is poured into the gap 712 between the sidewall of the melting furnace 700C (FIG. 7C) and the outer surface of the heating can 708. The ceramic powder is tapped to remove air pockets and densify into a compacted ceramic powder layer 704B having a thickness defined by the width of the gap 712 and a height corresponding to the fill line (F) or a fraction thereof, as described above with respect to FIGS. 6A-6C. It will be appreciated that, if only the diffusive lining 403A is to be formed, e.g., as illustrated in FIG. 6B, the formation of the ceramic powder layer 704B can be omitted.

Referring to FIGS. 7E and 7F, thus formed compacted ceramic powder layers 704A and 704B on the bottom surface and sidewall surface of the melting furnace 700E, respectively, are ready to be partially or locally sintered to form the two-layer structure described above with respect to FIG. 6C. The partial or local sintering at the surface regions of the ceramic powder layers 704A, 704B is performed in situ using the induction coil 138. In particular, the local sintering is performed indirectly using the induction coil 138, using heat from a molten liquid formed by melting the can 708 and a heating feedstock disposed therein, as described herein. Referring to FIG. 7E, the can 708 is filled with a heating feedstock 712. Similar to the heating can 708, the heating feedstock 712 is formed of a metal, e.g., an iron-based feedstock that can form a heating molten metal mixture and be heated in situ in the melting furnace 700E, using the induction coil 138, to a temperature sufficient to partially or locally sinter the compacted ceramic powder layer 704A, 704B in contact therewith. According to embodiments, without limitation, the heating feedstock 712 can be formed of an iron-based material such as a mild steel or cast iron. The heating feedstock 712 and the heating can 708 can be formed of the same material or different materials. Regardless, the heating feedstock 712 and the heating can 708 are both adapted to melt and form a heating molten metal mixture that can be heated to a temperature sufficient to sinter at least the surface region of the compacted ceramic powder layers 704A, 704B.

Referring to FIG. 7F, after filling the heating can 708 with the heating feedstock 712, both the heating can 708 and the heating feedstock 712 are inductively heated using the induction coil 138 to a temperature high enough to form a heating molten metal mixture 716 comprising molten mild steel and/or cast iron. The heating molten metal mixture 716 is further heated to a temperature sufficient to provide the heat sufficient to partially or locally melt the compacted ceramic powder layers 704A, 704B, e.g., at surface regions thereof, on the bottom and sidewall surfaces of the melting furnace 700F.

It will be appreciated that the heating condition to form the heating molten metal mixture 716 depends on the sintering temperature for the compacted ceramic powder layers 704A, 704B to sinter at least the surface regions thereof to form, e.g., the two-layer structure described above with respect to FIG. 6C. According to embodiments, the sintering temperature used can be greater than 0.7 Tₘ, 0.75 Tₘ, 0.8 Tₘ and 0.85 Tₘ and less than 0.9 Tₘ, or a value in a range defined by any of these values, where Tₘ is the melting temperature of the compacted ceramic powder layers 704A, 704B. For example, for a ceramic powder having a mullite-forming composition with a melting temperature of 1828° C., the heating molten metal mixture 716 can be heated to between about 1280° C. to 1650° C., for instance about 1430° C. (about 2600° F.). After sintering, the final diffusive lining 403A, 403B, e.g., having a two layer structure described above with respect to FIG. 6C, is formed. Afterwards, the heating molten metal mixture 712 is poured off, and the melting furnace 608A (FIG. 6A) or 608B (FIG. 6B) is obtained.

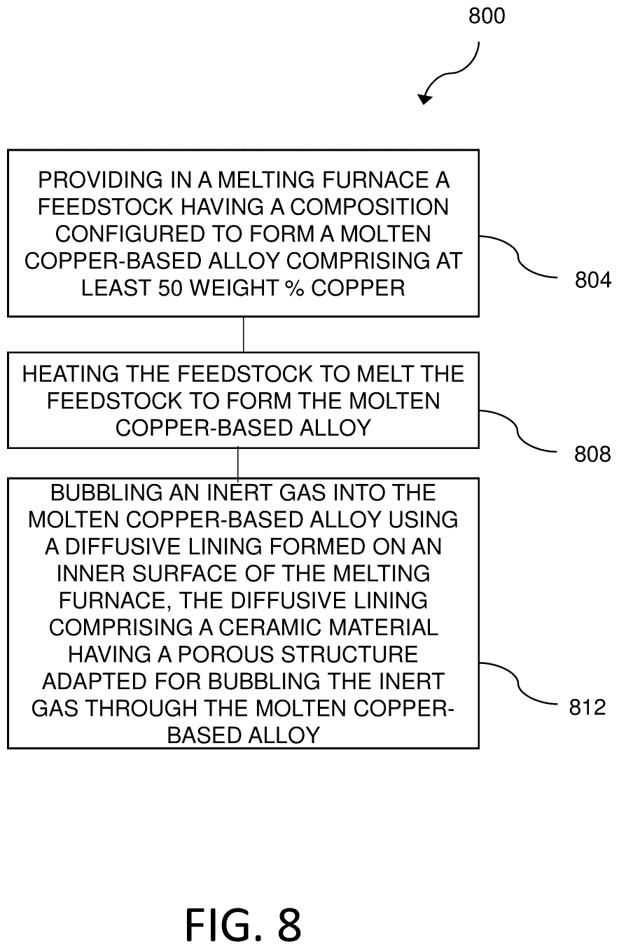

FIG. 8 illustrates method of manufacturing a copper-based alloy having low impurity content using a melting furnace having a diffusive lining, according to embodiments. The illustrated method can include various features of the method 500 of manufacturing a copper-based alloy having low impurity content described above with respect to FIG. 5. Various features that can be commonly present between the method 500 (FIG. 5) and the method 800 (FIG. 8) are omitted herein for brevity. Similar to the method 500 of FIG. 5, the method 800 includes providing 804 in a melting furnace a feedstock. The feedstock can have, without limitation, a composition configured to form a molten copper-based alloy comprising at least 50 weight % copper. The method 800 additionally includes heating 808 the feedstock to melt the feedstock to form the molten alloy, e.g., a copper-based alloy. The method additionally includes bubbling 818 an inert gas into the molten alloy, e.g., the copper-based alloy. Unlike the method 500 (FIG. 5), however, the method 800 includes, using a diffusive lining formed on an inner surface of the melting furnace chamber, bubbling 812 the inert gas through the alloy. The diffusive lining can have any configuration of the diffusive lining 400A, 400B described above with respect to FIGS. 6A-6C. For example. the diffusive lining 400A, 400B comprises an aluminum-silicate ceramic material having a porous structure adapted for bubbling the inert gas through the molten copper-based alloy. According to embodiments, bubbling 812 the inert gas through the molten copper-based alloy can include using a diffusive lining substantially covering a bottom inner surface of the melting furnace and having a porous structure adapted for bubbling the inert gas into the molten copper-based alloy. According to embodiments, bubbling 812 the inert gas through the molten copper-based alloy can include using a diffusive lining formed on at least two different inner surfaces of the melting furnace such that the diffusive lining is adapted for bubbling the inert gas into the molten copper-based alloy from the at least two different inner surfaces.

### Experimental Examples

To fabricate specimens used to obtain mechanical test results, a copper feedstock, e.g., a feedstock of alloy C87850 was melted at 1950° F. in a 4000 lb. furnace and argon gas was bubbled into the melting furnace through the copper-based alloy at a rate of 4 liters/minute for a period of 90 min. A reference ingot was also produced using the same system but without sparging, e.g., bubbling argon through the molten copper-based alloy in the melting furnace. Both the copper ingot produced with argon gas and the reference copper ingot were tested using ASTM E8/E8M-21, the American Society for Testing Materials Standard Test Methods for Tension Testing of Metallic Materials E8/E8M-21. The results of these tests can be seen in TABLE 1.

TABLE 1

| | Ultimate | | | |
|---|---|---|---|---|
| | Tensile | 0.5% Yield | Elongation | |
| Copper-based | Strength | Strength EUL | in | Reduction of |
| alloy | (ksi) | (ksi) | 2″ (%) | Area″ (%) |
| Ref. Criteria | 85.0 | 35.0 | 15 | n/a |
| Sparged | 98.5 | 42.0 | 21 | 21 |
| Unsparged | 67.0 | 36.1 | 11 | 10 |

As shown, for the particular C87850 alloy, the measured mechanical properties are clearly superior. For example, the ultimate tensile strength is improved by 47%. Similar results were repeatably obtained for various copper-based alloys. Similar comparisons were made for four representative copper-based alloys including C87850, C89833, C99500 and C96400. The nominal compositions of the four alloys are shown in TABLE 2.

TABLE 2

| Description | CA# | Cu % | Sn % | Pb % | Zn % | Fe % | Sb % | Ni % | S % | P % | Al % | Si | Mn % | Bi % | Nb % |
|---|---|---|---|---|---|---|---|---|---|---|---|---|---|---|---|
| Silicon Bronze | C87850 | 74.00- | 0.30 | 0.09 | 20.00- | 0.10 | — | 0.20 | — | 0.05- | <0.01 | 2.70- | 0.10 | | |
| | | 78.00 | max | max | 24.00 | max | | max | | 0.20 | | 3.40 | max | | |
| Bismuth Brass | C89833 | 86.00- | 4.00- | 0.09 | 2.00- | 0.20 | 0.25 | 1.00 | 0.30 | 0.05 | 0.005 | 0.005 | — | 1.70- | |
| Alloy | | 91.00 | 6.00 | max | 4.00 | max | max | max | max | max | max | max | | 2.70 | |
| Copper Nickel | C96400 | Balance | — | 0.01 | — | 0.25- | — | 28.0- | 0.02 | 0.02 | — | 0.05 | 1.50 | | 0.50- |
| | | | | max | | 1.50 | | 32.0 | max | max | | max | max | | 1.50 |
| Special Copper | C99500 | Balance | — | 0.25 | 0.50- | 3.00- | — | 3.50- | — | — | 0.50- | 0.50- | 0.50 | | |
| Alloy | | | | max | 2.00 | 5.00 | | 5.50 | | | 2.00 | 2.00 | max | | |

For each alloy system shown in TABLE 2, copper ingot were produced with and without sparging using argon gas, and were tested using ASTM E8/E8M-21, the American Society for Testing Materials Standard Test Methods for Tension Testing of Metallic Materials E8/E8M-21. The results of these tests can be seen in TABLE 3.

TABLE 3

| | | | 0.5% Yield | |
|---|---|---|---|---|
| | | Ultimate | Strength EUL | Elongation |
| Alloy | | Strength (ski) | (ksi) | in 2″ (%) |
| C87850 | Sparged | 75 | 33.4 | 19 |
| | Unsparged | 51.5 | 25 | 15 |
| | Difference | 23.5 | 8.4 | 4 |
| | % Difference from | 45.63% | 33.60% | 26.67% |
| | non-sparged | | | |
| C89833 | Sparged | 41.6 | 18.5 | 36 |
| | Unsparged | 14.4 | 13.5 | 2.5 |
| | Difference | 27.2 | 5 | 33.5 |
| | % Difference from | 188.89% | 37.04% | 1340.00% |
| | non-sparged | | | |
| C99500 | Sparged | 73.5 | 45.5 | 18 |
| | Unsparged | 69.5 | 45.4 | 7.5 |
| | Difference | 4 | 0.1 | 10.5 |
| | % Difference from | 5.76% | 0.22% | 140.00% |
| | non-sparged | | | |
| C96400 | Sparged | 67.5 | 28.7 | 33 |
| | Unsparged | 37 | 26 | 18 |
| | Difference | 30.5 | 2.7 | 15 |
| | % Difference from | 82.43% | 10.38% | 83.33% |
| | non-sparged | | | |

The measured mechanical properties of sparged ingots are clearly superior. For example, the ultimate tensile strength is improved by 46%, 189%, 6% and 82% for alloys having C87850, C89833, C99500 and C96400 alloy compositions.

As disclosed herein, a copper-based alloy composition according to various embodiments including a feedstock composition can include, in weight percent: Cu in the amount greater than 50%, 60%, 70%, 80%, 90% 95%. or a value in a range defined by any of these values; Sn in the amount greater than 0.1%, 0.2%, 0.5%, 1%, 2%, 5%, 10%, or a value in range defined by any of these values; Pb in the amount greater than 0.01%, 0.02%, 0.05%, 0.1%, 0.2%, 0.5%, or a value in range defined by any of these values; Zn in the amount greater than 0.1%, 0.2%, 0.5%, 1%, 2%, 5%, 10%, 20%, 30% or a value in range defined by any of these values; Fe in the amount greater than 0.1%, 0.2%, 0.5%, 1%, 2%, 5%, 10%, or a value in range defined by any of these values; Sb in the amount greater than 0.01%, 0.02%, 0.05%, 0.1%, 0.2%, 0.5%, or a value in range defined by any of these values; Ni in the amount greater than 0.1%, 0.2%, 0.5%, 1%, 2%, 5%, 10%, 20%, 30%, 40% or a value in range defined by any of these values; S in the amount greater than 0.01%, 0.02%, 0.05%, 0.1%, 0.2%, 0.5%, or a value in range defined by any of these values; P in the amount greater than 0.01%, 0.02%, 0.05%, 0.1% or a value in range defined by any of these values; Al in the amount greater than 0.01%, 0.02%, 0.05%, 0.1%, 0.2%, 0.5%, 1%, 2%, 5%, or a value in range defined by any of these values; Si in the amount greater than 0.01%, 0.02%, 0.05%, 0.1%, 0.2%, 0.5%, 1%, 2%, 5%, or a value in range defined by any of these values; Mn in the amount greater than 0.01%, 0.02%, 0.05%, 0.1%, 0.2%, 0.5%, 1%, 2% or a value in a range defined by any of these values; Bi in the amount greater than 0.01%, 0.02%, 0.05%, 0.1%, 0.2%, 0.5%, 1%, 2%, 5% or a value in a range defined by any of these values; Nb in the amount greater than 0.01%, 0.02%, 0.05%, 0.1%, 0.2%, 0.5%, 1%, 2% or a value in a range defined by any of these values. Further, the copper-based alloy composition can include any one or more elements disclosed in TABLE 2 in a range defined by any of the corresponding amounts, including those corresponding to C87850, C89833, C99500 and C96400 alloy compositions.

### Systems and Methods for Manufacturing High Purity Copper-Based Alloys Based on Rotary Type Furnace

In the above, various features of apparatuses and methods for forming high purity copper alloys are described. While specific references may have been made to such apparatuses and methods in the context of induction-type melting furnaces, various embodiments are not so limited. Unless contrariwise to the present disclosure, various embodiments disclosed above are applicable to other types of furnaces as well, including rotary-type furnaces. A rotary furnace includes a cylindrical or barrel-shaped chamber that is configured to be rotated around an axis when performing heat treatment of its content. The chamber may be tilted slightly to allow the content to passed from one end of the chamber to the other. Sample transfer, mixing, or stirring can occur as the rotary furnace rotates.

As disclosed herein, features of rotary type melting furnaces can share features that are similar to those of the induction-type melting furnaces. For example, both types can include a barrel or cylindrical-shaped furnace body. Such similarities may not be repeated herein for brevity. While there are similarities, there are some notable differences between an induction melting furnace and a rotary melting furnace. For example, as described above, an induction-type furnace can have a cylindrical-shaped furnace body in an upright configuration with the cylindrical axis extending generally lengthwise in a vertical direction. In these configurations, a diffuser according to embodiments may be located at the bottom of the furnace, which can correspond to a base of a cylindrical furnace body. In addition, induction melting furnaces are stationary during the melting process. As such, the inert gas that is bubbled through a diffuser travels from the bottom of the stationary furnace, through the feedstock and the molten metal, towards the top of the furnace.

On the contrary, a rotary-type furnace can have a cylindrical-shaped furnace body with the cylindrical axis extending generally lengthwise in a horizontal direction. In this configuration, diffusers can be located at the bottom surface of the furnace at certain angles of rotation corresponding to a portion of a curved cylindrical sidewall. In addition, in operation, the rotary-type furnace can be either stationary or rotating. A rotary-type melting furnace can rotate at a predetermined rate and induce a motion of the molten metal and the inert gas bubbles within. Advantageously, such movement may increase the dwell time of the inert gas bubbles in molten metal. The increased dwell time of the inert gas in turn increases the probability of the exposure of the inert gas to impurities in the molten metal to which the inert gas can bind, including oxygen or oxides, thereby increasing the effectiveness of the inert gas in removing unwanted impurities. In the following, systems and methods for manufacturing high purity copper-based alloys using a rotary melting furnace are disclosed.

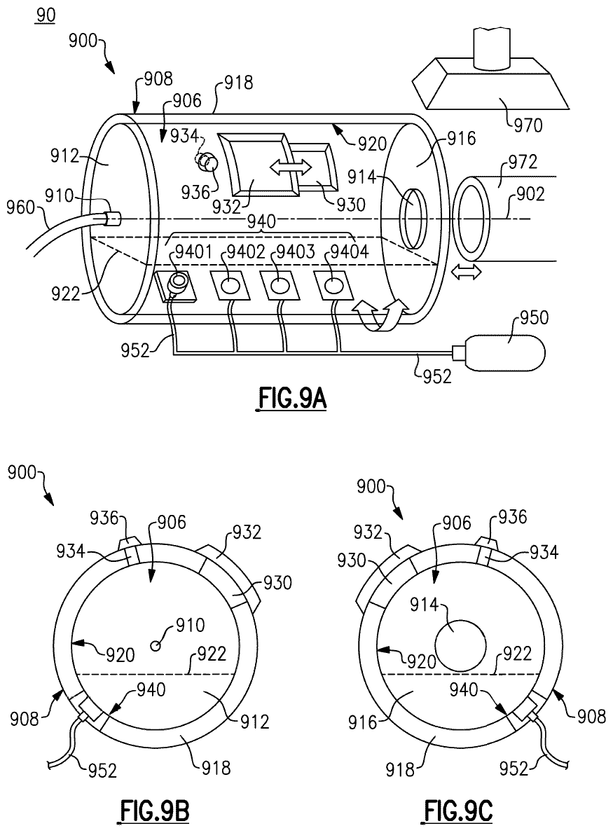

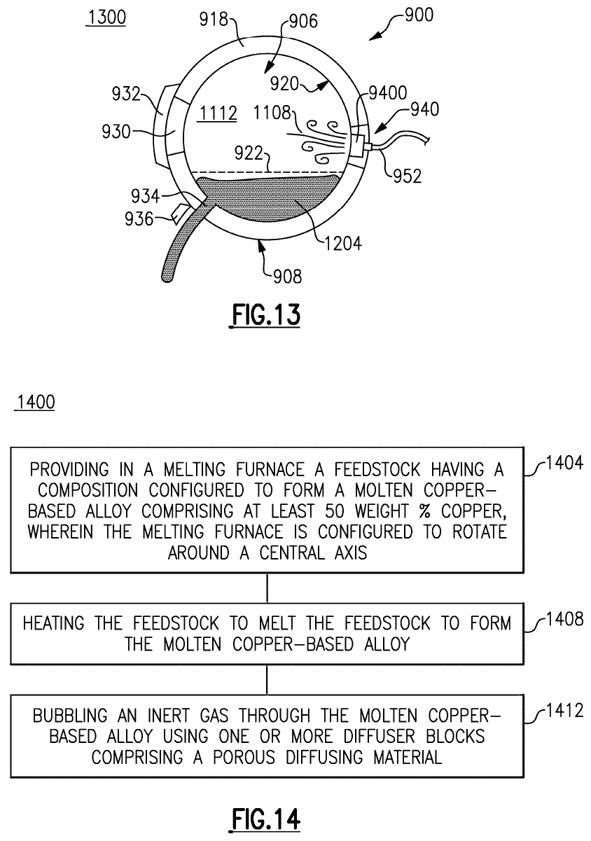

FIGS. 9A-13 illustrate aspects of a sparging rotary furnace system configured for manufacturing a copper-based alloy with reduced impurity content, including oxygen or oxygen-related impurities content, according to various embodiments disclosed herein. FIG. 9A shows a schematic perspective illustration of a sparging rotary furnace system for manufacturing a copper-based alloy, including a rotary furnace. FIGS. 9B and 9C show schematic side views of the rotary furnace from opposing ends, according to some embodiments. FIG. 10 illustrates a cross-sectional view of a diffuser block configured to bubble an inert gas through the molten copper-based alloy, according to some embodiments. FIGS. 11-13 shows different ways the rotary furnace may be configured during the manufacturing process of the copper-based alloy, including a loading configuration, a melting configuration, and a pouring configuration, according to some embodiments. FIG. 14 illustrates a method of manufacturing a copper-based alloy using one of the sparging rotary furnace systems illustrated in FIGS. 9A-13, according to some embodiments.

The sparging rotary furnace system 90 illustrated in FIG. 9A comprises a rotary furnace 900 configured for sparing according to embodiments. The rotary furnace 900 is configured to form a molten copper-based alloy comprising at least 50 weight % copper from solid feedstock pieces in one or more batches. The sparging rotary furnace includes a diffuser assembly 940 for flowing inert gas into the rotary furnace 900. The inert gas may be introduced through solid feedstock or bubbled through a molten copper-based alloy formed from the feedstock. The rotary furnace 900 may be configured to rotate around a central axis 902 in both clockwise and counterclockwise directions. As used herein, a central axis refers to an axis passing through a geometric center of a shape or an axis about which a rotational symmetry exists for a shape. For the rotary furnace 900 having a cylindrical shape, the central axis runs along a lengthwise direction of the cylinder. By rotating into various angular positions around the central axis 902, the rotary furnace 900 can be positioned in various configurations, including a loading configuration, a melting configuration, and a pouring configuration. An inert gas may be introduced into the furnace chamber in one or more of the loading, melting, and pouring configurations. The rotary furnace 900 may be heated prior to introducing the feedstock, and the molten copper-based alloy formed from the feedstock may be cooled before it is poured out of the furnace. An inert gas may be provided to the furnace chamber before or during the loading of the feedstock, before or during heating and/or melting of the feedstock, and/or or before or during pouring of the molten copper-based alloy. An inert gas may be introduced into rotary furnace 900 under various configurations. For example, the inert gas may be introduced into the atmosphere enclosed by the furnace above the feedstock or the molten copper-based alloy, be flowed through gaps between the solid feedstock pieces, or be bubbled through the molten copper-based alloy. Although not explicitly shown in FIG. 9A, the sparging rotary furnace system 90 may additionally include a transfer ladle configured to receive the molten copper-based alloy from the melting furnace and to transfer the molten copper-based alloy into one or more molds or a shot pit configured to solidify the molten copper-based alloy, in a manner described elsewhere herein.

Using the sparging rotary furnace system 90, the method 500 illustrated in FIG. 5 and the method 1400 illustrated in FIG. 14 can be performed. Various features that can be commonly present between the method 500 and the method 1400 are omitted herein for brevity. The method 1400 includes providing 1404 in a melting furnace a feedstock having a composition configured to form a molten copper-based alloy comprising at least 50 weight % copper. The melting furnace is configured to rotate around a central axis. The method 1400 additionally includes heating 1408 the feedstock to melt the feedstock to form the molten copper-based alloy. The method 1400 additionally includes bubbling 1412 an inert gas through the molten copper-based alloy using one or more diffuser blocks comprising a porous diffusing material. While not illustrated in FIG. 14, as described elsewhere in the application, the inert gas may begin flowing into the furnace before the feedstock is introduced and/or prior to and during the melting of the feedstock.

The method 1400 can include additional steps that can be performed on a sparging rotary furnace system 90 illustrated in FIG. 9A. For example, the method 1400 can include, configuring the melting furnace in a loading configuration before providing 1404 the feedstock, configuring the melting furnace in a melting configuration before heating 1408 the stock, and configuring the melting furnace in a pouring configuration before transferring the molten copper-based alloy. According to embodiments, heat may be applied to the melting furnace before the feedstock is provided 1404 to the furnace. According to embodiments, bubbling the inert gas through the molten copper-based alloy can include using a diffusive block arranged at a bottom the melting furnace, corresponding to a curved surface in the barrel-shaped furnace, and having a porous structure adapted for bubbling the inert gas into the molten copper-based alloy. According to embodiments, the diffusive block can bubble the inert gas into the molten copper-based alloy from at least two different positions as the furnace rotates. According to embodiments, transferring the molten copper-based alloy into a transfer ladle can include flowing an inert gas using a diffusive block on a wall of the melting furnace and having a porous structure adapted for flowing the inert gas directly into an atmosphere above the molten copper-based alloy.

Referring back to FIG. 9A the sparging rotary furnace system 90 for manufacturing a copper-based alloy, e.g., ingot, copper-based shot, or copper-based component, having low content of oxygen or oxygen-related impurities, comprises a rotary furnace 900 configured to rotate about a central axis 902 in both directions. The rotary furnace 900 of the rotary furnace system may comprise a burner inlet 910 on one end of the furnace and an exhaust portal 914 on another end opposite to the burner inlet 910. FIG. 9B shows a schematic illustration of the rotary furnace 900 viewed from the burner end. FIG. 9C further shows a schematic illustration of the rotary furnace 900 viewed from the exhaust end. Although not shown in FIGS. 9A-9C, the sparging rotary furnace system 90 may further comprise various components that are broadly configured similarly to the corresponding components of induction-type sparging furnace systems described elsewhere herein, including components associated with transferring the molten copper-based alloy from the rotary furnace. A detailed description of some of those components may be omitted herein for brevity.

As shown in FIG. 9A, the burner inlet 910 of the sparging rotary furnace system 90 may be connected to a burner system through a burner line 960. The burner system is configured to provide the furnace with a fuel stream to be ignited into a flame, for heating the feedstock to form the molten copper-based alloy. The ignited flame may combust in a furnace chamber 906 of the rotary furnace 900 and provide heat to the furnace wall 908, the feedstock, and the molten copper-based alloy. The fuel may be a gas or a liquid and may be mixed with air or oxygen. The fuel may be a suitable gaseous hydrocarbon, for example, a natural gas. The burner system may compress the fuel and inject it through the burner inlet as a stream at a high speed or pressure. The fuel may be ignited as it enters the furnace chamber 906 using, e.g., a spark generated outside or inside the furnace chamber, and may combust completely or incompletely inside the furnace chamber 906, consuming oxygen in the chamber. The fuel may be provided constantly, intermittently, or with adjustable speeds during the manufacturing of the molten copper-based alloy, depending on the heating needs of the manufacturing process. An operator may adjust the amount, speed, or the composition of the fuel to adjust the thermal energy imparted to the furnace in response to the condition of the alloy within the furnace during various stages of the manufacturing process discussed herein.

Still referring to FIG. 9A, the rotary furnace 900 further comprises an exhaust portal 914 configured to vent an exhaust from the furnace. The exhaust may comprise a product of the combustion of the fuel, a product of supplying an inert gas to the furnace, or a product of melting or heating the copper-based alloy. The exhaust portal 914 may be provided on an opposite end of the furnace from the burner inlet 910. In some other embodiments, it is also possible to arrange exhaust portal at other locations, e.g., at the same end as the burner inlet 910, or at a side of the burner inlet. To guide the exhaust away from the exhaust portal 914, an exhaust duct 972 may be removably disposed adjacent to the exhaust portal 914. The exhaust duct 972 may further separate the atmosphere inside the furnace chamber 906 from an outside atmosphere, keeping the enclosed atmosphere inside and sufficiently inert while the inert gas is being flowed into the chamber. The exhaust duct 972 may also reduce the amount of heat escaping from the exhaust portal, saving an energy cost of the manufacturing process. Although not explicitly shown in FIG. 9A, the exhaust portal 914 may further comprise an exhaust door to further isolate and/or insulate the inside of the furnace chamber from the outside. As the exhaust can often be hazardous, the exhaust duct 972 helps guide the exhaust toward a safe location for further treatment, for example, into a baghouse. The inside of the exhaust duct may be lined with a refractory material to protect it from the high temperature exhaust, for example, with the same material as the furnace lining 920 of the rotary furnace 900. During the operation of the furnace, the exhaust duct 972 may be disposed adjacent to, e.g., in contact with and against the exhaust portal 914, thereby substantially sealing the furnace chamber 906 from the surrounding atmosphere. When the rotary furnace 900 is not actively being used, the exhaust duct may be moved away from the exhaust portal, leaving a gap between the exhaust duct and the exhaust portal, where the gap may be used for inspection or maintenance purposes. A hygiene hood 970 may also be provided above the exhaust portal 914 to help collect any residue exhaust that is not guided toward the exhaust duct.

Still referring to FIG. 9A, the exhaust may be at a high temperature, travels at a high speed, and may comprise a gas, a liquid, or a solid waste product of the manufacturing process. Such exhaust may act as a fire hazard if collected directly from the exhaust duct 972. Therefore, in some embodiments, a drop-bottom cavity may be provided after the exhaust portal 914, configured to reduce the speed or the temperature of the exhaust before it is collected. The drop-bottom cavity can be disposed, for example, between the exhaust duct 972 and the baghouse. The drop-bottom cavity may be in the shape of a cubic cavity with a size larger than that of the exhaust duct 972, for example, with a size larger than 0.5 m, 1 m, 1.5 m, 2 m, 3 m, 4 m, 5 m, 7 m, 10 m, or a value in a range defined by any of these values. When the exhaust enters the drop-bottom cavity from the exhaust duct, the enlarged space available inside the cavity may help reduce the speed of the exhaust and encourage any hazardous solid waste to separate and fall more readily from the exhaust. After the drop-bottom cavity, the exhaust may be safer to collect and treat.

Still referring to FIGS. 9A-9C, the rotary furnace 900 can be configured to be heated by the ignited flame to have a suitable internal temperature to melt various feedstock materials to form various copper-based alloys. In some embodiments, the internal temperature of the melting furnace 108 may be between 700° F. and 3000° F. In some embodiments, the temperature of the melting furnace 108 may be 900° F., 1000° F., 1200° F., 1400° F., 1600° F., 1800° F., 2000° F., 2200° F., 2400° F., 2500° F., or 3000° F. or a value in a range defined by any of these values. The internal temperature of the furnace may not be uniform and may be determined by one or more thermometers that take measurements at an interior of the furnace. The internal temperature of the furnace may also be inferred by one or more thermometers that take measurements at an exterior of the furnace. The internal temperature of the furnace and the temperature of the molten alloy may also be determined from a color or a spectrum of the thermal radiation of the furnace and the alloy, respectively.

Still referring to FIGS. 9A-9C, the rotary furnace 900 may be of an elongated shape, with the axis of elongation along the central axis 902. A total length measured on the inside of the furnace along the direction of elongation may be 50 cm, 100 cm, 150 cm, 200 cm, 250 cm, 300 cm, 350 cm, 400 cm, 450 cm, 500 cm, 600 cm, 700 cm, 800 cm, 1000 cm, or a value in a range defined by any of these values. A cross-section of the rotary furnace 900 taken perpendicular to the axis of elongation may be substantially circular, and may have an inner diameter greater than 50 cm, 100 cm, 150 cm, 200 cm, 250 cm, 300 cm, 350 cm, 400 cm, 450 cm, 500 cm, or a value in a range defined by any of these values. The rotary furnace 900 may have a capacity at full load to melt alloys in a weight greater than 1000 lbs., 2000 lbs., 5000 lbs., 10,000 lbs., 20,000 lbs. 50,000 lbs., 100,000 lbs., or a value in a range defined by any of these values.

In some embodiments, the rotary furnace 900 is configured to rotate or rock continuously through an angle range around the central axis 902 greater than 5°, 10°, 15°, 20°, 30°, 45°, 60°, 75°, 90°, 120°, 150°, 180°, 240°, 300°, 360°, or a value in a range defined by any of these values. The rate at which the furnace rotates may be constant or non-uniform, and may be greater than 1°/min, 5°/min, 10°/min, 15°/min, 30°/min, 45°/min, 60°/min, 90°/min, 120°/min, 180°/min, 270°/min, 360°/min, 480°/min, 720°/min, or a value in a range defined by any of these values. The rotation may be realized by providing one or more rings of gears along an external circumference of the rotary furnace to receive a driving motion from a motor, and the motor may be controlled by an operator such that the speed of rotation and the angular position of the furnace may be adjusted.

Still referring to FIGS. 9A-9C, in some embodiments, the furnace may be provided in a cylindrical shape, with the circumferences at the center of the furnace similar to the ends of the furnace. In some embodiments, the furnace may also be provided in a barrel shape, with the circumferences at the center of the furnace larger than the circumference of the ends of the furnace. Additionally, the rotary furnace may comprise two end walls corresponding to bases of the cylindrical or barrel shape, including a burner end wall 912 and an exhaust end wall 916 connected by a curved side wall 918, where the burner inlet 910 is provided on the burner end wall 912, and the exhaust portal 914 may be provided on the exhaust end wall 916 opposite to the burner end wall. The central axis 902 of rotation may intersect the center point of both the burner end wall and the exhaust end wall. The side wall 918 of the furnace, connecting the exhaust end wall 916 and the burner end wall 912 may be centered around and elongated along the central axis 902. The side wall 918 may be substantially cylindrically symmetric about the central axis. A substantial portion of the side wall may be cylindrical, such that a significant portion of the side wall 918 is straight and approximately parallel to the central axis. The burner end wall 912, the exhaust end wall 916, and the side wall 918 enclose the furnace chamber 906.

The interior of the furnace walls 908 of the rotary furnace 900 is lined with a suitable refractory material similar to those described above with respect to induction-type furnaces to facilitate reaching and maintaining these temperatures. The interior of the furnace walls 908 may be made from one or more refractory materials, for example, a refractory brick or a fire brick. The interior of the furnace walls 908 may be covered with a furnace lining 920 comprising silicon carbide, alumina, silica, mullite, zirconia, or other suitable refractory ceramic or clay. The thickness of the refractory lining may be 1 cm, 5 cm, 10 cm, 15 cm, 20 cm, 25 cm, 30 cm, 35 cm, 40 cm, 50 cm, 60 cm, 80 cm, 100 cm, 120 cm, or a value in a range defined by any of these values.

Still referring to FIGS. 9A-9C, the rotary furnace 900 may further comprise a loading portal 930. A plurality of feedstock pieces having a combined composition configured to form a molten copper-based alloy comprising at least 50 weight % copper may be provided through the loading portal 930. The loading portal may be provided on the curved side wall 918 of the rotary furnace 900. In some embodiments, the loading portal may be provided with a loading portal door 932 comprising a refractory material. The loading portal door may be closed during the manufacturing of the molten copper-based alloy to separate the atmosphere inside the furnace chamber from the atmosphere outside, or to provide additional thermal insulation by preventing heat to escape from the loading portal. A height and/or width of the loading portal 930 may be 10 cm, 15 cm, 20 cm, 25 cm, 30 cm, 45 cm, 50 cm, 60 cm, 75 cm, 100 cm, 125 cm, 150 cm, 175 cm, 200 cm, 250 cm, 300 cm, or a value in a range defined by any of these values.

Still referring to FIGS. 9A-9C, the rotary furnace 900 may additionally comprise a pouring portal 934 configured to transfer the molten copper-based alloy out of the furnace and, for example, into a transfer ladle, a mold, or a shot pit. In some embodiment as shown in FIGS. 9A-9C, the pouring portal 934 may be provided on a side wall of the rotary furnace, and may be provided in the shape a circular or a elliptical hole through the curved side wall 918 of the rotary furnace 900. The pouring portal 934 may be provided near the middle or closer towards an end along an axis of elongation of the furnace, depending on the setup of the transfer system receiving the outgoing molten alloy. The pouring portal 934 may be disposed apart from the loading portal in an azimuthal direction around the central axis 902 by at least 5°, 10°, 15°, 20°, 30°, 45°, 60°, 75°, 90°, 120°, 150°, 180°, or a value in a range defined by any of these values. A width of the pouring portal 934 may be greater than 1 cm, 1.5 cm, 2 cm, 2.5 cm, 3 cm, 4 cm, 5 cm, 7.5 cm, 10 cm, 12.5 cm, 15 cm, 20 cm, 30 cm, or a value in a range defined by any of these values. The pouring portal 934 may further comprise a pouring portal stopper 936 configured to stop the molten alloy from flowing out of the pouring portal 934 when the pouring portal is submerged under the alloy. The pouring portal may also comprise a spout configured to control the direction and the speed of the flow of the molten copper-based alloy during transfer.

In some embodiments, the central axis 902 around which the rotary furnace 900 rotates may extend substantially parallel to a ground level, such that the axis of rotation is parallel to a top surface level of the molten alloy. In other embodiments, the central axis may be provided with a tilt with respect to the ground level, such that one end of the furnace holds more molten alloy than the other. An angle the tilt of the central axis may be greater than 1°, 2°, 3°, 5°, 10°, 15°, 20°, 30°, 45°, or a value in a range defined by any of these values. In some embodiments, the rotary furnace 900 may be configured to rotate about a second axis different from the central axis 902. A rotation around the second axis may change the tilt of the furnace and the central axis with respect to the ground level, such that the content of the furnace may be moved from one side of the furnace to the other. For example, the second axis around which the furnace rotates may be parallel to the ground level and orthogonal to the central axis.

In some other embodiments, while not shown in FIGS. 9A-9C, the burner inlet 910 and the exhaust portal 914 may be provided on the same side of the rotary furnace 900, for instance, on the same end wall of the furnace. In some other embodiments, one or both of the burner inlet 910 and the exhaust portal 914 may be provided on a side wall 918 of the furnace. In some other embodiments, one or both of the burner inlet 910 and the exhaust portal 914 may be provided on a door of the rotary furnace 900, wherein the door may be provided on an end wall or a side wall of the furnace. In some embodiments, as shown in FIGS. 9A-9C, the central axis 902 may extend through one or both of the burner inlet 910 and the exhaust portal 914. In some other embodiments, while not shown by FIGS. 9A-9C, one or both of the burner inlet 910 and the exhaust portal 914 may be provided off-axis from the central axis 902.

In some embodiments, as shown in FIGS. 9A-9C, the loading portal 930, the pouring portal 934, and the exhaust portal 914 may be provided as separate portals, and may be located on different walls of the rotary furnace 900. In some other embodiments, while not shown in FIGS. 9A-9C, two or all of the loading portal 930, the pouring portal 934, and the exhaust portal 914 may be the same portal. Providing a common portal or portals for loading, pouring, and exhaust may be beneficial to reducing heat loss, better isolating the inside atmosphere from the outside atmosphere, or simplifying the manufacturing of the furnace and therefore saving the cost. In some embodiments, a burner injector may also be provided through any one of the portals discussed above.

Still referring to FIGS. 9A-9C, the rotary furnace 900 may further comprise a diffuser assembly 940 configured to flow an inert gas into the rotary furnace 900, e.g. bubble the inert gas through a molten copper-based alloy. A gas supply 950 may be connected to the diffuser assembly 940 via a gas line 952. As the rotary furnace 900 rotates and moves the diffuser assembly 940 with it, the gas line 952 may be made from a flexible material or structure to accommodate this motion. The gas supply 950 may be configured to provide the diffuser assembly 940 with a pressurized inert gas, which may be essentially free of oxygen, hydrogen, moisture and/or any substance that may react with or negatively affect the purity of the molten copper-based alloy. In some embodiments, the inert gas may comprise a noble gas, for example, argon (Ar), or a mixture of noble gases. In other embodiments, the inert gas may comprise nitrogen gas (N₂). After passing through the gas line 952, the inert gas is diffused through the diffuser assembly 940 and is flowed into the furnace chamber 906, through the feedstock, or bubbled into the molten copper-based alloy. One or more valves may be provided with the gas supply to control the flow rate of the inert gas through the gas line 952, the diffuser assembly 940, and into the furnace chamber 906.

The furnace chamber 906 may be partially enclosed, substantially enclosed, or completely enclosed before, during, or after the melting and heating of the molten copper-based alloy. For reasons discussed elsewhere in the application, at least partly enclosing the furnace can be advantageous. An enclosed system or a component described herein may refer to an arrangement in which the system or component is substantially physically sealed or otherwise isolated from the outside atmosphere. For example, while not physically sealed, the atmosphere inside the furnace chamber 906 may be maintained substantially inert by flowing an inert gas into the enclosed system or a component and/or maintaining a positive pressure with inert gas. For example, a substantially inert atmosphere inside the furnace chamber 906 may be maintained by continuously or intermittently supplying a flow of inert gas, thereby sufficiently preventing air from an outside atmosphere from backflowing and accumulating inside the chamber, and replacing the enclosed atmosphere with the inert gas supplied. In some embodiments, the substantially inert atmosphere of the furnace chamber may be similar in composition to the inert gas supplied. In some embodiments, the substantially inert atmosphere of the furnace chamber may comprise argon (Ar). In some embodiments, the substantially inert atmosphere of the furnace chamber comprises substantially higher levels of nitrogen gas (N₂) compared to an outside atmosphere. In some embodiments, the substantially inert atmosphere of the furnace chamber comprises substantially lower levels of oxygen, hydrogen, moisture, or other reactive or undesirable substances that can negatively affect the purity of the molten copper-based alloy, compared to an outside atmosphere.

Still referring to FIGS. 9A-9C, the diffuser assembly 940 may comprise one or more diffuser blocks comprising a porous diffusing material adapted for bubbling an inert gas through the molten copper-based alloy. The porous diffusing material can be similar to those described above with respect to rotary-type furnaces. The diffuser block assembly 940 may comprise one, two, three, four, five, six, or more than six diffuser blocks, and maybe provided on a side wall 918 of the furnace opposite to the loading portal 930. In the illustrated embodiment, the diffuser assembly 940 comprises four diffuser blocks 9401, 9402, 9403, and 9404. One or more valves may be provided in the path of the inert gas to collectively or independently control the flow rate to different ones of the diffuser blocks 9401-9404. The one or more diffuser blocks of the diffuser assembly 940 may be arranged in a line or in an array. For example, the diffuser blocks 9401-9404 are arranged in a side wall 918 of the furnace along a line parallel to the central axis 902. The spacing between neighboring diffuser blocks can be optimized such that the inert gas flux is dispersed to cover a substantial area of the molten metal. For example, the spacing can be greater than 1 cm, 2 cm, 5 cm, 10 cm, 15 cm, 20 cm, 30 cm, 50 cm, 75 cm, 1 m, 1.25 m, 1.5 m, 2 m, or a value in a range defined by any of these values, in a direction along the central axis, in a azimuthal direction, or in a vertical direction. The location, shape, size, and porosity and granular size of the diffusing material of diffuser blocks can be adjusted to suit the particular shape of furnaces and the quantity or the composition of the molten alloy, and are not limited to the embodiments disclosed herein. In some other embodiments, some of the one or more diffuser blocks 9401-9404 can also be arranged substantially apart from the others along an azimuthal direction around the central axis or along a vertical direction of the furnace, such that, at certain angular positions of the rotary furnace, a portion of the diffuser assembly may remain underneath the surface the copper-based alloy while another portion of the diffuser assembly is in contact with the atmosphere above the alloy.

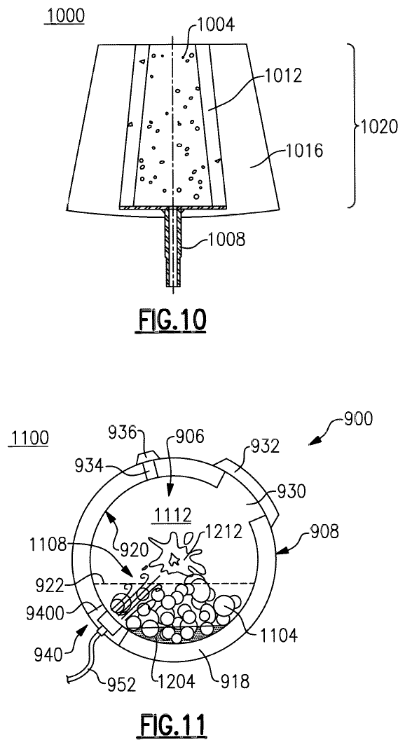

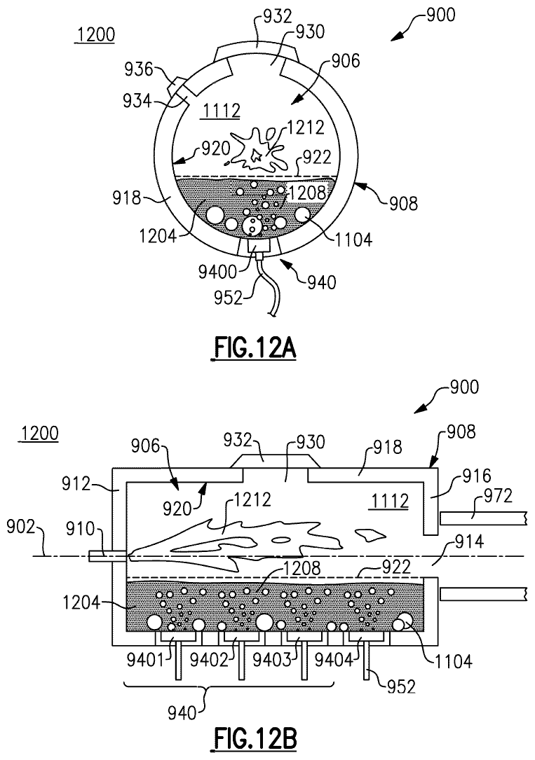

As discussed herein and elsewhere in the application, to optimize impurity removal from the molten alloy, the inventors have found it beneficial to increase the contact area between inert gas bubbles and the molten alloy. Therefore, it can be advantageous to increase both the distance traveled by the inert gas bubble in the molten alloy and the dwelling time of the inert gas bubble in the molten alloy. For the illustrated embodiment, it may be advantageous to bubble the inert gas from the bottom of the molten alloy. It can therefore be beneficial to arrange at least some of the diffuser blocks to dwell at the bottom of the molten alloy for at least part of the time during the manufacturing process. For example, as illustrated in FIG. 12A, it can be beneficial to have at least one of the diffuser blocks 9401-9404 arranged at the lowest point of the furnace chamber 906 in a melting configuration of the rotary furnace 900. The rest of the one or more diffuser blocks may be arranged at the same azimuthal angle around the central axis and spaced apart in a direction along the central axis. The diffuser blocks may be arranged such that, at a certain rotation angle of the rotary furnace 900, the one or more diffuser blocks are simultaneously rotated into their respective lowered positions and increase the upward distance traveled by the bubbles in the alloy diffused through each of the diffuser blocks.

The inventors have further found, in order to increase the effectiveness of the inert gas bubbles at removing impurities, it may be beneficial to increase the cross-sectional flow area of the inert gas bubbles with respect to a cross-sectional area of the molten copper-based alloy in the same horizontal plane. For instance, the diffuser blocks may be arranged such that a cross-sectional flow area of the inert gas bubbles diffused therethrough may be greater than 30%, 50%, 60%, 70%, 80%, 90%, or a value in a range defined by any of these values, of the cross-sectional area of the molten copper-based alloy in the same cross-sectional plane. In order to increase the cross-sectional area for the inert gas bubbles, it may be beneficial to spread the diffuser blocks to substantially cover a length of the rotary furnace. For example, As shown in FIG. 9A, the four diffuser blocks 9401-9404 are spread out to cover a length of the furnace 900 along the direction of the central axis 902. It may also be beneficial to spread out diffuser blocks to over a significant area of the furnace wall, for example, over an area at the bottom of the rotary furnace 900 extending both in a longitudinal direction and an azimuthal direction. The spread in the azimuthal direction may be achieved by arranging the diffuser blocks in a 2 dimensional array or by offsetting the location of some of the diffuser blocks in the second direction away from a single-file profile in the first direction. A similar effect may also be achieved by gently rocking the rotary furnace 900 back and forth in the azimuthal direction around the central axis 902 during the heating of the molten copper-based alloy, such that the inert gas bubbles may pass through different vertical cross-sections of the molten alloy as the azimuthal locations of the diffuser blocks change. The inventors have further discovered that, as the motion of the furnace wall can be transmitted from the inner wall of the furnace to the molten alloy through a viscous drag of the liquid alloy, such gentle rocking may result in a gentle, nonturbulent stirring or a mixing of the alloy. This internal motion of the alloy drags the inert gas bubbles inside it along, moving the bubbles in horizontal or azimuthal directions as the gentle rocking of the furnace takes place, which may in turn cause an average trajectory of the inert bubbles to deviate from a straight upward path. For example, the rocking motion may cause the bubbles to rise and diffuse in curved or zig-zag trajectories. As such, the rocking motion may increase the distance traveled by the inert gas bubbles in the molten alloy compared to bubbles diffused in a stationary furnace, leading to increased dwelling time of the inert gas bubble in the molten alloy. The inventors have found that the increased distance and the dwelling time of the inert gas bubbles can promote the binding between the inert gas and impurities in the molten metal, including oxygen or oxides, and thereby increasing the effectiveness of the inert gas in entraining and removing undesirable impurities.

The rocking may take place for a short or substantial period of time during the heating of the molten copper-based alloy. The rate at which the gentle rocking of the rotary furnace 900 takes place may be greater than 1°/min, 5°/min, 10°/min, 15°/min, 30°/min, 45°/min, 60°/min, 90°/min, 120°/min, 180°/min, 270°/min, 360°/min, 480°/min, 720°/min, or a value in a range defined by any of these values. The range of the rocking motion can be greater than 1°, 2°, 5°, 10°, 20°, 30°, 45°, 60°, 75°, 90°, 120°, 150°, 180°, or a value in a range defined by any of these values.

FIG. 10 is a schematic cross-sectional view of an exemplary diffuser block 1000, according to some embodiments. The diffuser block 1000 corresponds to any one of the diffuser blocks 9401-9404 described above with respect to FIG. 9A. According to some embodiments, the diffuser blocks of the sparging rotary furnace system 90 may also share various components that are broadly configured similarly to the corresponding components of the diffuser 106 described herein, and a detailed description of some of those components may be omitted herein for brevity.

As illustrated in FIG. 10, the diffuser block 1000 comprises a gas inlet 1008 through which the inert gas is received, a diffusing material 1004 through which the inert gas is bubbled into the molten copper-based alloy, a container 1012 connected to the gas inlet 1008 to hold the diffusing material 1004 and to prevent the inert gas from leaking out of the container 1012, and a diffuser lining 1016 surrounding the container and the diffusing material. The diffuser lining 1016 may have a thermal expansion coefficient matching that of the furnace lining to reduce the thermal stress when the diffuser block 1000 is integrated into the furnace. The diffuser lining 1016 may have a composition similar to that of the furnace lining 920 (FIG. 9A). The gas inlet 1008 may be connected to a gas supply 950 through a gas line 952 (FIG. 9A). The container may comprise a material impermeable to the inert gas, such as steel, e.g., stainless steel. The diffusing material may be disposed within the volume defined by the container 1012 as shown in FIG. 10, or may be provided to form a protrusion or recess from edge of the container in other embodiments. The diffuser block 1000 may be installed in the rotary furnace 900 as shown in FIGS. 9A-9C, with an upper surface of the diffuser block 1000 in FIG. 10 exposed to the furnace chamber 906 and configured to contact a molten copper-based alloy. A bracket may be provided on the outside of the furnace to further secure the diffuser block to the furnace.

As illustrated in FIG. 10, the diffusing material 1004 comprises a porous refractory ceramic material, which may be formed using compacted ceramic powder such as alumina, silica, or mullite, and can be at least partially sintered to improve its mechanical integrity and reduce permeability to the molten alloy. The diffusing material may comprise alumina in an amount greater than 60% by weight, greater than 70-99% by weight, greater than 80% by weight, 85-95% by weight, or a % by weight in a range defined by any of these values, for instance, 90% by weight. The diffusing material may further comprise silica in an amount of less than 50% by weight, less than 35% by weight, 10-25% by weight, 15-21% by weight, or a % by weight in a range defined by any of these values, for instance, 18% by weight. The diffusing material may further comprise chromium (III) oxide, Cr₂O₃, in an amount of less than 10% by weight, less than 5% by weight, less than 2% by weight, 0.5-1.5% by weight, or a % by weight in a range defined by any of these values, for instance, 1% by weight. The diffusing material can have various properties and structures described herein with respect to the diffusive lining described in FIGS. 6A and 6B. For example, the diffusing material can have a density of 2.45 g/cm³.

The size, density and velocity distributions of inert gas bubbles can be affected by, among other things, the pores of the diffusing material 1004. The pore size of the diffuser 106 can be controlled such that the bubbles diffused therethrough and into the molten alloy have suitable size, density and velocity distributions, while preventing molten liquid alloy from infiltrating into the diffuser blocks. In some embodiments, the pore distribution in the diffusing material may be optimized, in combination with other factors, such that the distribution of bubble size, distribution of bubble number, distribution of bubble volume density, and the distribution of bubble velocity do not result in substantial coalesce of the bubbles or cause substantial turbulence of the molten alloy. The diffuser 106 can have an average pore size of greater than 20 μm, 30 μm, 40 μm, 50 μm, 60 μm, 70 μm, 80 μm, 90 μm, 100 μm, or a value in a range defined by any of these values. A porosity of the diffusing material, defined as a ratio of void space to the overall macroscopic volume, may be greater than 10%, 15%, 20%, 25%, 30%, 35%, or a value in a range defined by any of these values, for instance, 27.6%. In some embodiments, the diffusing material 1004 may comprise any of the material and characteristics described above with respect to the diffuser 400 as illustrated in FIGS. 4A-4C, or with respect to the diffusive lining 400A, 400B as illustrated in FIGS. 6A-6B.

Still referring to FIG. 10, the diffuser lining 1016 surrounding the diffusing material may directly contact the rotary furnace lining 920 and provide a seal between the diffuser block and the furnace lining to prevent the molten alloy from leaking. As the rotary furnace may go through extreme temperature variations, its components may experience significant thermal expansion and contraction as well. Such temperature variation may include uneven thermal expansion or contraction due to large thermal gradients between neighboring components. A mismatch between the thermal expansion coefficient of the diffuser lining and the furnace lining may cause undesirable stress or gaps forming between them, which may in turn cause a fracture or a leakage. Therefore, the inventors have found it advantageous to provide the diffuser block 1000 with a diffuser lining 1016 comprising a material with a thermal expansion coefficient similar to that of the furnace lining, for example, within 50%, 30%, 20%, 10%, 5%, 1%, or a value in a range defined by any of these values of that of the furnace lining 920. The diffuser lining may be formed using a mullite brick comprising 70-80% alumina by volume and 20-30% silica by volume. The diffuser lining 1016 may also comprise a material substantially similar in composition and structure to that of the furnace lining 920 (FIGS. 9A-9C) or the refractory lining 130A and 130B (FIGS. 1A and 1B). Matching the composition of the diffuser lining 1016 to the furnace lining 920 can allow them to expand and contract at the same rate, thereby maintaining a tight fit of the diffuser blocks through the expected life of the sparging rotary furnace system.

As illustrated in FIG. 10, a cross-sectional profile of the main body 1020 of diffuser block 1000 may be slightly or substantially trapezoidal or conical. The upper side of the main body 1020 may be configured to be exposed to contact the molten metal inside the furnace chamber 906, and the bottom side of the main body may be configured to connect to the gas inlet 1008 and face the outside of the furnace. A width of the upper side of the main body 1020 may be narrower than the width of the bottom side of the main body. The side surface of the main body 1020 of diffuser block 1000, which may also be the side surface of the diffuser lining 1016, extending up from the bottom side, maybe slanted inward. This narrowing trapezoidal or conical profile may help provide a better seal around the diffuser block when it is inserted from the outside into a hole with a matching narrowing shape on the side wall 918. The hole may be a through hole through a wall of the furnace chamber. A bracket may be provided on the outside of the furnace providing an inward force on the diffuser block to further secure the seal or tighten the fit between the diffuser block to the furnace wall. One or both of the upper side and the bottom side of the diffuser block 1000 may also have a curvature to match that of the furnace wall. For example, the diffuser block 1000 illustrated in FIG. 10 has a convex curvature on the bottom side to match that of the cylindrical side wall 918 the rotary furnace 900 shown in FIG. 9A.

Still referring to FIG. 10, When installed into a rotary furnace 900 (FIG. 9A), the upper surface of the diffuser block may sit approximately flush with the inner surface of the furnace lining, according to some embodiments. The top surface of the diffuser block may also protrude from the furnace lining, or form a recess from the furnace lining. The upper surface of the diffuser block 1000 may be configured to contact and bubble the inert gas diffused therethrough into the molten copper-based alloy, and may not be limited to having the flat profile as illustrated. A curved profile, such as a convex or a concave profile of the diffusing material may provide more surface area for inert gas to diffuse through compared to a flat profile. The effective area through which the inert gas diffuses from any individual diffuser block may be approximately equal to the contact area between the diffusive material and the molten copper-based alloy. When the diffusive block 1000 is installed in the rotary furnace 900 (FIG. 9A), the effective diffusing area through which the inert gas diffuses through may also be affected by the local geometries of the furnace, and may be larger or smaller than the apparent surface area of the diffusing material, according to some embodiments. Sintering from the heat of the furnace and blockage from the content of the furnace can further change the effective diffusion area or the effective pore size of the diffuser blocks throughout the lifetime of the sparging rotary system. The effective area through which the inert gas diffuses from any individual diffuser block may have an effective diameter greater than 2 cm, 5 cm, 10 cm, 15 cm, 20 cm, 25 cm, 30 cm, 35 cm, 40 cm, 45 cm, 50 cm or a value in a range defined by any of these values. In some embodiments, the diffuser block may also comprise various components that are broadly configured similarly to the corresponding components of the diffuser 400 in FIG. 4A described herein. A detailed description of some of those components may be omitted herein for brevity.

As mentioned above, the sparging rotary furnace configured for manufacturing a copper-based alloy having low impurity content may be configured into at least one of a loading configuration, a melting configuration, and a pouring configuration, illustrated in FIGS. 11-13, respectively, according to some embodiments.

FIG. 11 illustrates a cross-sectional view of a rotary furnace 900 in a loading configuration 1100. In the loading configuration 1100, the furnace is rotated into a loading angle, where the loading portal 930 is oriented such that feedstock can be conveniently loaded therethrough, and the diffuser assembly 940 is oriented such that an inert gas 1108 diffused therethrough flows across the surface of the feedstock, preferably from underneath the feedstock for increased exposure to the inert gas 1108. The rotary furnace may be locked into a loading configuration when the feedstock is being loaded into the furnace.

FIG. 12A illustrates a cross-sectional view of the rotary furnace 900 in a melting configuration 1200, viewed along a central axis from an end of the furnace. FIG. 12B illustrates a cross-sectional view of the melting configuration 1200, viewed from a side of the furnace. A stream of flame 1212 providing heat to the furnace and inert gas bubbles diffused through the molten alloy can be more clearly seen in FIG. 12B. In the melting configuration 1200, the furnace is rotated into a melting angle, where the diffuser assembly 940 contacts the molten copper-based alloy and bubbles an inert gas diffused therethrough. In the melting configuration 1200, the furnace may remain stationary at the melting angle, or rock gently around the melting angle during the melting and heating of the molten copper-based alloy. In some embodiments, the melting angle may be 0° to 180° apart from the loading angle, such that the loading portal 930 in the melting configuration 1200 is disposed at an equal or greater height compared to the loading configuration 1100 (FIG. 11), and the diffuser assembly 940 in the melting configuration 1200 is disposed at an equal or lower height compared to the loading configuration 1100.

FIG. 13 illustrates a cross-sectional view of a rotary furnace in a pouring configuration 1300. In the pouring configuration 1300, the furnace is rotated into a pouring angle, where the pouring portal 934 is below the surface of the molten copper-based alloy 1204. In the pouring configuration 1300, the rotary furnace 900 may stay stationary, or gradually tilt as the molten alloy unloads to optimize the angle and the speed of the outpouring molten alloy.

Referring back to FIG. 11, in the loading configuration 1100, the loading portal 930 may be rotated to a middle or upper portion of the rotary furnace 900, while at least one of the diffuser blocks from the diffuser assembly 940 is disposed at a lower half of the furnace chamber 906. For illustrative purposes, the diffuser block 9400 of FIG. 11-13 may correspond to any one of the diffuser blocks 9401-9404 in FIG. 9A. The loading portal 930 may be oriented between approximately 0° to 90° above the horizon with respect to the central axis, and the diffuser block 9400 may be oriented 0° to 90° below the horizon with respect to the central axis. For example, the loading portal 930 may be located approximately half-way up the side of the furnace 900. The feedstock 1104 with a combined composition to form a molten copper-based alloy may be loaded into the furnace chamber 906 through the loading portal 930 with the loading portal door 932 in an open position.

Referring to FIG. 11 and FIGS. 12A-12B, in some embodiments, the effective volume occupied by the feedstock may decrease as the solid feedstock pieces melt. As such, a plurality of feedstock pieces may be added in batches until the fully melted copper-based alloy reaches the height of a target fill line 922, defined by the intercept between the top horizontal surface of the molten alloy and an inner surface of the rotary furnace 900. To load a batch of the feedstock 1104, the rotary furnace 900 may be rotated into the loading configuration 1100 and set in a stationary position, the loading portal door 932 may then be opened and the feedstock added through the loading portal 930, after which the loading portal door 932 may be closed again.

As described elsewhere in the application, in some embodiments, an inert gas may start to be diffused through the diffuser assembly 940 into the furnace chamber 906 before feedstock 1104 is loaded and/or flowed through the surface and gaps of the feedstock 1104 while the feedstock is being loaded and melted. Advantageously, flowing the gas prior to initiating the melting can reduce the amount of oxygen incorporation in the resulting molten metal. After melting, the inert gas is bubbled through molten copper-based alloy 1204 throughout the loading process. The loading process may stop when the feedstock loaded is completely melted and the surface of the molten alloy reaches a target fill line. The inert gas may continue to be bubbled into the molten copper-based alloy after the target fill line 922 is reached. Measured from a bottom inner surface of the rotary furnace, the target fill line 922 may have a height greater than 10 cm, 20 cm, 50 cm, 100 cm, 150 cm, 200 cm, 250 cm, 300 cm, 350 cm, 400 cm, 450 cm, 500 cm, or a value in a range defined by any of these values. Because the rotary furnace 900 can rotate during operation, the fill line is not a fixed line marked on a permanent position on the furnace wall. In some embodiments, the furnace may not have a perfect cylindrical symmetry around the central axis, and the height of the fill line may change as the furnace rotates. However, the capacity of the rotary furnace 900, defined by the volume below the target fill line 922, remains constant as a rotary furnace rotates. In some embodiments, when the rotary furnace 900 is filled to the target fill line 922, the molten copper-based alloy 1204 may occupy a percentage volume of the furnace chamber 906 that is less than 10%, 20%, 30%, 40%, 50%, 60%, 70%, 80%, 90%, or a value in a range defined by any of these values, for example, less than 50%.

According to various embodiment disclosed herein, the rotary furnace may have a capacity to manufacture molten copper-based alloy in weight greater than 1000 lbs., 2000 lbs., 5000 lbs., 10,000 lbs., 20,000 lbs. 50,000 lbs., 100,000 lbs., or a value in a range defined by any of these values. The inert gas may be diffused through a porous diffusing material of the diffuser assembly 940 having contact area with the molten alloy of greater than 10 cm², 20 cm², 50 cm², 100 cm², 200 cm², 500 cm², 1000 cm², 2000 m², 0.5 m², 1 m², or a value in a range defined by any of these values, for example, between 25 cm² and 2500 cm². During the loading process, the inert gas may be provided through the diffuser assembly at a flow rate greater than 0.1 liters/minute, 0.5 liters/minute, 1 liters/minute, 2 liters/minute, 5 liters/minute, 10 liters/minute, 15 liters/minute, 20 liters/minute, 50 liters/minute, or a value in a range defined by any of these values, for example, between 1 liters/minute and 10 liters/minute, or 2-6 liters/minute, for instance about 4 liters/minute.

Still referring to FIGS. 11-12, in some embodiments, during the loading process of the rotary furnace 900, the furnace may rock or rotate back and forth one or more times, e.g., between the loading configuration 1100 and the melting configuration 1200, and the loading portal door 932 may be opened or closed one or more times before the resulting molten alloy reaches the target fill line 922 of the rotary furnace. It will be appreciated that, even though the loading portal door 932 may remain open while additional feedstock is being loaded into the furnace chamber 906, the partially enclosed atmosphere 1112 inside the furnace chamber 906 may remain substantially inert by flowing a supply of the inert gas through the diffuser assembly 940. The diffuser block 9400 may be located below the target fill line 922 or be covered by the feedstock 1104 from above, or, after the feedstock starts melting, be submerged under the molten copper-based alloy 1204. The inert gas diffused through the diffuser block 9400 may flow between gaps of the solid feedstock pieces 1104 or bubble through the molten copper-based alloy 1204 before it escapes into the enclosed atmosphere 1112 above. Therefore, a portion of the atmosphere that is in immediate contact with the feedstock 1104 or the molten copper-based alloy 1204, may be more inert than the rest of the enclosed atmosphere 1112 inside the chamber.

According to some embodiments, each batch of feedstock may be partially or fully melted before the next batch is added, and the loading portal door 932 may be closed between the batches, substantially sealing or isolating the enclosed atmosphere within the furnace chamber 906. Supply of heat or inert gas to the furnace may commence before the first batch of feedstock is loaded, and may pause between or continue through the addition of feedstock batches. The rotary furnace 900 does not need to stay in the loading configuration 1100 for the entire loading process, for example, it may be rotated into the melting configuration 1200 to completely or partially melt the existing feedstock before the next batch is added. The composition and quantity of the different batches of feedstock may not be the same, and may be adjusted to best suit the composition required by the final the low impurity molten copper-based alloy product.

Referring to FIG. 11, the feedstock 1104 can be present in a variety of forms, including one or more alloy pieces and/or elemental metal pieces. The feedstock pieces may or may not have the same composition. However, the pieces have a combined composition configured to form a molten copper-based alloy having a target composition of the alloy to be formed, and comprise at least 50 weight % copper. Various degrees of impurity such as oxidation can be present in the feedstock before melting. Depending on the sizes of the feedstock pieces, the inventors have further discovered that the amount or flow rate of the inert gas that is effective to suppress or reduce oxidation of the feedstock before and during melting as described above can be different. The amount or flow rate of the inert gas can depend on, among other things, the relative amount of open space between the feedstock pieces, or the permeability of the copper-based alloy feedstock material, that forms the raw material to create the molten copper-based alloy 1204. A relatively high amount of open space or permeability, which may be present when the feedstock comprises relatively large feedstock pieces, may have a relatively small amount of surface area of alloy exposed to the inert gas. For instance, in some embodiments, the feedstock material may comprise feedstock pieces having relatively large sizes and correspondingly higher amount of open space or permeability. For feedstock with high permeability, relatively high flow rates of inert gas, e.g. greater than or about 5 liters/minute, through the diffuser assembly 940, may be suitable to remove the oxygen and oxygen-related impurities from the feedstock. In some embodiments, the feedstock material may comprise feedstock pieces having a relatively small size and correspondingly lower amount of open space or permeability. For example, the feedstock may be relatively small copper-based alloy turnings (e.g., copper-based scrap). For feedstocks with low permeability, relatively low flow rates of inert gas, e.g. less than about 5 liters/minute, through the diffuser assembly 940, may be suitable to remove the oxygen and oxygen-related impurities from the feedstock. The flow rate of inert gas before and during melting of the feedstock as described herein may also have any value that is the same or different relative to the flow rate of inert gas during bubbling of the inert gas through the molten alloy in the melting configuration 1200, as discussed herein, which values are not repeated herein for brevity. Other factors that may determine the optimal flow rate of the inert gas can include the impurity level of the feedstock, the quantity of the feedstock batches to be or being loaded, the amount existing feedstock or molten alloy present in the furnace, or the temperature of the furnace and the alloy inside the furnace.

Still referring to FIG. 11, in various embodiments, heat may be provided by the burner system through the burner inlet 910 to the rotary furnace 900 and the feedstock 1104 in the form of a flame 1212 before, during, or after the feedstock is loaded. In order to keep the impurity level in the final molten copper-based alloy sufficiently low, it can be beneficial to supply heat and inert gas to the furnace before the feedstock is loaded, heated or melted in a pre-heating or a pre-purging process, the details of which is discussed below.

The inventors have discovered that undesirable ambient impurity-inducing substances, such as oxygen, hydrogen, and moisture may be present in the atmosphere inside the furnace chamber 906. Similar ambient impurity-inducing substances may also be present in the furnace lining or on the surface of the feedstock, through absorption, adsorption, or chemical reaction such as oxidation. At certain elevated temperatures, for instance, the temperature needed to form the molten copper-based alloy, some of the ambient impurities-inducing substances may be released from these surfaces, and be released into the atmosphere inside the furnace chamber 906 or directly into the copper-based alloy. When these impurity-inducing substances come into contact with the feedstock 1104 or the molten copper-based alloy 1204, it may react or be integrated into the alloy, and remain in the resulting molten copper-based alloy, negatively affecting the mechanical, thermal, and electrical properties of the ingot or shot manufactured. For example, when the furnace is heated, oxygen or moisture from the furnace wall 908 can be released into the atmosphere of the furnace chamber 906, and can react with the feedstock loaded subsequently loaded into the chamber, forming an oxide on the surface of the feedstock. When the oxidized feedstock is melted, the surface oxidation may remain stable in oxide form or release oxygen into the molten copper-based alloy, thereby contributing to the oxygen and oxygen-related impurities in the final molten alloy. Therefore, pre-heating the furnace before the feedstock is loaded and pre-purging the furnace the feedstock with an inert gas before feedstock is heated or melted can help reduce the amount of impurities present in the final molten copper-based alloy.

Still referring to FIG. 11, in various embodiments, in the loading configuration 1100, the rotary furnace 900 may be pre-heated to a temperature below the liquidus temperature of the copper-based alloy before the feedstock is loaded. The inventors have found it advantageous to pre-heat the inside of the rotary furnace to a temperature sufficiently high to promote or accelerate the release of impurities such as oxygen, hydrogen, or moisture from the furnace lining while not high enough to cause significant oxidization of the feedstock, for example, less than 120° C., 150° C., 175° C., 200° C., 225° C., 250° C., 300° C., 350° C., 400° C., 500° C., or a value in a range defined by any of these values, for example, less than 200° C. The inventors have also found it advantageous to pre-purge the sparging rotary furnace system 90 with an inert gas before the system is substantially heated, including pre-purging at least one of the diffuser assembly 940, the furnace chamber 906, or the transfer system configured to receive the molten copper-based alloy. One or more of these components of the sparging rotary furnace system 90 may be enclosed in a substantially inert atmosphere and substantially isolated or sealed from the ambient atmosphere outside of the furnace system. To reduce or prevent a backflow of the ambient air from outside of the furnace chamber, or to exclude outside air from mixing with enclosed atmosphere 1112, the loading portal door 932 may be closed, and the exhaust duct may be placed against the exhaust portal during the pre-purging process. The feedstock 1104, when loaded, may then be loaded into a furnace chamber 906 with a substantially inert enclosed atmosphere 1112 with significantly less impurity-inducing substance than an ambient atmosphere outside the furnace. In addition, the inventors have found it advantageous to continue flowing the inert gas through the feedstock and preferably through the gaps between feedstock pieces while the feedstock is being loaded and heated. In this way, the feedstock may continue to be heated and melted while being surrounded by the substantially inert enclosed atmosphere 1112 with low level of potentially impurity-inducing substances, for example, oxygen, hydrogen, moisture, or other reactive or undesirable substances that can negatively affect the purity of the molten copper-based alloy. Any volatile impurity-inducing substance released from the feedstock may be also carried away by the flow of the inert gas and be prevented from re-entering the molten copper-based alloy. To increase the contact between the inert gas 1108 and the loaded feedstock 1104, the diffuser assembly 940 can be disposed in a lower half of the furnace chamber 906 in the loading configuration 1100, such that the loaded feedstock may cover at least a portion of the diffuser assembly, and the inert gas 1108 may be diffused from the bottom of the feedstock stack. In some embodiments, the pre-heating or the pre-purging of the furnace may last for a period of time greater than 5 minutes, 10 minutes, 20 minutes, 30 minutes, 1 hour, 2 hours, 3 hours, 5 hours, 6 hours, 10 hours, or a value in a range defined by any of these values, before the feedstock is loaded. In some embodiments, purging or flowing of the inert gas through the feedstock material may last, for example, 1 minute, 2 minutes, 5 minutes, 10 minutes, 20 minutes, 30 minutes, 45 minutes, 60 minutes, 1 hour, 2 hours, 3 hours, or a value in a range defined by any of these values before the feedstock is substantially heated or substantially melted.

As illustrated in FIGS. 12A-12B, after the feedstock 1104 is loaded into the rotary furnace 900, the feedstock 1104 may be heated and melted to form a molten copper-based alloy 1204, with the furnace configured in a melting configuration 1200. In the melting configuration 1200, the furnace is rotated into a melting angle, where the diffuser assembly 940 comes into contact with the molten copper-based alloy and bubbles an inert gas diffused therethrough from the bottom of the alloy. In the melting configuration 1200, the furnace may remain stationary at the melting angle, or gently rock about the melting angle. In some embodiments, the melting angle may be 0° to 180° apart from the loading angle, such that the loading portal 930 in a melting configuration 1200 is located at an equal or greater height compared to the loading configuration 1100. In some embodiments, the diffuser assembly 940 in a melting configuration 1200 may be located at an equal or lower height compared to the loading configuration 1100. For example, the melting angle may be 0°-135°, 0°-90°, 15°-75°, 30°-60° apart, for instance approximately 45° apart from the loading angle, and at least a portion of the diffuser assembly 940 may be located below the target fill line 922.

As illustrated in FIGS. 12A-12B, in the melting configuration 1200, the loading portal 930 may be configured in an upper portion of the rotary furnace 900 away from the molten copper-based alloy, while the diffuser assembly 940 may be configured at the bottom of the rotary furnace 900. For example, the loading portal 930 may be oriented between approximately 45° to 90° above the horizon with respect to the central axis, and at least one diffuser block 9400 may be oriented 45° to 90° below the horizon with respect to the central axis. The diffuser assembly 940 may be located near a bottom of the rotary furnace 900 or the furnace chamber 906. Heat may be provided to the furnace to heat the molten copper based in the form of a stream of flame 1212 in the melting configuration 1200 by combusting a fuel that is injected as a stream into the furnace chamber 906. An inert gas 1208, diffused through a porous diffusing material of the diffuser block 9400, may be bubbled through the molten copper-based alloy to entrain impurities, for example, oxygen and oxygen-related impurities.

Still referring to FIGS. 12A-12B, the rotary furnace 900 can be configured to have a variable internal temperature during the manufacturing of various molten copper-based alloys. In some embodiments, the internal temperature of the melting furnace 900 is between 700° F. and 3000° F. In some embodiments, the rotary furnace 900 can be configured to reach an internal temperature greater than 700° F. 900° F., 1000° F., 1200° F., 1400° F., 1600° F., 1800° F., 2000° F., 2200° F., 2400° F., 2500° F., or 3000° F. or a value in a range defined by any of these values. The inventors have found that heating the molten copper-based alloy 1204 to a temperature greater than its melting temperature while bubbling an inert gas 1208 therethrough may be advantageous to the removal of oxygen and oxygen-related impurities from the alloy. For example, the inventors have found it advantageous to heat the molten alloy to a temperature greater than 10° C., 20° C., 50° C., 100° C., 150° C., 200° C., 350° C., 300° C., 400° C., 450° C., 500° C., 600° C., 700° C., or a value in a range defined by any of these values above its melting temperature while bubbling an inert gas therethrough.

Still referring to FIGS. 12A-12B, as discussed before, a stream of fuel may be injected through the burner inlet 910 comprising an injector into to the rotary furnace 900, and ignited to form a stream of flame 1212. The stream of fuel may be a mixture of fuel and oxygen in some implementations for efficient combustion. The stream of flame 1212 may be the result of a complete or incomplete combustion. In some embodiments, the stream of fuel and the resulting flame 1212 may reach a high velocity, e.g., a velocity exceeding 50 m/s, 100 m/s, 150 m/s, 200 m/s, 250 m/s, 300 m/s, or a value in a range defined by any of these values. In some embodiments, the temperature of the flame may be greater than 500° C., 750° C., 1000° C., 1250° C., 1500° C., 1600° C., 1700° C., 1800° C., 1900° C., 2000° C., 2100° C., 2200° C., 2300° C., 2500° C., 3000° C., or a value in a range defined by any of these values. The fuel may be provided by the burner system at a rate greater than 500 liters/min., 1000 liters/min., 2000 liters/min., 4000 liters/min., 6000 liters/min., 8000 liters/min., 10,000 liters/min., or a value in a range defined by any of these values. The fuel may also be provided by the burner system at a rate greater than 15 standard cubic feet/min. (scf/min.), 40 scf/min., 70 scf/min., 100 scf/min., 150 scf/min., 200 scf/min., 350 scf/min., or a value in a range defined by any of these values. The thermal power generated by the fuel or received by the sparging rotary furnace system 90 and the molten copper-based alloy 1204 may be greater 0.5 MWatt, 1.0 MWatt, 2.0 MWatt, 3 MWatt, or a value in a range defined by any of these values. The temperature and the heating power of the fuel may be controlled by the rate at which the fuel is provided, the state at which the fuel is provided (for example, droplet size), the composition of the fuel, the amount of oxygen available to the fuel, and the pressure at which the fuel is provided.

Still referring to FIGS. 12A-12B, in some embodiments, the stream of fuel may be injected into the furnace chamber 906, and the combustion may take place in the enclosed atmosphere 1112 directly above the molten copper-based alloy. In some implementations, the stream of flame 1212, which may contain unreacted oxygen, may be kept relatively narrow relative to a diameter of the furnace chamber 906, and may be localized within the enclosed atmosphere 1112 above the feedstock 1104 and/or the molten copper-based alloy 1204, without substantially directly impinging thereon to suppress their oxidation. The fuel may be injected along an axis of elongation of the furnace chamber, and the resulting flame may extend over a substantial length of the furnace, for example, a substantial length along the central axis 902 of the rotary furnace 900. The thermal power generated by the flame may be passed to the rotary furnace lining 920 and the molten copper-based alloy through conduction, radiation, or convection. The amount of thermal power received by, and thereby the temperature of the furnace and the molten alloy may also depend on the distance between the furnace lining 920 and the molten copper-based alloy 1204 and the flame. The stream of fuel provided to the rotary furnace 900 to generate the flame may comprise a gaseous or a liquid hydrocarbon, for example, the fuel may comprise natural gas, methane, ethane, propane, butane, or an oil. The burner system may compress and/or mix the fuel before injecting it through the burner inlet 910 into the furnace chamber 906 at a high speed or pressure. Oxygen or ambient air may be mixed with the fuel and provided through the burner inlet to help sustain the combustion of the fuel. The amount of oxygen or ambient air provided to the fuel may be optimized such that the amount of oxygen is sufficient to sustain a flame for heating the furnace and the molten alloy, but not too much to be left over from the combustion process and cause undesired oxidation of the molten copper alloy. For example, the amount of oxygen provided by the burner system may be approximately equal to the amount needed for complete combustion of the fuel it accompanies. In order to reduce the exposure of the molten copper-based alloy to oxygen, it can be beneficial to have most or all of the oxygen provided with the fuel through the burner to the furnace consumed by the combustion. Any residue oxygen that is not consumed by the combustion may be flushed away from the furnace chamber 906 using the inert gas provided through the diffuser assembly 940. The inert gas bubbled through the molten copper-based alloy may also help prevent the oxygen provided through the burner from contacting and combining with the molten alloy 1204 by forming a substantially inert layer of air immediately above the molten alloy as bubbles break at the surface of the alloy, separating the stream of flame 1212 from the molten copper-based alloy. This substantially inert layer of air may be more inert than the rest of the enclosed atmosphere 1112 in the furnace chamber.

Still referring to FIGS. 12A-12B, in some embodiments, a local temperature of the furnace lining 920 may vary, and may differ from a local temperature of the molten copper-based alloy 1204. For example, the inventors have found that the local temperature of the portion of furnace lining closer to the flame may be higher than that of the portion further away from the stream of flame 1212. The inventors have also found that the local temperature of the portion of furnace lining directly exposed to the flame may be higher than that of the portion submerged under the molten copper-based alloy. The local temperature of the molten copper-based alloy 1204 may also vary. In some embodiments, the local temperature of the portion of the molten alloy closer to the flame may be higher than that of the portion of the molten alloy further away from the flame, for example, the temperature of a surface portion of the molten copper-based alloy may be higher than that of a bottom portion of the alloy. Therefore, the inventors have found it beneficial to gently rock the furnace back and forth around a melting angle, such that the portion of the furnace with the higher temperature may come into contact with the portion of the molten alloy with a lower temperature. After the portion of the furnace lining with the higher temperature comes into contact with a molten alloy, it may transfer its heat to the molten alloy, and its temperature may decrease or may equilibrate with the molten alloy in its immediate surroundings, depending on the duration of the contact time. The portion of the furnace with the now lowered and/or equilibrated temperature may then be rocked back to an original position above the molten copper-based alloy and closer to the flame, be heated up by the flame again, and enter the next cycle of the rocking. This rocking motion of the furnace may be transferred to the molten alloy due to a viscous effect, and lead to a gentle stirring or mixing of the liquid alloy, thereby increasing the uniformity of both the temperature and the chemical composition of the molten copper-based alloy. This gentle rocking of the furnace may last continuously or intermittently throughout the heating and the melting of the copper-based alloy, providing a more uniform heating and more efficient usage of the thermal power generated by the fuel. The angular speed at which the gentle rocking of the rotary furnace 900 takes place may be greater than 1°/min, 5°/min, 10°/min, 15°/min, 30°/min, 45°/min, 60°/min, 90°/min, 120°/min, 180°/min, 270°/min, 360°/min, 480°/min, 720°/min, or a value in a range defined by any of these values. The angular range of the rocking motion can be greater than 1°, 2°, 5°, 10°, 20°, 30°, 45°, 60°, 75°, 90°, 120°, 150°, 180°, or a value in a range defined by any of these values. As discussed elsewhere in the application, rocking the rotary furnace 900 may increase the effectiveness of removal of impurities such as oxygen-related impurities by increasing the probability that an inert gas bubble may come into contact with impurities.

Still referring to FIGS. 12A-12B, the inventors have also found it advantageous to provide an inert gas to the sparging rotary furnace system 90 while the molten copper-based alloy is being heated. The inventors have further found it advantageous to diffuse an inert gas through the diffuser block 9400, and bubble the inert gas through the molten copper-based alloy 1204, and to fill the enclosed atmosphere 1112 above the molten copper-based alloy 1204 with the inert gas. The enclosed atmosphere 1112 above the molten copper-based alloy may be a substantially inert atmosphere containing significantly less impurity-inducing substance than an ambient atmosphere outside of the furnace chamber 906, and may be substantially or completely enclosed by the rotary furnace 900 during operation. In order to provide further enclosure from the outside atmosphere, various portals to the rotary furnace may be closed during the heating of the molten copper-based alloy. For instance, as illustrated in FIG. 12B, the loading portal door 932 of the furnace may remain closed, and the exhaust duct 972 may be placed against the exhaust portal while the molten copper-based alloy 1204 is being heated and the inert gas bubbled through the molten copper-based alloy 1204.

Still referring to FIGS. 12A-12B, in some embodiments, the substantially inert atmosphere above the molten copper-based alloy comprises one or more inert gases. In some embodiments, the substantially inert atmosphere of the furnace chamber comprises argon (Ar). In some embodiments, the substantially inert atmosphere of the furnace chamber comprises substantially higher levels of nitrogen gas (N₂) compared to an outside atmosphere. In some embodiments, the substantially inert atmosphere of the furnace chamber comprises substantially lower level of oxygen, hydrogen, moisture, or other reactive or undesirable substances that can negatively affect the purity of the molten copper-based alloy, compared to an outside atmosphere.

To maintain the atmosphere above the molten copper-based alloy sufficiently inert, the various portals to the furnace may be closed but do not need to be sealed (e.g. airtight or hermetically sealed) during loading, heating, melting, or pouring of the molten copper-based alloy. In some embodiments, the atmosphere above the molten copper-based alloy sufficiently may be maintained substantially inert by flowing the inert gas into the furnace chamber at a sufficient rate, without completely closing each and every single portal of the furnace. According to various embodiment, when the inert gas is flowed into the chamber at a sufficient rate into the furnace chamber 906 through the diffuser assembly 940, an outward flow of air from inside to the outside of the chamber occurs through various portals of the furnace, for instance, through the loading portal 930, pouring portal 934, or the exhaust portal 914, which may be sufficient to exclude the ambient air by suppressing a backflow of the outside ambient air. In other words, a positive pressure of the inert gas may be maintained inside the furnace chamber 906 by diffusing the inert gas through the diffuser assembly 940 into the rotary furnace 900, thereby keeping the enclosed atmosphere 1112 substantially inert.

Still referring to FIGS. 12A-12B, as discussed herein, to optimize impurity removal from the molten alloy, the inventors have found it beneficial to increase the contact between inert gas bubbles and the molten alloy. Therefore, in order to increase the surface area of the inert gas bubbles, it can be advantageous to also increase the distance traveled by the inert gas bubble in the molten alloy and the dwelling time of the inert gas bubble in the molten alloy. This can be achieved by having at least one diffuser block 9400 disposed at or near the bottom of the molten copper-based alloy 1204, bubbling the inert gas 1208 from the lower points of the molten copper-based alloy 1204. For example, it can be beneficial to place the diffuser block 9400 in contact with a bottom portion of the molten copper-based alloy, or at a location at or near the bottom of the furnace chamber vertically substantially farthest from the target fill line 922 in a melting configuration 1200. A portion of the diffuser assembly 940 may remain in contact with the molten copper-based alloy 1204 as the rotary furnace gently rocks back and forth in a melting configuration 1200, for instance, the diffuser block 9400 may remain below the target fill line 922 in while bubbling the inert gas into the molten copper-based alloy in the melting configuration. In some embodiments, in order to increase the contact area between the inert gas and the molten copper-based alloy, it may be advantageous to submerge all the diffuser blocks of the diffuser assembly 940 under the molten copper-based alloy in a melting configuration. For instance, the diffuser blocks may be disposed around the furnace chamber such that at a certain angle of rotation, all diffuser blocks of the diffuser assembly 940 are positioned below the target fill line 922.

Still referring to FIGS. 12A-12B, the inventors have further discovered that, combinations of various flow parameters related to diffusing and bubbling the inert gas 1208 through the molten copper-based alloy can be advantageous to the removal of oxygen and oxygen-related impurities from the molten copper-based alloy 1204. In various embodiments, the inventors have discovered that the size distribution, volume density distribution, and velocity distribution of the inert gas bubbles 1208 traveling through the molten alloy 1204 can influence the effectiveness of the bubbles at removing the impurities. When the size, volume density, and velocity of the gas bubbles 1208 are too small or too low, the bubbles can be too slow or ineffective at removing oxygen or oxygen-related impurities. On the other hand, when the size, volume density, and velocity of the gas bubbles are too large or too high, the bubbles can create substantial turbulence as the bubbles rise and break at the surface of the molten copper-based alloy 1204. The inventors have discovered that such turbulence, when substantial, can not only negate any removal of oxygen or oxygen-related impurities, but can even increase the content of oxygen or oxygen-related impurities. As such, the inventors have discovered that controlling the size distribution, volume density distribution, and velocity distribution of the inert gas bubbles 1208 can be critical to producing molten copper-based alloy with low impurity. The size, density and velocity distributions of the bubbles can depend on a variety of factors, including the composition, temperature, and viscosity of the molten copper-based alloy 1204, the total flow rate of the inert gas diffused through the diffuser assembly 940, the flux or the local flow rate per area of the inert gas diffused through the diffuser blocks into the molten alloy, the porosity and pore size distribution of the diffusing material of diffuser blocks, the depth or height of the molten alloy through which the gas bubbles rises, the cross-sectional area of the molten alloy the inert gas bubbles cover or fails to cover, and the total volume of the molten copper-based alloy 1204, the geometry of the furnace chamber 906, and any motion of the rotary furnace 900 and the molten copper-based alloy 1204, to name a few. It will be appreciated that these flow parameters can be inter-dependent. For example, the flow rate of the inert gas and the cross-sectional flow area determine the flux of the inert gas, and the viscosity of the molten alloy may depend on the composition and temperature of the molten alloy.

The inventors have discovered that viscosity can depend on the temperature of molten alloy. Therefore, to achieve desirable size distribution, volume density distribution, and velocity distribution for the inert gas bubbles, the viscosity of the molten copper-based alloy may be adjusted by adjusting the heating power provided to the alloy. The inventors have also discovered that, in some embodiments, the inert gas bubbles may be more effective at oxygen and oxygen-related impurities removal when the molten alloy is heated to a temperature greater than, 10° C., 20° C., 50° C., 100° C., 150° C., 200° C., 250° C., 300° C., 350° C., 400° C., 450° C., 500° C., 550° C., 600° C., 700° C., or a value in a range defined by any of these values, above the melting or liquidus temperature of the alloy, for example, between 100° C. and 400° C. above the melting temperature of the molten copper-based alloy.

According to some embodiments, the total flow rate of the inert gas diffused through all the diffuser blocks of the diffuser assembly 940 and bubbled into the molten copper-based alloy 1204 can be greater than 10 liters/minute, 9 liters/minute, 8 liters/minute, 7 liters/minute, 6 liters/minute, 5 liters/minute, 4 liters/minute, 3 liters/minute, 2 liters/minute, 1 liter/minute or any value in a range defined by these values, such as 1-10 liters/minute or 2-6 liters/minute, for instance about 4 liters/minute. According to some embodiments, the individual flow rate of the inert gas diffused through a individual diffuser block of the diffuser assembly and bubbled into the molten copper-based alloy 1204 can be the total flow rate divided by the number of diffuser blocks. For rotary furnaces with various capacities, the flow rate of the inert gas bubbled through the molten copper-based alloy manufactured using the furnace may be adjusted accordingly. For example, in some embodiments, the flow rate of the inert gas bubbled through a molten copper-based alloy manufactured using a rotary furnace may be adjusted in proportion to the weight, volume, or cross-sectional area of the molten copper-based alloy 1204, or in proportion to the capacity of the rotary furnace. For example, for a furnace having a capacity to manufacture molten copper-based alloy weighing greater than 1000 lbs., 2000 lbs., 5000 lbs., 10,000 lbs., 20,000 lbs. 50,000 lbs., 100,000 lbs., or a value in a range defined by any of these values, for instance, 120,000 lbs., the inert gas can be bubbled into the molten alloy at a flow rate in the range as described above, for example, 1-10 liters/minute, through a porous diffusing material with a total diffusing area of 25-2500 cm². In some embodiments, a total flow of inert gas that may be bubbled through may be determined based on any of the above capacity and flow values.

FIG. 13 is a schematic cross-sectional illustration of a rotary furnace 900 in a pouring configuration 1300, viewed along the central axis from the burner inlet end, according to some embodiments. As illustrated in FIG. 13, after a feedstock is melted to form the molten copper-based alloy 1204, a portion of the molten alloy may be ready to be transferred out of the rotary furnace 900 in the pouring configuration 1300. In the pouring configuration 1300, the furnace is rotated into a pouring angle, where a pouring portal 934 may be positioned to stay below the surface level of the molten copper-based alloy 1204 such that the alloy can be transferred out of the furnace through the portal at an appropriate speed. In some embodiments, the pouring portal 934 may be disposed near a bottom of the rotary furnace 900 in the pouring configuration 1300. In some embodiments, an inert gas 1108 may continue to be provided to the rotary furnace 900 during the pouring or transferring process of the molten alloy. In some embodiments, at least part of the diffuser assembly 940 may stay in contact with the molten alloy and continue to bubble an inert gas into the molten alloy in the pouring configuration 1300. In some embodiments, at least part of the diffuser assembly 940 may be in contact with an enclosed atmosphere 1112 above the molten alloy in the pouring configuration and flow an inert gas directly into the enclosed atmosphere 1112 above the molten copper-based alloy. In some embodiments, the diffuser block 9400 may be located above the target fill line 922 of the rotary furnace 900 and diffuse an inert gas 1108 directly into the enclosed atmosphere 1112 above the molten copper-based alloy 1204. Various portals of the sparging rotary furnace 900 may be closed to completely or substantially enclose the atmosphere 1112 inside the furnace chamber 906 from an outside atmosphere in a pouring configuration.

Still referring to FIG. 13, in the pouring configuration 1300, a transfer system (not shown) may be configured to receive the molten copper-based alloy from the pouring portal 934. The transfer system may also be enclosed in a substantially inert atmosphere and may be substantially isolated from an ambient outside atmosphere. In some embodiments, the transfer system may comprise a transfer ladle, a velocity control element, or molds with various features similar to the corresponding components disclosed with respect to FIGS. 1-3, the details of which will be omitted here for brevity. Additionally, according to some embodiments, when the molten copper-based alloy 1204 is ready to be transferred, the pouring portal stopper 936 may be opened and a portion of the molten copper-based alloy 1204 poured into a transfer ladle comprising one or more ladle spouts. Once filled, the transfer ladle may then be tipped and the molten copper-based alloy 1204 poured through the one or more ladle spouts into one or more ingot molds. The molten copper-based alloy 1204 solidifies in the molds, thereby forming a solidified copper-based alloy ingot. The one or more molds can be moved via a conveyer belt where they may be further processed, e.g., cooled, prior to being collected.

Still referring to FIG. 13, as the height of the surface level of the molten copper-based alloy may change during the pouring process, the melting furnace may be tilted continuously or intermittently to adjust the pouring angle and the flow rate of the molten alloy. In some embodiments, the pouring angle may be 0°-180° apart from the melting angle, such that the pouring portal 934 in the pouring configuration 1300 is disposed at an equal or lower height compared to the melting configuration 1200 (FIGS. 12A-12B). In some embodiments, the diffuser block 9400 may be disposed at an equal or higher height in the pouring configuration 1300 compared to the melting configuration 1200. For example, the pouring angle may be 0°-135°, 0°-90°, 15°-75°, 30°-60° apart, for instance approximately 45° apart from the melting angle.

Still referring to FIG. 13, the inventors have found that the concentration of oxygen or oxygen-related impurities may vary between different portions of the molten copper-based alloy 1204. In some embodiments, the inventors have discovered that the content of oxygen or oxygen-related impurities can be higher towards the surface of the molten copper-based alloy 1204. Thus, advantageously, the molten copper-based alloy 1204 at a lower portion of the rotary furnace may be preferentially transferred through the pouring portal 934 when an alloy of lower than average oxygen content is desired. This can be achieved, according to some embodiments, by orienting the rotary furnace 900 such that the pouring portal 934 is positioned, for example, to access the lower 10%, 20%, 30%, 40%, 50%, 60%, 70%, 80%, or 90% of the volume of the molten copper-based alloy. Alternatively, a mechanical pump may be employed to preferentially pump the molten copper-based alloy 1204 from a bottom portion thereof, which is then transferred to the transfer system. These and various additional features associated with transferring the molten copper-based alloy 1204 outside of the melting furnace may parallel those associated with induction-type furnace.

Still referring to FIG. 13, the inventors have found that, prior to transferring the molten copper-based alloy 1204, it may be advantageous to cool the molten copper-based alloy 1204 under a substantially inert enclosed atmosphere 1112 to a temperature closer to but above its melting or liquidus temperature. The cooling may take place in either the pouring configuration 1300 or the melting configuration 1200. The inventors have discovered that, in some embodiments, when the molten copper-based alloy is transferred out of the furnace at a higher temperature, impurities-inducing substances may react or combine with molten copper-based alloy more readily compared to lower temperatures. Therefore, cooling the molten alloy before transferring it out of the furnace may help reduce the amount of impurity the alloy may collect during the transfer process. Thus, according to various embodiments, the temperature of the molten copper-based alloy 1204 as it is being transferred or poured out of the sparging rotary furnace 900 may be cooler than a temperature of the alloy during a melting process by greater than 10° C., 20° C., 50° C., 100° C., 150° C., 200° C., 250° C., 300° C., 350° C., 400° C., 450° C., 500° C., 600° C. or any temperature in a range defined by any of these values, while remaining above a liquidus temperature of the molten copper-based alloy. According to various embodiments, the temperature of the molten copper-based alloy as it is being transferred or poured out of the sparging rotary furnace 900 may be lower than 500° C., 400° C., 300° C., 250° C., 200° C., 150° C., 50° C., 10° C., or any temperature in a range defined by any of these values above a liquidus temperature of the molten copper-based alloy. An inert gas 1108 may be supplied to the rotary furnace 900 while the molten copper-based alloy 1204 cools. In some embodiments, at least a portion of the diffuser assembly 940 may be arranged above the surface of the molten copper-based alloy, and the inert gas 1108 diffused directly into the enclosed atmosphere 1112 while the alloy cools. For instance, the diffuser block 9400 may be located above the target fill line 922 of the rotary furnace 900 and flow the inert gas 1108 directly into the atmosphere above the molten copper-based alloy 1204 in a pouring configuration 1300 while the alloy cools. In some other embodiments, at least a portion of the diffuser assembly 940 may be arranged beneath the surface of the molten copper-based alloy while it cools, and at least a portion of the inert gas diffused through a diffuser assembly 940 may bubble through the molten copper-based alloy 1204 before escaping into the enclosed atmosphere 1112. For instance, the diffuser block 9400 may be located below the target fill line 922 of the rotary furnace 900 and bubbles the inert gas 1108 directly into the molten copper-based alloy 1204 in the pouring configuration 1300. Various portals of the rotary furnace 900 may be closed, and the enclosed atmosphere 1112 above the molten copper-based alloy 1204 may be maintained substantially inert during the pre-transfer cooling process. A flow rate of the inert gas bubbled into the alloy during the cooling process may differ from during the melting process. Among other things, the location of the diffuser blocks and the viscosity of the molten copper-based alloy during the cooling process may differ from those in a melting process, calling for an adjustment in the flow rate of the inert gas in order to optimize its impurity removal efficiency.

In the following, various Additional Examples are disclosed. It will be appreciated that any one of the Additional Examples can be combined with any other one(s) of the Additional Examples, unless doing so would be contrariwise to the present disclosure.

### Additional Examples I

1. An apparatus for manufacturing a copper-based alloy, the apparatus comprising:
an enclosed melting furnace configured to form a molten copper-based alloy comprising at least 50 weight % copper under an enclosed inert atmosphere and to bubble an inert gas through the molten copper-based alloy; and
a transfer ladle configured to receive the molten copper-based alloy from the melting furnace under the enclosed inert atmosphere and to transfer the molten copper-based alloy into one or more molds or a shot pit configured to solidify the molten copper-based alloy.

2. An apparatus for manufacturing a copper-based alloy, the apparatus comprising:
an enclosed melting furnace configured to form a molten copper-based alloy comprising at least 50 weight % copper under an enclosed inert atmosphere and to bubble an inert gas through the molten copper-based alloy; and
a transfer ladle configured to receive the molten copper-based alloy from the melting furnace through a velocity control element, and to transfer the molten copper-based alloy into one or more molds or a shot pit configured to solidify the molten copper-based alloy.

3. The apparatus of Embodiment 1, wherein the transfer ladle is configured to receive the molten copper-based alloy from the melting furnace through a velocity control element.

4. The apparatus of Embodiment 2, wherein the transfer ladle is configured to receive the molten copper-based alloy from the melting furnace under the enclosed inert atmosphere.

5. The apparatus of any one of the above Embodiments, wherein the transfer ladle is configured to transfer the molten copper-based alloy into the shot pit configured to solidify the molten copper-based alloy into a copper-based shot.

6. The apparatus of any one of the above Embodiments, wherein the one or more molds are ingot molds which are configured to solidify the molten copper-based alloy into a copper-based ingot.

7. The apparatus of any one of the above Embodiments, wherein the enclosed melting furnace and the transfer ladle are configured to substantially exclude outside air from mixing with the enclosed inert atmosphere.

8. The apparatus of any one of the above Embodiments, wherein the melting furnace and the transfer ladle are integrally connected to be sealed from an outer atmosphere while under a common enclosed inert atmosphere.

9. The apparatus of any one of the above Embodiments, wherein the inert gas and the same enclosed inert atmosphere consist essentially of argon.

10. The apparatus of any one of the above Embodiments, wherein the inert gas is hydrogen-free.

11. The apparatus of any one of the above Embodiments 1, 3 and 5-10, further comprising a velocity control element configured to transfer the molten copper-based alloy from the enclosed melting furnace to the encapsulated transfer ladle at a controlled velocity adapted for reduced velocity-induced entrainment in the copper-based alloy to a reference copper-based alloy formed from a reference apparatus configured to be the same as the apparatus except for the presence of the velocity control element.

12. The apparatus of Embodiment 11, wherein the velocity control element comprises a ramp.

13. The apparatus of Embodiment 11 or 12, wherein the controlled velocity is less than 100 in/s.

14. The apparatus of any one of the above embodiments, further comprising a second velocity control element configured to transfer the molten copper-based alloy from the encapsulated transfer ladle to the one or more molds or the shot pit at a second controlled velocity adapted for reduced velocity-induced entrainment in the copper-based alloy relative to a reference copper-based alloy formed from a reference apparatus configured to be the same as the apparatus except for the presence of the velocity control element.

15. The apparatus of Embodiment 14, wherein the second velocity control element comprises a ramp.

16. The apparatus of Embodiment 14 or 15, wherein the second controlled velocity is less than 30 in/s.

17. The apparatus of any one of the above Embodiments, wherein the encapsulated transfer ladle is thermally insulated.

18. The apparatus of any one of the above Embodiments, further comprising a diffuser disposed at the bottom of the melting furnace and having a plurality of through-holes adapted for bubbling the inert gas into the molten copper-based alloy in the form of inert gas bubbles having a size distribution adapted to reduce an oxygen content from the molten copper-based alloy.

19. The apparatus of Embodiment 18, wherein the diffuser is configured to flow therethrough the inert gas at a flow rate of 2-6 liters per minute.

20. The apparatus of Embodiments 18-19, wherein the diffuser has a porosity greater than 20%.

21. The apparatus of Embodiments 18-19, wherein the diffuser has a diameter greater than 5 cm and smaller than an inner diameter of the melting furnace.

22. The apparatus of Embodiments 18-19, wherein the melting furnace has an inner diameter exceeding 50 cm.

23. The apparatus of any one of the above Embodiments, wherein the apparatus is configured such that the copper-based alloy has an oxygen content that is reduced by at least 10% relative to a reference copper-based alloy formed from a reference apparatus configured to be the same as the apparatus except for the melting furnace and the transfer ladle being under the same enclosed inert atmosphere.

24. The apparatus of any one of the above Embodiments, wherein the apparatus is configured such that the copper-based alloy has an oxygen content that is reduced by at least 10% relative to a reference copper based alloy formed from a reference apparatus configured to be the same as the apparatus except for the melting furnace being configured to bubble the inert gas through the molten copper-based alloy.

25. The apparatus of any one of the above Embodiments, wherein the apparatus is configured such that one or more testing results obtained using an ASTM E8/E8M-21 method from the copper-based alloy has, relative to a reference copper-based alloy formed from a reference apparatus configured to be the same as the apparatus except for the melting furnace and the transfer ladle being under the same enclosed inert atmosphere:
an ultimate tensile strength that is increased by at least 5 ksi;
0.5% yield strength that is increased by at least 3 ksi;
elongation that is increased by at least 5%; and
reduction in cross-sectional area that increased by at least 5%.

26. The apparatus of any one of the above Embodiments, wherein the apparatus is configured such that the copper-alloy has an ultimate tensile strength that is increased by at least 20 ksi relative to a reference copper-based alloy formed from a reference apparatus configured to be the same as the apparatus except for the melting furnace being configured to bubble the inert gas through the molten copper-based alloy.

27. The apparatus of Embodiment 1, wherein the transfer ladle is configured to transfer the molten copper-based alloy into the shot pit configured to solidify the molten copper-based alloy into the copper-based shot.

28. The apparatus of Embodiment 1, wherein the transfer ladle is configured to transfer the molten copper-based alloy into the one of more ingot molds configured to solidify the molten copper-based alloy into the copper-based ingot.

29. The apparatus of Embodiment 1, wherein the melting furnace is configured to transfer the molten copper-based alloy to the transfer ladle from a lower half of a volume of the molten copper-based alloy prior to transferring a remainder of the molten copper-based alloy.

30. The apparatus of Embodiment 1, wherein a first velocity element is connected to a lower half of the melting furnace.

31. The apparatus of any one of the above Embodiments, wherein the melting furnace further comprises a diffusive lining comprising an aluminum-silicate ceramic having a porous structure adapted for bubbling the inert gas through the molten copper-based alloy.

32. The apparatus of any one of Embodiments 1-30, wherein the melting furnace further comprises a diffusive lining substantially covering a bottom inner surface thereof and having a porous structure adapted for bubbling an inert gas into the molten copper-based alloy.

33. The apparatus of any one of Embodiments 1-30, wherein the melting furnace further comprises a diffusive lining having a porous structure, wherein the diffusive lining is formed on at least two different inner surfaces of the melting furnace such that the diffusive lining is adapted for bubbling an inert gas into the molten copper-based alloy from the at least two different inner surfaces.

34. The apparatus according to Embodiment 32 or 33, wherein the diffusive lining comprises an aluminum-silicate ceramic.

35. The apparatus according to Embodiment 31 or 33, wherein the diffusive lining substantially covers a bottom inner surface of the melting furnace.

36. The apparatus according to Embodiment 31 or 32, wherein the diffusive lining is formed on at least two different inner surfaces of the melting furnace such that the a diffusive lining is adapted for bubbling an inert gas into the molten copper-based alloy from the at least two different inner surfaces.

37. The apparatus according to any one of the above Embodiments, wherein the apparatus is further according to any one of Embodiments in Additional Examples III.

### Additional Examples II

1. A method of manufacturing a copper-based alloy, the method comprising:
providing in a melting furnace a plurality of feedstock pieces having a combined composition configured to form a molten copper-based alloy comprising at least 50 weight % copper;
flowing an inert gas through gaps between the feedstock pieces prior to heating;
heating the feedstock pieces while flowing the inert gas therethrough, thereby melting the feedstock pieces to form the molten copper-based alloy;
bubbling the inert gas through the molten copper-based alloy; and
transferring the molten copper-based alloy into a transfer ladle.

2. A method of manufacturing a copper-based alloy, the method comprising:
providing in a melting furnace a plurality of feedstock pieces having a combined composition configured to form a molten copper-based alloy comprising at least 50 weight % copper;
heating the feedstock pieces to form the molten copper-based alloy;
bubbling the inert gas through the molten copper-based alloy; and
transferring the molten copper-based alloy into a transfer ladle,
wherein one or more of heating the feedstock pieces, bubbling the inert gas and transferring the molten copper-based alloy is performed at least partly under an enclosed inert atmosphere configured to substantially exclude outside air from mixing with the enclosed inert atmosphere.

3. A method of manufacturing a copper-based alloy, the method comprising:
providing in a melting furnace a plurality of feedstock pieces having a combined composition configured to form a molten copper-based alloy comprising at least 50 weight % copper;
heating the feedstock pieces to form a molten copper-based alloy;
bubbling the inert gas through the molten copper-based alloy; and
transferring the molten copper-based alloy into a transfer ladle,
wherein transferring comprises limiting a velocity of the molten copper-based alloy that is transferred from the melting furnace to the transfer ladle to less than 100 in/sec.

4. The method of Embodiment 2 or 3, further comprising, prior to heating, flowing an inert gas through gaps between the feedstock pieces, and wherein heating comprises heating the feedstock pieces while flowing the inert gas therethrough.

5. The method of Embodiment 1 or 3, wherein one or more of heating the feedstock pieces, bubbling the inert gas and transferring the molten copper-based alloy is performed at least partly under an enclosed inert atmosphere configured to substantially exclude outside air from mixing with the enclosed inert atmosphere.

6. The method of Embodiment 1 or 2, wherein transferring comprises limiting a velocity of the molten copper-based alloy that is transferred from the melting furnace to the transfer ladle to less than 100 in/sec.

7. The method of any one of the above Embodiments, wherein the feedstock pieces comprise one or both of alloy pieces and elemental metal pieces.

8. The method of any one of the above Embodiments, wherein flowing the inert gas comprises flowing prior to initiating the heating of the feedstock pieces.

9. The method of any one of the above Embodiments, wherein flowing the inert gas comprises flowing at a sufficient flow rate such that the feedstock pieces are substantially under a flowing inert gas atmosphere prior to and during melting.

10. The method of any one of the above Embodiments, further comprising, prior to transferring, adding additional feedstock pieces while bubbling the inert gas through the molten copper-based alloy.

11. The method of any one of the above Embodiments, wherein bubbling the inert gas continues through transferring the molten copper-based alloy.

12. The method of any one of the above Embodiments, wherein bubbling the inert gas comprises bubbling at a sufficient flow rate such that the molten copper-based alloy is substantially under a flowing inert gas atmosphere during bubbling of the inert gas.

13. The method of any one of the above Embodiments, one or more of heating the feedstock pieces, bubbling the inert gas and transferring the molten copper-based alloy is performed under a common inert atmosphere.

14. The method of Embodiment 13, wherein the common inert atmosphere comprises an enclosed common inert atmosphere shared by the melting furnace and the transfer ladle.

15. The method of Embodiment 14, wherein the enclosed inert common atmosphere is enclosed by keeping an injector of the transfer ladle closed until immediately prior to ejecting the molten copper-based alloy from the transfer ladle to a mold.

16. The method of any one of the above Embodiments, wherein flowing and bubbling the inert gas comprise flowing and bubbling the inert gas consisting essentially of argon.

17. The method of any one of the above Embodiments, wherein flowing and bubbling the inert gas comprise flowing and bubbling the inert gas that is essentially hydrogen-free.

18. The method of any one of the above Embodiments, wherein flowing and bubbling the inert gas comprise diffusing through a diffuser disposed at a bottom of the melting furnace and having a plurality of pores adapted for bubbling the inert gas into the molten copper-based alloy in the form of inert gas bubbles.

19. The method of any one of the above Embodiments, wherein flowing and bubbling the inert gas comprise flowing at a flow rate of 2-6 liters per minute through a diffuser having a porosity greater than 20%.

20. The method of any one of the above Embodiments, wherein flowing and bubbling the inert gas comprise flowing at a flow rate of 2-6 liters per minute through a diffuser having a diameter greater than 5 cm and smaller than an inner diameter of the melting furnace.

21. The method of Embodiment 17, wherein flowing and bubbling the inert gas comprise flowing through the melting furnace having an inner diameter exceeding of 50 cm.

22. The method of any one of the above Embodiments, wherein heating comprises heating to a temperature greater than a temperature of the copper-based alloy by 100-400° C.

23. The method of Embodiment 22, further comprising, prior to transferring, cooling the molten copper-based alloy by 100-400° C.

24. The method of any one of the above Embodiments, wherein transferring comprises pouring the molten copper-based alloy disposed in a lower half of the melting furnace.

25. The method of any one of the above Embodiments, wherein transferring comprises limiting a velocity of the molten copper-based alloy that is transferred from the melting furnace to the transfer ladle using a sloped ramp.

26. The method of any one of the above Embodiments, after transferring the molten copper-based alloy to the transfer ladle by limiting a velocity thereof through a sloped ramp, ejecting the molten copper-based alloy from the transfer ladle by opening one or more injection valves.

27. The method of Embodiment 26, wherein the sloped ramp is under an inert atmosphere.

28. The method of Embodiment 24, transferring the molten copper-based alloy is performed under an enclosed common inert atmosphere shared by the melting furnace, the transfer ladle and the sloped ramp.

29. The method of any one of the above Embodiments, wherein after transferring the molten copper-based alloy to the transfer ladle by limiting a velocity thereof through a sloped ramp, ejecting the molten copper-based alloy from the transfer ladle by opening one or more injection valves one or more molds or a shot pit to solidify the molten copper-based alloy.

30. The method of any one of the above Embodiments, wherein after transferring the molten copper-based alloy to the transfer ladle by limiting a velocity thereof through a sloped ramp, ejecting the molten copper-based alloy from the transfer ladle to a second sloped ramp to further limit a velocity of the molten copper-based alloy, prior to disposing the molten copper-based alloy into one or more molds or a shot pit to solidify the molten copper-based alloy.

31. The method of any one of the above Embodiments, wherein bubbling the inert gas comprises bubbling using a diffusive lining formed on an inner surface of the melting furnace chamber, the diffusive lining comprising an aluminum-silicate ceramic material having a porous structure adapted for bubbling the inert gas through the molten copper-based alloy.

32. The method of any one of Embodiments 1-30, wherein bubbling the inert gas comprises bubbling using a diffusive lining formed in the melting furnace chamber, the diffusive lining substantially covering a bottom inner surface of the melting furnace and having a porous structure adapted for bubbling the inert gas into the molten copper-based alloy.

33. The method of any one of Embodiments 1-30, wherein bubbling the inert gas comprises bubbling using a diffusive lining having a porous structure, the diffusive lining formed on at least two different inner surfaces of the melting furnace such that the diffusive lining is adapted for bubbling the inert gas into the molten copper-based alloy from the at least two different inner surfaces.

34. The method according to Embodiment 32 or 33, wherein the diffusive lining comprises an aluminum-silicate ceramic.

35. The method according to Embodiment 31 or 33, wherein the diffusive lining substantially covers a bottom inner surface of the melting furnace.

36. The method according to Embodiment 31 or 32, wherein the diffusive lining is formed on at least two different inner surfaces of the melting furnace such that the a diffusive lining is adapted for bubbling an inert gas into the molten copper-based alloy from the at least two different inner surfaces.

37. The method according to any one of the above Embodiments, wherein the method is further according to any one of Embodiments in Additional Examples VI.

### Additional Examples III

1. An apparatus for manufacturing a copper-based alloy, the apparatus comprising:
a melting furnace configured to form a molten copper-based alloy comprising at least 50 weight % copper; and
a diffusive lining formed on an inner surface of the melting furnace and comprising an aluminum-silicate ceramic having a porous structure adapted for bubbling an inert gas through the molten copper-based alloy.

2. An apparatus for manufacturing a copper-based alloy, the apparatus comprising:
a melting furnace configured to form a molten copper-based alloy comprising at least 50 weight % copper; and
a diffusive lining substantially covering a bottom inner surface of the melting furnace and having a porous structure adapted for bubbling an inert gas into the molten copper-based alloy.

3. An apparatus for manufacturing a copper-based alloy, the apparatus comprising:
a melting furnace configured to form a molten copper-based alloy comprising at least 50 weight % copper; and
a diffusive lining having a porous structure in the melting furnace,
wherein the diffusive lining is formed on at least two different inner surfaces of the melting furnace such that the diffusive lining is adapted for bubbling an inert gas into the molten copper-based alloy from the at least two different inner surfaces.

4. The apparatus according to Embodiment 2 or 3, wherein the diffusive lining comprises an aluminum-silicate ceramic.

5. The apparatus according to Embodiment 1 or 3, wherein the diffusive lining substantially covers a bottom inner surface of the melting furnace.

6. The apparatus according to Embodiment 1 or 2, wherein the diffusive lining is formed on at least two different inner surfaces of the melting furnace such that the a diffusive lining is adapted for bubbling an inert gas into the molten copper-based alloy from the at least two different inner surfaces.

7. The apparatus according to any one of the above Embodiments, wherein the diffusive lining comprises alumina and silica.

8. The apparatus according to any one of the above Embodiments, wherein the diffusive lining comprises mullite.

9. The apparatus according to any one of the above Embodiments, wherein the diffusive lining comprises at least two layers comprising a sintered ceramic layer and an unsintered ceramic layer.

10. The apparatus according to Embodiment 9, wherein the sintered ceramic layer comprises mullite.

11. The apparatus according to Embodiment 9, wherein the unsintered ceramic layer comprises alumina and silica.

12. The apparatus according to Embodiment 10, wherein the sintered ceramic layer is configured to contact the molten copper-based alloy.

13. The apparatus according to Embodiment 9, wherein the unsintered ceramic layer comprises a compacted ceramic powder layer comprising alumina and silica.

14. The apparatus according to Embodiment 9, wherein the sintered ceramic layer is formed by partially sintering a compacted ceramic powder layer such that the sintered ceramic layer and the unsintered ceramic layer have substantially the same chemical composition while having different phases.

15. The apparatus according to Embodiment 9, wherein the unsintered ceramic layer comprises 60-70% alumina and 20-25% silica.

16. The apparatus according to Embodiment 9, wherein the unsintered ceramic layer comprises a compacted ceramic powder layer having an average particle size less than 63 mm or corresponding to number 4 on the f scale.

17. The apparatus according to any one of the above Embodiments, wherein the diffusive lining has a thickness of 3-6 inches.

18. The apparatus according to any one of the above Embodiments, wherein the diffusive lining covers an entire bottom inner surface of the melting furnace.

19. The apparatus according to any one of the above Embodiments, wherein the diffusive lining over a bottom inner surface of the melting furnace has a thickness of 4-6 inches.

20. The apparatus according to any one of the above Embodiments, wherein the diffusive lining covers at least an inner sidewall surface of the melting furnace.

21. The apparatus according to any one of the above Embodiments, wherein the diffusive lining over an inner sidewall of the melting furnace has a thickness of 3-4 inches.

22. The apparatus according to any one of the above Embodiments, wherein the diffusive lining is configured to contact the molten copper-based alloy.

23. The apparatus according to any one of the above Embodiments, wherein the inert gas consists essentially of argon.

24. The apparatus according to any one of the above Embodiments, wherein the inert gas is hydrogen-free.

25. The apparatus according to any one of the above Embodiments, further comprising a diffuser centrally disposed within the diffusive lining at a bottom inner surface of the melting furnace, the diffuser comprising a diffuser material disposed within a container connected to an inert gas source and having an upper surface disposed below an upper surface of the diffusive lining covering the bottom inner surface.

26. The apparatus according to Embodiment 25, wherein the diffuser overlaps a portion of the diffusive lining over the bottom inner surface of the melting furnace.

27. The apparatus according to Embodiment 26, wherein the diffuser contacts the diffusive lining and comprises the same material as the diffusive lining.

28. The apparatus according to any one of Embodiments 25-27, wherein one or both of the diffuser and the diffusive lining have a porosity greater than 20%.

29. The apparatus according to any one of Embodiments 25-28, wherein the diffuser has a lateral dimension less than 50% of a lateral dimension of the diffusive lining covering a bottom inner surface of the melting furnace.

30. The apparatus according to any one of Embodiments 25-29, wherein the diffuser has a diameter greater than 5 cm and smaller than a diameter of the diffusive lining covering a bottom inner surface of the melting furnace.

31. The apparatus according to any one of Embodiments 25-30, wherein the diffusive lining covering a bottom inner surface of the melting furnace has a diameter exceeding 50 cm.

32. The apparatus according to any one of Embodiments 25-31, wherein the melting furnace is configured to melt the copper-based alloy under an enclosed chamber configuration in which an atmosphere above the molten copper-based alloy is isolated from an outside atmosphere.

33. The apparatus according to any one of Embodiments 25-31, wherein the melting furnace is configured to melt the copper-based alloy under an open chamber configuration in which an atmosphere above the molten copper-based alloy is exposed to an outside atmosphere.

34. The apparatus according to Embodiment 32, wherein the apparatus is configured to diffusedly flow the inert gas at a flow rate of 2-6 liters per minute under the enclosed chamber configuration.

35. The apparatus according to Embodiment 33, wherein the apparatus is configured to diffusedly flow the inert gas at a flow rate of 4-13 liters per minute under the open chamber configuration.

36. The apparatus according to any one of the above Embodiments, wherein the melting furnace is an induction furnace comprising an induction coil surrounding the melting furnace and configured to melt the copper-based alloy.

37. The apparatus according to Embodiment 36, wherein the induction furnace is configured to operate at a frequency less than 1000 Hz.

38. The apparatus according to Embodiments 36 and 37, wherein a topmost winding of the induction coil is disposed at a vertical position below a fill line of the molten copper-based alloy.

39. The apparatus according to any one of the above Embodiments, further comprising an inert gas source connected to the diffusive lining for supplying the inert gas to the melting furnace.

40. The apparatus according to any one of the above Embodiments, further comprising a diffuser smaller than and embedded within the diffusive lining covering a bottom inner surface of the melting furnace.

41. The apparatus according to Embodiment 40, wherein the diffuser and the diffusive lining comprise the same diffuser material.

42. The apparatus according to Embodiment 40, wherein the diffuser comprises a diffuser material disposed within a container connected to an inert gas source and having an upper surface disposed below an upper surface of the diffusive lining covering a bottom inner surface of the melting furnace.

43. The apparatus according to any one of the above Embodiments, wherein the apparatus is further according to any one of Embodiments in Additional Examples I.

### Additional Examples IV

1. A method of manufacturing an apparatus for fabricating a copper-based alloy, the method comprising:
providing a melting furnace chamber configured to form a molten copper-based alloy comprising at least 50 weight % copper; and
forming a diffusive lining on an inner surface of the melting furnace chamber, the diffusive lining comprising an aluminum-silicate ceramic material having a porous structure adapted for bubbling an inert gas through the molten copper-based alloy.

2. A method of manufacturing an apparatus for fabricating a copper-based alloy, the method comprising:
providing a melting furnace chamber configured to form a molten copper-based alloy comprising at least 50 weight % copper; and
forming a diffusive lining substantially covering a bottom inner surface of the melting furnace and having a porous structure adapted for bubbling an inert gas into the molten copper-based alloy.

3. A method of manufacturing an apparatus for fabricating a copper-based alloy, the method comprising:
providing a melting furnace chamber configured to form a molten copper-based alloy comprising at least 50 weight % copper; and
forming a diffusive lining having a porous structure on at least two different inner surfaces of the melting furnace such that the diffusive lining is adapted for bubbling an inert gas into the molten copper-based alloy from the at least two different inner surfaces.

4. The method according to Embodiment 2 or 3, wherein the diffusive lining comprises an aluminum-silicate ceramic.

5. The method according to Embodiment 1 or 3, wherein forming the diffusive lining comprises substantially covering a bottom inner surface of the melting furnace.

6. The method according to Embodiment 1 or 2, wherein forming the diffusive lining comprises forming on at least two different inner surfaces of the melting furnace such that the diffusive lining is adapted for bubbling an inert gas into the molten copper-based alloy from the at least two different inner surfaces.

7. The method according to any one of the above Embodiments, wherein the diffusive lining comprises alumina and silica.

8. The method according to any one of the above Embodiments, wherein the diffusive lining comprises mullite.

9. The method according to any one of the above Embodiments, wherein forming the diffusive lining comprises forming at least a sintered ceramic layer and an unsintered ceramic layer.

10. The method according to Embodiment 9, wherein forming the sintered ceramic layer comprises sintering a portion of a compacted ceramic powder layer to form mullite.

11. The method according to Embodiment 9, wherein forming the unsintered ceramic layer comprises forming a compacted ceramic powder layer comprising alumina and silica.

12. The method according to Embodiment 10, wherein forming the sintered ceramic layer comprises configuring to contact the molten copper-based alloy.

13. The method according to Embodiment 9, wherein forming the sintered layer and the unsintered layer comprises forming from a same compacted ceramic powder layer comprising alumina and silica.

14. The method according to Embodiment 9, wherein forming the sintered ceramic layer comprises partially sintering a compacted ceramic powder layer such that the sintered layer and the unsintered ceramic layer have substantially the same chemical composition while having different phases.

15. The method according to Embodiment 9, wherein the unsintered ceramic layer comprises 60-70% alumina and 20-25% silica.

16. The method according to Embodiment 9, wherein the unsintered ceramic layer comprises a compacted ceramic powder layer having an average particle size less than 63 mm or corresponding to number 4 on the f scale.

17. The method according to any one of the above Embodiments, wherein the diffusive lining has a thickness of 3-6 inches.

18. The method according to any one of the above Embodiments, wherein forming the diffusive lining comprises covering an entire bottom inner surface of the melting furnace.

19. The method according to any one of the above Embodiments, wherein the diffusive lining over a bottom inner surface of the melting furnace has a thickness of 4-6 inches.

20. The method according to any one of the above Embodiments, wherein forming the diffusive lining comprises covering at least a sidewall of the melting furnace.

21. The method according to any one of the above Embodiments, wherein the diffusive lining over a sidewall of the melting furnace has a thickness of 3-4 inches.

22. The method according to any one of the above Embodiments, wherein forming the diffusive lining comprises configuring to contact the molten copper-based alloy.

23. The method according to any one of the above Embodiments, wherein the inert gas consists essentially of argon.

24. The method according to any one of the above Embodiments, wherein the inert gas is hydrogen-free.

25. The method according to any one of the above Embodiments, further comprising disposing a diffuser centrally below the diffusive lining at a bottom of the melting furnace.

26. The method according to Embodiment 25, wherein disposing the diffuser comprises positioning to overlap a portion of the diffusive lining at the bottom of the melting furnace.

27. The method according to Embodiment 26, wherein disposing the diffuser comprises contacting the diffusive lining with the diffuser comprising the same material as the diffusive lining.

28. The method according to any one of Embodiments 25-27, wherein one or both of the diffuser and the diffusive lining have a porosity greater than 20%.

29. The method according to any one of Embodiments 25-28, wherein the diffuser has a lateral dimension less than 50% of a lateral dimension of the diffusive lining covering bottom inner surface of the melting furnace.

30. The method according to any one of Embodiments 25-29, wherein the diffuser has a diameter greater than 5 cm and smaller than the diffusive lining covering a bottom inner surface of the melting furnace.

31. The method according to any one of Embodiments 25-30, wherein the diffusive lining covering a bottom inner surface of the melting furnace has a diameter exceeding 50 cm.

32. The method according to any one of Embodiments 25-31, further comprising configuring the melting furnace to melt the copper-based alloy under an enclosed chamber configuration in which an atmosphere above the molten copper-based alloy is isolated from an outside atmosphere.

33. The method according to any one of Embodiments 25-31, further comprising configuring the melting furnace to melt the copper-based alloy under an open chamber configuration in which an atmosphere above the molten copper-based alloy is exposed to an outside atmosphere.

34. The method according to Embodiment 32, further comprising configuring the apparatus to diffusedly flow the inert gas at a flow rate of 2-6 liters per minute under an enclosed chamber configuration.

35. The method according to Embodiment 33, further comprising configuring the apparatus to diffusedly flow the inert gas at a flow rate of 4-13 liters per minute under an open chamber configuration.

36. The method according to any one of the above Embodiments, wherein the melting furnace is an induction furnace comprising a surrounding induction coil configured to melt the copper-based alloy.

37. The method according to Embodiment 36, wherein the induction furnace is configured to operate at a frequency less than 1000 Hz.

38. The method according to Embodiments 36 and 37, wherein a topmost winding of the induction coil is disposed half of a height of the molten copper-based alloy.

39. The method according to any one of the above Embodiments, wherein the method is further according to any one of Embodiments in Additional Examples V.

### Additional Examples V

1. A method of manufacturing an apparatus for fabricating an alloy, the method comprising:
providing a melting furnace chamber;
disposing a compacted ceramic powder layer on an inner surface of the melting furnace chamber, the compacted ceramic powder layer comprising a mixture of silica and alumina; and
sintering the compacted ceramic powder layer in the melting furnace to form a diffusive lining on the inner surface, the diffusive lining comprising an aluminum-silicate ceramic material having a porous structure adapted for diffusing gas therethrough.

2. A method of manufacturing an apparatus for fabricating an alloy, the method comprising:
providing a melting furnace chamber;
disposing a compacted ceramic powder layer on an inner surface of the melting furnace chamber; and
selectively sintering a surface portion of the compacted ceramic powder layer, thereby forming a diffusive lining on the inner surface comprising a sintered ceramic layer on an unsintered ceramic layer.

3. A method of manufacturing an apparatus for fabricating an alloy, the method comprising:
providing a melting furnace chamber;
disposing a compacted ceramic powder layer on an inner surface of the melting furnace chamber; and
sintering the compacted ceramic powder layer using heat from a heated material disposed in the melting furnace chamber, thereby forming a diffusive lining on the inner surface.

4. The method according to Embodiment 2 or 3, wherein sintering the compacted ceramic powder layer comprises sintering in the melting furnace to form the diffusive lining, the diffusive lining comprising an aluminum-silicate ceramic material having a porous structure adapted for diffusing gas therethrough.

5. The method according to Embodiment 1 or 3, wherein sintering comprises selectively sintering a surface portion of the compacted ceramic powder layer, thereby forming a diffusive lining on the inner surface comprising a sintered ceramic layer on an unsintered ceramic layer.

6. The method according to Embodiment 1 or 2, wherein sintering comprises using heat from a heated material disposed in the melting furnace chamber, thereby forming a diffusive lining on the inner surface.

7. The method according to any one of the above Embodiments, wherein disposing the compacted ceramic powder layer comprises covering a bottom surface of the melting furnace chamber with a bottom compacted ceramic powder layer.

8. The method according to any one of the above Embodiments, wherein disposing the compacted ceramic powder layer comprises covering a sidewall of the melting furnace chamber with a sidewall compacted ceramic powder layer.

9. The method according to any one of the above Embodiments, wherein sintering comprises using heat from a material disposed in the melting furnace chamber and heated using power applied to the melting furnace chamber.

10. The method according to Embodiment 9, wherein power applied to the melting furnace chamber comprises inductive power delivered through a coil surrounding the melting furnace chamber.

11. The method according to Embodiment 9, wherein sintering comprises using heat from an iron-containing material that is inductively heated by the power applied to the melting furnace chamber.

12. The method according to Embodiment 9, wherein sintering comprises using heat from an iron-containing material that is molten using power applied to the melting furnace chamber.

13. The method according to Embodiment 9, wherein the material is heated to a temperature sufficient to form mullite from silica and alumina.

14. The method according to any one of the above Embodiments, wherein the diffusive lining comprises alumina and silica.

15. The method according to any one of the above Embodiments, wherein the diffusive lining comprises mullite.

16. The method according to any one of the above Embodiments, wherein forming the diffusive lining comprises forming at least a sintered ceramic layer and an unsintered ceramic layer.

17. The method according to Embodiment 16, wherein forming the sintered ceramic layer is comprises sintering a portion of the compacted ceramic powder layer to form mullite.

18. The method according to Embodiment 17, wherein the unsintered ceramic layer comprises a remaining portion of the compacted ceramic powder layer that does not form mullite.

19. The method according to Embodiment 16, wherein forming the sintered ceramic layer comprises configuring to contact the molten copper-based alloy.

20. The method according to Embodiment 16, wherein forming the sintered layer and the unsintered layer comprises forming from the same compacted ceramic powder layer comprising alumina and silica.

21. The method according to Embodiment 16, wherein forming the sintered ceramic layer comprises partially sintering a compacted ceramic powder layer such that the sintered layer and the unsintered ceramic layer have substantially the same chemical composition while having different phases.

22. The method according to any one of the above Embodiments, wherein the compacted ceramic powder layer comprises 60-70% alumina and 20-25% silica.

23. The method according to any one of the above Embodiments, wherein the compacted ceramic powder layer comprises particles having an average particle size less than 63 mm or corresponding to number 4 on the f scale.

24. The method according to any one of the above Embodiments, wherein the compacted ceramic powder layer has a thickness of 3-6 inches.

25. The method according to any one of the above Embodiments, wherein disposing the compacted ceramic powder layer comprises covering an entire bottom inner surface of the melting furnace.

26. The method according to any one of the above Embodiments, wherein the compacted ceramic powder layer over a bottom inner surface of the melting furnace has a thickness of 4-6 inches.

27. The method according to any one of the above Embodiments, wherein disposing the compacted ceramic powder layer comprises covering at least an inner sidewall surface of the melting furnace.

28. The method according to any one of the above Embodiments, wherein the compacted ceramic powder layer over an inner sidewall surface of the melting furnace has a thickness of 3-4 inches.

29. The method according to any one of the above Embodiments, wherein forming the diffusive lining comprises configuring to contact the molten copper-based alloy.

30. The method according to any one of the above Embodiments, further comprising disposing a diffuser centrally below the diffusive lining at a bottom of the melting furnace.

31. The method according to Embodiment 30, wherein disposing the diffuser comprises positioning to overlap a portion of the diffusive lining at the bottom of the melting furnace.

32. The method according to Embodiment 31, wherein disposing the diffuser comprises contacting the diffusive lining with the diffuser comprising the same material as the diffusive lining.

33. The method according to any one of Embodiments 30-32, wherein one or both of the diffuser and the diffusive lining have a porosity greater than 20%.

34. The method according to any one of Embodiments 30-33, wherein the diffuser has a lateral dimension less than 50% of a lateral dimension of the diffusive lining covering bottom inner surface of the melting furnace.

35. The method according to any one of Embodiments 30-34, wherein the diffuser has a diameter greater than 5 cm and smaller than the diffusive lining covering a bottom inner surface of the melting furnace.

36. The method according to any one of Embodiments 30-35, wherein the diffusive lining covering a bottom inner surface of the melting furnace has a diameter exceeding 50 cm.

37. The method according to any one of Embodiments 30-36, further comprising configuring the melting furnace to melt the copper-based alloy under an enclosed chamber configuration in which an atmosphere above the molten copper-based alloy is isolated from an outside atmosphere.

38. The method according to any one of Embodiments 30-37, further comprising configuring the melting furnace to melt the copper-based alloy under an open chamber configuration in which an atmosphere above the molten copper-based alloy is exposed to an outside atmosphere.

39. The method according to Embodiment 38, further comprising configuring the apparatus to diffusedly flow the inert gas at a flow rate of 2-6 liters per minute under an enclosed chamber configuration.

40. The method according to Embodiment 38, further comprising configuring the apparatus to diffusedly flow the inert gas at a flow rate of 4-13 liters per minute under an open chamber configuration.

41. The method according to any one of the above Embodiments, wherein the melting furnace is an induction furnace comprising a surrounding induction coil configured to melt the copper-based alloy.

42. The method according to Embodiment 41, wherein the induction furnace is configured to operate at a frequency less than 1000 Hz.

43. The method according to Embodiments 41 and 42, wherein a topmost winding of the induction coil is disposed half of a height of the molten copper-based alloy.

44. The method according to any one of the above Embodiments, further comprising connecting an inert gas supply to the diffusive lining.

45. The method according to any one of the above Embodiments, wherein the method is further according to any one of Embodiments in Additional Examples IV.

### Additional Examples VI

1. A method of manufacturing a copper-based alloy, the method comprising:
providing in a melting furnace a feedstock having a composition configured to form a molten copper-based alloy comprising at least 50 weight % copper;
heating the feedstock to melt the feedstock to form the molten copper-based alloy; and
bubbling an inert gas into the molten copper-based alloy using a diffusive lining formed on an inner surface of the melting furnace chamber, the diffusive lining comprising an aluminum-silicate ceramic material having a porous structure adapted for bubbling the inert gas through the molten copper-based alloy.

2. A method of manufacturing a copper-based alloy, the method comprising:
providing in a melting furnace a feedstock having a composition configured to form a molten copper-based alloy comprising at least 50 weight % copper;
heating the feedstock to melt the feedstock to form the molten copper-based alloy; and
bubbling an inert gas through the molten copper-based alloy using a diffusive lining formed in the melting furnace chamber, the diffusive lining substantially covering a bottom inner surface of the melting furnace and having a porous structure adapted for bubbling the inert gas into the molten copper-based alloy.

3. A method of manufacturing a copper-based alloy, the method comprising:
providing in a melting furnace a feedstock having a composition configured to form a molten copper-based alloy comprising at least 50 weight % copper;
heating the feedstock to melt the feedstock to form the molten copper-based alloy; and
bubbling an inert gas through the molten copper-based alloy using a diffusive lining having a porous structure, the diffusive lining formed on at least two different inner surfaces of the melting furnace such that the diffusive lining is adapted for bubbling the inert gas into the molten copper-based alloy from the at least two different inner surfaces.

4. The method according to Embodiment 2 or 3, wherein the diffusive lining comprises an aluminum-silicate ceramic.

5. The method according to Embodiment 1 or 3, wherein the diffusive lining substantially covers a bottom inner surface of the melting furnace.

6. The method according to Embodiment 1 or 2, wherein the diffusive lining is formed on at least two different inner surfaces of the melting furnace such that the a diffusive lining is adapted for bubbling an inert gas into the molten copper-based alloy from the at least two different inner surfaces.

7. The method according to any one of the above Embodiments, wherein the diffusive lining comprises alumina and silica.

8. The method according to any one of the above Embodiments, wherein the diffusive lining comprises mullite.

9. The method according to any one of the above Embodiments, wherein the diffusive lining comprises at least two layers comprising a sintered ceramic layer and an unsintered ceramic layer.

10. The method according to Embodiment 9, wherein the sintered ceramic layer comprises mullite.

11. The method according to Embodiment 9, wherein the unsintered ceramic layer comprises alumina and silica.

12. The method according to Embodiment 10, wherein the sintered ceramic layer contacts the molten copper-based alloy.

13. The method according to Embodiment 9, wherein the unsintered layer comprises compacted ceramic powder layer comprising alumina and silica.

14. The method according to Embodiment 9, wherein the sintered ceramic layer is formed by partially sintering a compacted ceramic powder layer such that the sintered layer and the unsintered ceramic layer have substantially the same chemical composition while having different phases.

15. The method according to Embodiment 9, wherein the unsintered ceramic layer comprises 60-70% alumina and 20-25% silica.

16. The method according to Embodiment 9, wherein the unsintered ceramic layer comprises a compacted ceramic powder having an average particle size less than 63 mm or corresponding to number 4 on the f scale.

17. The method according to any one of the above Embodiments, wherein the diffusive lining has a thickness of 3-6 inches.

18. The method according to any one of the above Embodiments, wherein the diffusive lining covers an entire bottom inner surface of the melting furnace.

19. The method according to any one of the above Embodiments, wherein the diffusive lining over a bottom inner surface of the melting furnace has a thickness of 4-6 inches.

20. The method according to any one of the above Embodiments, wherein the diffusive lining covers at least a sidewall of the melting furnace.

21. The method according to any one of the above Embodiments, wherein the diffusive lining over a sidewall of the melting furnace has a thickness of 3-4 inches.

22. The method according to any one of the above Embodiments, wherein the diffusive lining is configured to contact the molten copper-based alloy.

23. The method according to any one of the above Embodiments, wherein the inert gas consists essentially of argon.

24. The method according to any one of the above Embodiments, wherein the inert gas is hydrogen-free.

25. The method according to any one of the above Embodiments, further comprising a diffuser centrally disposed below the diffusive lining at a bottom of the melting furnace.

26. The method according to Embodiment 25, wherein the diffuser overlaps a portion of the diffusive lining at the bottom of the melting furnace.

27. The method according to Embodiment 26, wherein the diffuser contacts the diffusive lining and comprises the same material as the diffusive lining.

28. The method according to any one of Embodiments 25-27, wherein one or both of the diffuser and the diffusive lining have a porosity greater than 20%.

29. The method according to any one of Embodiments 25-28, wherein the diffuser has a lateral dimension less than 50% of a lateral dimension of the diffusive lining covering a bottom inner surface of the melting furnace.

30. The method according to any one of Embodiments 25-29, wherein the diffuser has a diameter greater than 5 cm and smaller than the diffusive lining covering a bottom inner surface of the melting furnace.

31. The method according to any one of Embodiments 25-30, wherein the diffusive lining covering a bottom inner surface of the melting furnace has a diameter exceeding 50 cm.

32. The method according to any one of Embodiments 25-31, wherein melting the feedstock comprises melting under an enclosed chamber configuration in which an atmosphere above the molten copper-based alloy is isolated from an outside atmosphere.

33. The method according to any one of Embodiments 25-31, wherein melting the feedstock comprises melting under an open chamber configuration in which an atmosphere above the molten copper-based alloy is exposed to an outside atmosphere.

34. The method according to Embodiment 32, wherein bubbling the inert gas comprises diffusedly flow the inert gas through the diffusive lining at a flow rate of 2-6 liters per minute under an enclosed chamber configuration.

35. The method according to Embodiment 33, wherein bubbling the inert gas comprises diffusedly flow the inert gas through the diffusive lining at a flow rate of 4-13 liters per minute under an open chamber configuration.

36. The method according to any one of the above Embodiments, wherein melting comprises inductively heating the feedstock by supplying power to an induction coil surrounding the melting furnace.

37. The method according to any one of the above Embodiments,
wherein providing the feedstock comprises providing a plurality of feedstock pieces having a combined composition configured to form the molten copper-based alloy and flowing the inert gas through gaps between the feedstock pieces prior to heating,
wherein heating comprises heating the feedstock pieces while flowing the inert gas therethrough, thereby melting the feedstock pieces to form the molten copper-based alloy, and
wherein the method further comprises, after bubbling the inert gas through the molten copper-based alloy, transferring the molten copper-based alloy into a transfer ladle.

38. The method according to any one of Embodiments 1-36,
wherein providing the feedstock comprises providing a plurality of feedstock pieces having a combined composition configured to form the molten copper-based alloy and flowing the inert gas through gaps between the feedstock pieces prior to heating,
wherein the method further comprises, after bubbling the inert gas through the molten copper-based alloy, transferring the molten copper-based alloy into a transfer ladle, and
wherein one or more of heating the feedstock pieces, bubbling the inert gas and transferring the molten copper-based alloy is performed at least partly under an enclosed inert atmosphere configured to substantially exclude outside air from mixing with the enclosed inert atmosphere.

39. The method according to any one of Embodiments 1-36,
wherein providing the feedstock comprises providing a plurality of feedstock pieces having a combined composition configured to form the molten copper-based alloy,
wherein the method further comprises, after bubbling the inert gas through the molten copper-based alloy, transferring the molten copper-based alloy into a transfer ladle, and
wherein transferring comprises limiting a velocity of the molten copper-based alloy that is transferred from the melting furnace to the transfer ladle to less than 100 in/sec.

40. The method according to Embodiments 38 or 39, further comprising, prior to heating, flowing an inert gas through gaps between the feedstock pieces, and wherein heating comprises heating the feedstock pieces while flowing the inert gas therethrough.

41. The method according to Embodiments 37 or 39, wherein one or more of heating the feedstock pieces, bubbling the inert gas and transferring the molten copper-based alloy is performed at least partly under an enclosed inert atmosphere configured to substantially exclude outside air from mixing with the enclosed inert atmosphere.

42. The method according to Embodiments 37 or 38, wherein transferring comprises limiting a velocity of the molten copper-based alloy that is transferred from the melting furnace to the transfer ladle to less than 100 in/sec.

43. The method according to any one of Embodiments 37-42, wherein the method is further according to any one of the methods according to any one of Embodiments 7-30 in Additional Examples—II.

44. The method according to any one of the above Embodiments, wherein the melting furnace is an induction furnace comprising a surrounding induction coil configured to melt the copper-based alloy.

45. The method according to Embodiment 44, wherein the induction furnace is configured to operate at a frequency less than 1000 Hz.

46. The method according to Embodiments 44 and 45, wherein a topmost winding of the induction coil is disposed half of a height of the molten copper-based alloy.

47. The method according to any one of the above Embodiments, wherein the method is further according to any one of Embodiments in Additional Examples II.

### Additional Examples VII

1. An apparatus for manufacturing a copper-based alloy, the apparatus comprising:
a melting furnace configured to form a molten copper-based alloy comprising at least 50 weight % copper, wherein the melting furnace is configured to rotate around a central axis, and
one or more diffuser blocks comprising a porous diffusing material adapted for bubbling an inert gas through the molten copper-based alloy.

2. An apparatus for manufacturing a copper-based alloy, the apparatus comprising:
a melting furnace configured to form a molten copper-based alloy comprising at least 50 weight % copper, wherein the melting furnace is configured to rotate around a central axis extending in a lengthwise direction of the melting furnace; and
one or more diffuser blocks adapted for bubbling an inert gas through the molten copper-based alloy in a direction crossing the central axis.

3. An apparatus for manufacturing a copper-based alloy, the apparatus comprising:
a melting furnace configured to form a molten copper-based alloy comprising at least 50 weight % copper,
a flame injector configured to direct a stream of flame along a central axis of the melting furnace that serves as a heat source for forming the molten copper-based alloy, and
one or more diffuser blocks comprising a porous structure adapted for bubbling an inert gas through the molten copper-based alloy.

4. The apparatus according to Embodiment 1, wherein the one or more diffuser blocks further comprise a refractory diffuser lining around the porous diffusing material.

5. The apparatus according to Embodiment 4, wherein the refractory diffuser lining comprises mullite.

6. The apparatus according to Embodiment 4, wherein the refractory diffuser lining comprises alumina and silica.

7. The apparatus according to Embodiment 4, wherein the refractory diffuser lining has a thermal expansion coefficient is within 10% of that of a lining of the melting furnace.

8. The apparatus according to Embodiment 4, wherein the refractory diffuser lining and a lining of the melting furnace comprises a same material.

9. The apparatus according to Embodiment 1, wherein at least one of the one or more diffuser blocks comprises a trapezoidal or conical cross-sectional profile.

10. The apparatus according to Embodiment 1, wherein at least one of the one or more diffuser blocks further comprises an outlet end configured to contact the molten copper-based alloy and an inlet end opposite to the outlet end, wherein the outlet end is narrower than the inlet end.

11. The apparatus according to Embodiment 1, wherein the one or more diffuser blocks are connected to a chamber of the melting furnace using through-holes in the melting furnace.

12. The apparatus according to Embodiment 1, wherein the one or more diffuser blocks comprise two or more diffuser blocks.

13. The apparatus according to Embodiment 12, wherein the two or more diffuser blocks are arranged in a line along a direction of elongation of the melting furnace.

14. The apparatus according to Embodiment 12, wherein the two or more diffuser blocks are arranged in a line along a direction of the central axis.

15. The apparatus according to Embodiment 12, wherein two of the two or more diffuser blocks are spaced apart in a first direction by a first distance that is at least 30% of a length of the furnace chamber measured in the first direction.

16. The apparatus according to Embodiment 12, wherein the two or more diffuser blocks comprise four diffuser blocks.

17. The apparatus according to Embodiment 1, wherein the one or more diffuser blocks are configured to contact a bottom surface of the molten copper-based alloy.

18. The apparatus according to Embodiment 1, wherein the one or more diffuser blocks are configured to bubble an inert gas through the molten copper-based alloy while the melting furnace is rotating.

19. The apparatus according to Embodiment 1, wherein a location at which the one or more diffuser blocks bubbles an inert gas into the molten copper-based alloy moves as the melting furnace rotates.

20. The apparatus according to Embodiment 1, wherein the one or more diffuser blocks are configured to bubble the inert gas into the molten copper-based alloy from at least two locations as the melting furnace rotates.

21. The apparatus according to Embodiment 2, wherein the one or more diffuser blocks comprises a porous diffusing material adapted for bubbling an inert gas through the molten copper-based alloy.

22. The apparatus according to Embodiment 2, wherein the one or more diffuser blocks comprises a porous diffusing material structure for bubbling an inert gas through the molten copper-based alloy.

23. The apparatus according to Embodiment 22, wherein the one or more diffuser blocks are disposed in the side wall of the melting furnace.

24. The apparatus according to Embodiment 2, wherein the melting furnace further comprises a loading portal having a loading portal door.

25. The apparatus according to Embodiment 24, wherein the loading portal is disposed at least 90 degrees apart from one of the one or more diffuser blocks in an azimuthal direction with respect to the central axis.

26. The apparatus according to Embodiment 24, wherein the loading portal is disposed at a side of the melting furnace opposite to the one or more diffuser blocks.

27. The apparatus according to Embodiment 24, wherein the melting furnace further comprises a pouring portal different from the loading portal.

28. The apparatus according to Embodiment 3, wherein the melting furnace further comprises an exhaust portal connected to the chamber of the melting furnace configured to vent an exhaust of the ignited fuel.

29. The apparatus according to Embodiment 28, wherein the exhaust portal is disposed on the central axis.

30. The apparatus according to Embodiment 28, wherein an exhaust duct, configured to further guide the exhaust vented from the chamber, is removably disposed against the exhaust portal.

31. The apparatus according to Embodiment 28, wherein the exhaust portal is connected to a drop-bottom cavity configured to reduce a speed of the exhaust, the drop bottom cavity having a width larger than that of the exhaust outlet.

32. The apparatus according to Embodiment 3, wherein the flame injector is disposed on the central axis.

33. The apparatus according to Embodiment 3, wherein the flame injector is configured to inject a fuel at a high pressure or speed such that the flame extends over a substantial length of the melting furnace.

34. The apparatus according to any of the above Embodiments, further comprising an inert gas source connected to the one or more diffuser blocks for supplying the inert gas.

35. The apparatus according to any of the above Embodiments, wherein an atmosphere enclosed by the melting furnace is configured to be substantially inert.

36. The apparatus according to any of the above Embodiments, wherein an atmosphere in the melting furnace is substantially inert.

37. The apparatus according to any of the above Embodiments, wherein an atmosphere above the molten copper-based alloy is configured to be substantially inert.

38. The apparatus according to any of the above Embodiments, wherein a layer of atmosphere in the melting furnace directly above and in contact with the molten copper-based alloy is configured to be substantially inert.

39. The apparatus according to any of the above Embodiments, wherein the melting furnace is configured to melt the copper-based alloy while an outside atmosphere is excluded from an atmosphere above the molten copper-based alloy.

40. The apparatus according to any of the above Embodiments, wherein the melting furnace is configured to melt the copper-based alloy under an enclosed chamber configuration in which an atmosphere above the molten copper-based alloy is isolated from an outside atmosphere.

41. The apparatus according to any of the above Embodiments, wherein the apparatus is configured to diffusedly flow the inert gas at a flow rate of 2-6 liters per minute under the enclosed chamber configuration.

42. The apparatus according to any of the above Embodiments, wherein the melting furnace is configured to melt the copper-based alloy under an open chamber configuration in which an atmosphere above the molten copper-based alloy is enclosed from but connected to an outside atmosphere.

43. The apparatus according to any of the above Embodiments, wherein the apparatus is configured to diffusedly flow the inert gas at a flow rate of 4-13 liters per minute under the open chamber configuration.

44. The apparatus according to any of the above Embodiments, wherein the inert gas consists essentially of a noble gas.

45. The apparatus according to any of the above Embodiments, wherein the inert gas consists essentially of argon.

46. The apparatus according to any of the above Embodiments, wherein the inert gas is essentially free of one or both of hydrogen and moisture.

47. The apparatus according to any of the above Embodiments, wherein the porous structure or the porous diffusing material comprises alumina, silica, or an aluminum-silicate ceramic.

48. The apparatus according to any of the above Embodiments, wherein the porous structure or the porous diffusing material comprises more than 60% alumina by weight.

49. The apparatus according to any of the above Embodiments, wherein the porous structure or the porous diffusing material comprises less than 50% silica by weight.

50. The apparatus according to any of the above Embodiments, wherein the porous structure or the porous diffusing material comprises Cr₂O₃.

51. The apparatus according to any of the above Embodiments, wherein the porous structure or the porous diffusing material comprises less than 10% Cr₂O₃ by weight.

52. The apparatus according to any of the above Embodiments, wherein a porosity of the porous structure or the porous diffusing material is 15-40% by volume.

53. The apparatus according to any of the above Embodiments, wherein the porous structure or the porous diffusing material is configured to directly contact the molten copper-based alloy with an effective area greater than 25 cm².

54. The apparatus according to any of the above Embodiments, wherein the porous structure or the porous diffusing material is disposed within a gas-tight container connected to an inert gas source.

55. The apparatus according to any of the above Embodiments, wherein the one or more diffuser blocks are configured to bubble the inert gas through a bottom surface of the molten copper-based alloy by directly contacting the bottom surface of the molten copper-based alloy.

56. The apparatus according to any of the above Embodiments, wherein the one or more diffuser blocks are configured to flow the inert gas diffused therethrough directly into an atmosphere above the molten copper-based alloy.

57. The apparatus according to any of the above Embodiments, wherein the one or more diffuser blocks further comprise a refractory diffuser lining around the porous structure or the porous diffusing material.

58. The apparatus according to any of the above Embodiments, wherein the refractory diffuser lining and a lining of the melting furnace comprises a same material.

59. The apparatus according to any of the above Embodiments, wherein the one or more diffuser blocks comprise two or more diffuser blocks.

60. The apparatus according to any of the above Embodiments, wherein the two or more diffuser blocks are spaced apart along a direction of elongation of the melting furnace.

61. The apparatus according to any of the above Embodiments, wherein the two or more diffuser blocks are spaced apart along a direction of the central axis.

62. The apparatus according to any of the above Embodiments, wherein the melting furnace further comprises a loading portal having a loading portal door.

63. The apparatus according to any of the above Embodiments, wherein the central axis extends in a horizontal direction.

64. The apparatus of any of the above Embodiments, wherein the melting furnace comprises an outer wall including a first end, a second end opposite to the first end, and a side wall connecting the first end and the second end.

65. The apparatus of any of the above Embodiments, wherein the central axis intersects the first end and the second end.

66. The apparatus of any of the above Embodiments, wherein the central axis does not intersect the side wall.

67. The apparatus of any of the above Embodiments, wherein the melting furnace has a cylindrical or a barrel shape having the central axis extending in a lengthwise direction of the cylindrical or the barrel shape.

68. The apparatus according to any of the above Embodiments, wherein the central axis extends substantially parallel to a ground level.

69. The apparatus according to any of the above Embodiments, wherein the melting furnace is configured to rotate at least 45 degrees around the central axis.

70. The apparatus according to any of the above Embodiments, wherein the melting furnace is configured to rotate at least 90 degrees around the central axis.

71. The apparatus according to any of the above Embodiments, wherein an atmosphere enclosed by the melting furnace is substantially inert.

72. The apparatus according to any of the above Embodiments, wherein the melting furnace can rotate to a first configuration, wherein at least one of the one or more diffuser blocks is located in a bottom half of the melting furnace.

73. The apparatus according to any of the above Embodiments, wherein the melting furnace is configured to rotate to a second configuration, wherein at least one of the one or more diffuser blocks is located in a upper half of the melting furnace.

74. The apparatus according to any of the above Embodiments, wherein the melting furnace is configured to heat the copper-based alloy under an enclosed configuration in which an outside atmosphere is excluded from an atmosphere inside the melting furnace above the molten copper-based alloy.

75. The apparatus according to any of the above Embodiments, wherein the outside atmosphere is excluded by an outward flow of the inert gas.

76. The apparatus according to any of the above Embodiments, wherein the melting furnace is configured to rotate into a loading configuration, wherein in the loading configuration, a loading portal of the melting furnace is open and at least one of the one or more diffuser blocks is located in a lower half of the melting furnace.

77. The apparatus according to any of the above Embodiments, wherein the melting furnace is configured to be positioned in a melting configuration, wherein in the melting configuration, a loading portal of the melting furnace is closed and at least one of the one or more diffuser blocks is located near a bottom of the melting furnace.

78. The apparatus according to any of the above Embodiments, wherein the melting furnace is configured to be positioned in a pouring configuration, wherein in the pouring configuration, a pouring portal of the melting furnace is open and at least one of the one or more diffuser blocks is located in a upper half the melting furnace.

79. The apparatus according to any of the above Embodiments, wherein the melting furnace is configured to heat the copper-based alloy under an enclosed chamber configuration in which an outside atmosphere is excluded from an atmosphere above the molten copper-based alloy.

80. The apparatus of any of the above Embodiments, wherein the melting furnace is configured to form the molten copper-based alloy by providing a heat source extending through the central axis.

81. The apparatus of any of the above Embodiments, further comprising a flame injector configured to inject a stream of ignited fuel along the central axis of the melting furnace that serves as the heat source.

82. The apparatus according to any of the above Embodiments, wherein the flame is configured to extend in a direction along the central axis.

83. The apparatus according to any of the above Embodiments, wherein the flame is provided directly above the molten copper-based alloy.

84. The apparatus according to any of the above Embodiments, wherein the fuel comprises a hydrocarbon fuel.

85. The apparatus according to any of the above Embodiments, wherein the fuel comprises a natural gas.

86. The apparatus according to any of the above Embodiments, wherein the fuel comprises oxygen.

87. The apparatus according to any of the above Embodiments, further comprising an exhaust outlet connected to the chamber of the melting furnace configured to vent an exhaust of the ignited fuel from the chamber.

88. The apparatus according to any of the above Embodiments, wherein the flame injector is disposed at a first end of the melting furnace, and the exhaust portal is disposed at a second end of the melting furnace opposite to the first end.

### Additional Examples VIII

1. A method of manufacturing a copper-based alloy, the method comprising:
providing in a melting furnace a feedstock having a composition configured to form a molten copper-based alloy comprising at least 50 weight % copper, wherein the melting furnace is configured to rotate around a central axis;
heating the feedstock to melt the feedstock to form the molten copper-based alloy; and
bubbling an inert gas through the molten copper-based alloy using one or more diffuser blocks comprising a porous diffusing material.

2. A method of manufacturing a copper-based alloy, the method comprising:
providing in a melting furnace a feedstock having a composition configured to form a molten copper-based alloy comprising at least 50 weight % copper;
rotating the melting furnace such that the one or more diffuser blocks are positioned under the feedstock;
heating the feedstock to melt the feedstock to form the molten copper-based alloy; and
bubbling an inert gas through the molten copper-based alloy.

3. A method of manufacturing a copper-based alloy, the method comprising:
providing in a chamber of a melting furnace a feedstock having a composition configured to form a molten copper-based alloy comprising at least 50 weight % copper,
injecting a stream of flame along a central axis of the melting furnace to heat and melt the feedstock to form the molten copper-based alloy; and
bubbling an inert gas through the molten copper-based alloy.

4. The method according to any of the above Embodiments, further comprising rotating the melting furnace such that the one or more diffuser blocks are positioned to be under the feedstock.

5. The method according to any of the above Embodiments, further comprising bubbling an inert gas through the molten copper-based alloy using one or more diffuser blocks comprising a porous diffusing material or a porous structure.

6. The method according to any of the above Embodiments, wherein an atmosphere above the molten copper-based alloy is substantially inert.

7. The method according to any of the above Embodiments, wherein the inert gas consists essentially of noble gas or nitrogen.

8. The method according to any of the above Embodiments, wherein the inert gas consists essentially of argon.

9. The method according to any of the above Embodiments, wherein the inert gas is essentially hydrogen and moisture free.

10. The method according to any of the above Embodiments, wherein the porous diffusing material or the porous structure have a porosity greater than 20%.

11. The method according to any of the above Embodiments, wherein the porous diffusing material or the porous structure comprises alumina, silica, an aluminum-silicate ceramic, or Cr₂O₃.

12. The method according to any of the above Embodiments, wherein providing the feedstock comprises providing a plurality of feedstock pieces having a combined composition configured to form the molten copper-based alloy.

13. The method according to any of the above Embodiments, further comprising, prior to heating, flowing the inert gas through gaps between the plurality of feedstock pieces.

14. The method according to any of the above Embodiments, wherein heating comprises heating the plurality of feedstock pieces while flowing the inert gas therethrough, thereby melting the feedstock pieces to form the molten copper-based alloy.

15. The method according to any of the above Embodiments, further comprising heating the molten copper-based alloy with an outside atmosphere excluded from an atmosphere above the molten copper-based alloy.

16. The method according to any of the above Embodiments, wherein the outside atmosphere is excluded by an outward flow of the inert gas.

17. The method according to any of the above Embodiments, further comprising maintaining a pressure of the inert gas inside the melting furnace substantially higher than a pressure of the inert gas outside the melting furnace.

18. The method according to any of the above Embodiments, further comprising heating the molten copper-based alloy under an enclosed chamber configuration in which an atmosphere above the molten copper-based alloy is isolated from an outside atmosphere.

19. The method according to any of the above Embodiments, wherein the one or more diffuser blocks comprises two or more diffuser blocks.

20. The method according to any of the above Embodiments, wherein two of the two or more diffuser blocks are spaced apart in a first direction by a first distance wherein the first distance is at least 30% of a length of the furnace chamber measured in the first direction.

21. The method according to any of the above Embodiments, wherein the two or more diffuser blocks comprises four diffuser blocks.

22. The method according to any of the above Embodiments, wherein the one or more diffuser blocks directly contacts a bottom surface of the molten copper-based alloy.

23. The method according to any of the above Embodiments, wherein bubbling an inert gas through the molten copper-based alloy further comprises positioning the porous diffusing material or the porous structure in direct contact with a bottom surface of the molten copper-based alloy, thereby bubbling the inert gas through the bottom surface of the molten copper-based alloy.

24. The method according to any of the above Embodiments, wherein bubbling an inert gas through the molten copper-based alloy further comprises positioning the porous diffusing material or the porous structure in direct contact with an atmosphere above the molten copper-based alloy, thereby flowing the inert gas directly into an atmosphere above the molten copper-based alloy.

25. The method according to any of the above Embodiments, further comprising submerging all of the one or more diffuser blocks under the molten copper-based alloy while bubbling the inert gas diffused therethrough.

26. The method according to any of the above Embodiments, wherein bubbling the inert gas into the molten copper-based alloy further comprises bubbling the inert gas into the molten copper-based alloy while the melting furnace is rotating.

27. The method according to any of the above Embodiments, wherein bubbling an inert gas further comprises bubbling the inert gas through the molten copper-based alloy with a cross-sectional flow area greater than 50% of a cross-sectional area of the molten copper-based alloy in the same horizontal plane.

28. The method according to any of the above Embodiments, further comprising rocking the melting furnace around the central axis while heating the molten copper-based alloy.

29. The method according to any of the above Embodiments, further comprising, prior to providing in the melting furnace the feedstock, pre-heating the melting furnace.

30. The method according to any of the above Embodiments, wherein prior to providing in the melting furnace the feedstock, the melting furnace is pre-heated to a temperature lower than a liquidus temperature of the molten copper-based alloy.

31. The method according to any of the above Embodiments, wherein prior to providing in the melting furnace the feedstock, the melting furnace is pre-heated to a temperature lower than 200° C.

32. The method according to any of the above Embodiments, further comprising, while pre-heating the melting furnace, providing the melting furnace the inert gas such that an inner surface of the melting furnace is heated in a substantially inert environment.

33. The method according to any of the above Embodiments, wherein a rate at which the inert gas is bubbled into the molten copper-based alloy is greater than 1 liter per minute.

34. The method according to any of the above Embodiments, wherein bubbling the inert gas further comprises bubbling the inert gas into the molten copper-based alloy while a temperature of the molten copper-based alloy is at least 50° C. above a liquidus temperature of the molten copper-based alloy.

35. The method according to any of the above Embodiments, further comprising transferring a first portion of the molten copper-based alloy outside of the melting furnace, while a second portion of the molten copper-based alloy inside the melting furnace remains under the substantially inert atmosphere.

36. The method according to any of the above Embodiments, wherein the first portion is from a lower portion of the molten copper-based alloy.

37. The method according to any of the above Embodiments, further comprising cooling the molten copper-based alloy under the substantially inert atmosphere prior to transferring the molten copper-based alloy.

38. The method according to any of the above Embodiments, further comprises bubbling the inert gas into the molten copper-based alloy using the one or more diffuser block while cooling the molten copper-based alloy.

39. The method according to any of the above Embodiments, further comprising flowing the inert gas into the substantially inert atmosphere above the molten copper-based alloy using the one or more diffuser block while cooling the molten copper-based alloy.

40. The method according to any of the above Embodiments, wherein the porous diffusing material or the porous structure of the one or more diffuser blocks are disposed within a container connected to an inert gas source.

41. The method according to any of the above Embodiments, further comprising an inert gas source connected to the one or more diffuser blocks for supplying the inert gas.

42. The method according to any of the above Embodiments, wherein at least one of the one or more diffuser blocks is covered in a diffusive lining comprising a same material as a lining of the melting furnace.

43. The method according to any of the above Embodiments, wherein the one or more diffuser blocks bubble the inert gas through a bottom surface of the molten copper-based alloy by directly contacting the bottom surface of the molten copper-based alloy.

44. The method according to any of the above Embodiments, further comprising flowing the inert gas directly into an atmosphere above the molten copper-based alloy using the one or more diffuser blocks.

45. The method according to any of the above Embodiments, wherein the one or more diffuser blocks comprises two or more diffuser blocks, spaced apart in a first direction by a first distance wherein the first distance is at least 30% of a length of the chamber measured in the first direction.

46. The method according to any of the above Embodiments, wherein the porous diffusing material or the porous structure comprises alumina, silica, or an aluminum-silicate ceramic.

47. The method according to any of the above Embodiments, wherein the porous diffusing material or the porous structure comprises more than 60% alumina.

48. The method according to any of the above Embodiments, wherein the porous diffusing material or the porous structure comprises less than 50% silica.

49. The method according to any of the above Embodiments, wherein the porous diffusing material or the porous structure further comprises Cr₂O₃.

50. The method according to any of the above Embodiments, wherein the porous diffusing material or the porous structure comprises less than 10% Cr₂O₃.

51. The method according to any of the above Embodiments, further comprising heating the molten copper-based alloy under an enclosed chamber configuration in which an atmosphere above the molten copper-based alloy is isolated from an outside atmosphere.

52. The method according to any of the above Embodiments, wherein the inert gas is flowed at a rate of 2-6 liters per minute under the enclosed chamber configuration.

53. The method according to any of the above Embodiments, further comprising heating the molten copper-based alloy under an open chamber configuration in which an atmosphere above the molten copper-based alloy is connected to an outside atmosphere.

54. The method according to any of the above Embodiments, wherein the inert gas is flowed at a rate of 4-13 liters per minute under the open chamber configuration.

55. The method according to any of the above Embodiments, wherein a porosity of the porous diffusing material or the porous structure is 15-40%.

56. The method according to any of the above Embodiments, wherein the porous diffusing material or the porous structure of the one or more diffuser blocks directly contacts the molten copper-based alloy with an effective diffusing area greater than 25 cm².

57. The method according to any of the above Embodiments, wherein the one or more diffuser blocks further comprises a refractory diffuser lining around the porous diffusing material or the porous structure.

58. The method according to any of the above Embodiments, wherein the refractory diffuser lining comprises alumina, silica, or an aluminum-silicate ceramic.

59. The method according to any of the above Embodiments, wherein the refractory diffuser lining and a lining of the melting furnace comprises the same material.

60. The method according to any of the above Embodiments, wherein bubbling the inert gas into the molten copper-based alloy further comprises bubbling the inert gas into the molten copper-based alloy while the melting furnace is rotating.

61. The method according to any of the above Embodiments, wherein a location at which the one or more diffuser blocks bubble an inert gas into the molten copper-based alloy moves while the melting furnace is rotating.

62. The method according to any of the above Embodiments, wherein the one or more diffuser blocks bubble the inert gas into the molten copper-based alloy from at least two locations while the melting furnace is rotating.

63. The method according to any of the above Embodiments, further comprising rocking the melting furnace around the central axis while heating the molten copper-based alloy.

64. The method according to any of the above Embodiments, wherein a maximum angular speed of the rocking is less than 360° per minute.

65. The method according to any of the above Embodiments, wherein an angular range of the rocking is less than 120°.

66. The method according to any of the above Embodiments, further comprising rocking the melting furnace around the central axis while bubbling an inert gas into the molten copper-based alloy.

67. The method according to any of the above Embodiments, wherein a maximum angular speed of the rocking is less than 360° per minute.

68. The method according to any of the above Embodiments, wherein an angular range of the rocking is less than 120°.

69. The method according to any of the above Embodiments, wherein the melting furnace rotates at least 45 degrees around the central axis.

70. The method according to any of the above Embodiments, wherein the melting furnace rotates at least 90 degrees around the central axis.

71. The method according to any of the above Embodiments, wherein the melting furnace is of a cylindrical or barrel shape, and the central axis corresponds to an axis of elongation of the cylindrical or barrel shape.

72. The method according to any of the above Embodiments, wherein providing in the melting furnace the feedstock further comprises providing the feedstock through a loading portal of the melting furnace with a loading door of the loading portal opened.

73. The method according to any of the above Embodiments, wherein providing in the melting furnace the feedstock further comprises covering at least one of the one or more diffuser blocks with the feedstock from above.

74. The method according to any of the above Embodiments, further comprising transferring the molten copper-based alloy through a pouring portal of the melting furnace different from the loading portal.

75. The method according to any of the above Embodiments, wherein providing in a melting furnace a feedstock further comprises positioning the melting furnace in a loading configuration, wherein in the loading configuration, a loading portal of the melting furnace is open and at least one of the one or more diffuser blocks is located in a lower half of the melting furnace.

76. The method according to any of the above Embodiments, wherein heating the feedstock further comprises positioning the melting furnace in a melting configuration, wherein in the melting configuration, a loading portal of the melting furnace is closed, and at least one of the one or more diffuser blocks is located near a bottom of the melting furnace.

77. The method according to any of the above Embodiments, wherein the melting configuration is different from the loading configuration.

78. The method according to any of the above Embodiments, further comprising positioning the melting furnace in a pouring configuration, wherein in the pouring configuration, a pouring portal of the melting furnace is open, and at least one of the one or more diffuser blocks is located in an upper half the melting furnace.

79. The method according to any of the above Embodiments, wherein the pouring configuration is different from the melting configuration.

80. The method according to any of the above Embodiments, wherein the pouring configuration is different from the loading configuration.

81. The method according to any of the above Embodiments, wherein the pouring portal is different from the loading portal.

82. The method according to any of the above Embodiments, wherein at least one of the one or more diffuser blocks is disposed in a side wall of the melting furnace, the side wall extending parallel to the central axis.

83. The method according to any of the above Embodiments, wherein the central axis is a substantially parallel to a ground plane.

84. The method according to any of the above Embodiments, wherein the central axis is horizontal.

85. The method according to any of the above Embodiments, wherein heating the feedstock further comprises heating the feedstock while the melting furnace is rotating.

86. The method according to any of the above Embodiments, further comprising heating the molten copper-based alloy while the melting furnace is rotating.

87. The method according to any of the above Embodiments, wherein bubbling an inert gas through the molten copper-based alloy further comprises bubbling an inert gas through the molten copper-based alloy while the melting furnace is rotating.

88. The method according to any of the above Embodiments, wherein providing in a melting furnace a feedstock further comprises positioning the melting furnace in a loading configuration, wherein in the loading configuration, a loading portal of the melting furnace is open and at least one of the one or more diffuser blocks is located in a lower half of the melting furnace.

89. The method according to any of the above Embodiments, wherein heating the feedstock further comprises positioning the melting furnace in a melting configuration, wherein in the melting configuration, a loading portal of the melting furnace is closed, and at least one of the one or more diffuser blocks is located near a bottom of the melting furnace.

90. The method according to any of the above Embodiments, further comprising positioning the melting furnace in a pouring configuration, wherein in the pouring configuration, a pouring portal of the melting furnace is open, and at least one of the one or more diffuser blocks is located in a upper half the melting furnace.

91. The method according to any of the above Embodiments, further comprising injecting a stream of ignited fuel along a central axis of the melting furnace to heat and melt the feedstock to form the molten copper-based alloy.

92. The method according to any of the above Embodiments, further comprising injecting the stream of ignited fuel at a high pressure or speed such that a flame extends over a substantial length of the chamber.

93. The method according to any of the above Embodiments, further comprising combusting the ignited fuel inside the melting furnace.

94. The method according to any of the above Embodiments, further comprising combusting the ignited fuel in an atmosphere directly above the molten copper-based alloy.

95. The method according to any of the above Embodiments, further comprising combusting the ignited fuel while the melting furnace is rotating.

96. The method according to any of the above Embodiments, further comprising injecting the stream of ignited fuel using a burner through a burner inlet connected to the chamber.

97. The method according to any of the above Embodiments, wherein the fuel comprises a hydrocarbon fuel in a liquid or a gaseous state.

98. The method according to any of the above Embodiments, wherein the fuel comprises a natural gas.

99. The method according to any of the above Embodiments, wherein the fuel comprises oxygen to sustain a combustion.

100. The method according to any of the above Embodiments, further comprising venting an exhaust of the flame from the melting furnace through an exhaust portal.

101. The method according to any of the above Embodiments, wherein an exhaust duct is removably connected to the exhaust portal.

102. The method according to any of the above Embodiments, further comprising forming a substantially inert layer of air immediately above the molten copper-based alloy with the inert gas bubbled into the molten copper-based alloy, separating the flame or the fuel from the molten copper-based alloy.

103. The method according to any of the above Embodiments, further comprising venting an exhaust of the flame from the chamber through an exhaust portal.

104. The method according to any of the above Embodiments, wherein an exhaust duct is removably disposed against the exhaust portal to guide the exhaust away from the chamber.

105. The method according to any of the above Embodiments, further comprising reducing a speed of the exhaust by venting the exhaust into a drop-bottom cavity connected to the exhaust portal, wherein the drop-bottom cavity has a width larger than that of the exhaust portal.

106. The method according to any of the above Embodiments, wherein prior to providing in the melting furnace the feedstock, flowing the inert gas into the melting furnace.

107. The method according to any of the above Embodiments, further comprising flowing the inert gas into the melting furnace while heating the feedstock to melt the feedstock.

108. The method according to any of the above Embodiments, further comprising flowing the inert gas through the feedstock while heating the feedstock to melt the feedstock.

109. The method according to any of the above Embodiments, wherein providing in the melting furnace the feedstock comprises providing a plurality of feedstock pieces having a combined composition configured to form the molten copper-based alloy and flowing the inert gas through gaps between the feedstock pieces prior to heating.

110. The method according to Embodiment 109, further comprising, prior to heating, flowing the inert gas through gaps between the feedstock pieces.

111. The method according to Embodiment 109 or 110, and wherein heating comprises heating the feedstock pieces while flowing the inert gas therethrough.

112. The method according to any one of the above Embodiments, wherein the method further comprises, after bubbling the inert gas through the molten copper-based alloy, transferring the molten copper-based alloy into a transfer ladle.

113. The method according to any one of Embodiments 109-112, wherein one or more of heating the feedstock pieces, bubbling the inert gas and transferring the molten copper-based alloy is performed at least partly under an enclosed inert atmosphere configured to substantially exclude outside air from mixing with the enclosed inert atmosphere.

114. The method according to any one of the above Embodiments, wherein the method is further according to any one of Embodiments in Additional Examples II.

115. The method according to any one of the above Embodiments, wherein the method is further according to any one of Embodiments in Additional Examples VI.

### ADDITIONAL CONSIDERATIONS

Unless the context clearly requires otherwise, throughout the description and the claims, the words “comprise,” “comprising,” “include,” “including” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number, respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or whether these features, elements and/or states are included or are to be performed in any particular embodiment.

While certain embodiments have been described, these embodiments have been presented by way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and acts of the various embodiments described above can be combined to provide further embodiments. The various features and processes described above may be implemented independently of one another, or may be combined in various ways. All possible combinations and subcombinations of features of this disclosure are intended to fall within the scope of this disclosure.

In addition, unless otherwise specified, none of the steps of the methods of the present disclosure are confined to any particular order of performance. Modifications of the disclosed examples incorporating the spirit and substance of the disclosure may occur to persons skilled in the art and such modifications are within the scope of the present disclosure. Furthermore, all references cited herein are incorporated by reference in their entirety.

While the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various examples described and the appended claims. Further, the disclosure herein of any particular feature, aspect, method, property, characteristic, quality, attribute, element, or the like in connection with an example can be used in all other examples set forth herein. Any methods disclosed herein need not be performed in the order recited. Depending on the example, one or more acts, events, or functions of any of the algorithms, methods, or processes described herein can be performed in a different sequence, can be added, merged, or left out altogether (e.g., not all described acts or events are necessary for the practice of the method). In some examples, acts or events can be performed concurrently. Further, no element, feature, block, or step, or group of elements, features, blocks, or steps, are necessary or indispensable to each example. Additionally, all possible combinations, subcombinations, and rearrangements of systems, methods, features, elements, modules, blocks, and so forth are within the scope of this disclosure. The use of sequential, or time-ordered language, such as “then,” “next,” “after,” “subsequently,” and the like, unless specifically stated otherwise, or otherwise understood within the context as used, is generally intended to facilitate the flow of the text and is not intended to limit the sequence of operations performed. Thus, some examples may be performed using the sequence of operations described herein, while other examples may be performed following a different sequence of operations.

The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 1 V” includes “1 V.” Numbers not preceded by a term such as “about” or “approximately” may be understood to based on the circumstances to be as accurate as reasonably possible under the circumstances, for example ±5%, ±10%, ±15%, etc. For example, “1 V” includes “0.9-1.1 V.” Phrases preceded by a term such as “substantially” include the recited phrase and should be interpreted based on the circumstances (e.g., as much as reasonably possible under the circumstances). For example, “substantially perpendicular” includes “perpendicular.” Unless stated otherwise, all measurements are at standard conditions including temperature and pressure. The phrase “at least one of” is intended to require at least one item from the subsequent listing, not one type of each item from each item in the subsequent listing. For example, “at least one of A, B, and C” can include A, B, C, A and B, A and C, B and C, or A, B, and C.

What is claimed is:

1. An apparatus for manufacturing a copper-based alloy, the apparatus comprising:
a melting furnace configured to form a molten copper-based alloy comprising at least 50 weight % copper, wherein the melting furnace is configured to rotate around a central axis, and
one or more diffuser blocks comprising a porous diffusing material adapted for bubbling an inert gas through the molten copper-based alloy.

2. The apparatus of claim 1, wherein the melting furnace is configured to have an enclosed atmosphere that is substantially inert.

3. The apparatus of claim 1, wherein the inert gas is essentially free of hydrogen and moisture.

4. The apparatus of claim 1, wherein the melting furnace has a cylindrical or a barrel shape having the central axis extending in a lengthwise direction thereof.

5. The apparatus of claim 1, wherein the melting furnace is configured to heat the copper-based alloy under an enclosed chamber configuration in which an outside atmosphere is excluded from an atmosphere above the molten copper-based alloy.

6. The apparatus of claim 1, wherein the melting furnace is configured to form the molten copper-based alloy by providing a heat source extending through the central axis.

7. The apparatus of claim 1, wherein the porous diffusing material comprises one or more of alumina, silica, an aluminum-silicate ceramic and Cr₂O₃.

8. An apparatus for manufacturing a copper-based alloy, the apparatus comprising:
a melting furnace configured to form a molten copper-based alloy comprising at least 50 weight % copper, wherein the melting furnace is configured to rotate around a central axis extending in a lengthwise direction of the melting furnace; and
one or more diffuser blocks adapted for bubbling an inert gas through the molten copper-based alloy in a direction crossing the central axis.

9. The apparatus of claim 8, wherein the melting furnace is configured to melt the copper-based alloy under an enclosed chamber configuration in which an atmosphere above the molten copper-based alloy is substantially isolated from an outside atmosphere.

10. The apparatus of claim 8, wherein the one or more diffuser blocks are configured to bubble the inert gas from a bottom region of the molten copper-based alloy in direct contact with the one or more diffuser blocks.

11. The apparatus of claim 8, wherein the one or more diffuser blocks are configured to flow the inert gas diffused through the molten copper-based alloy directly into an atmosphere above the molten copper-based alloy.

12. The apparatus of claim 8, wherein the melting furnace is configured to heat the copper-based alloy under an enclosed chamber configuration in which an outside atmosphere is substantially excluded from an atmosphere above the molten copper-based alloy.

13. The apparatus of claim 8, wherein the melting furnace is configured to form the molten copper-based alloy by providing a heat source extending through the central axis.

14. The apparatus of claim 8, wherein the one or more diffuser blocks comprises a porous structure adapted for bubbling an inert gas through the molten copper-based alloy.

15. An apparatus for manufacturing a copper-based alloy, the apparatus comprising:
a melting furnace configured to form a molten copper-based alloy comprising at least 50 weight % copper;
a flame injector configured to direct a stream of flame along a central axis of the melting furnace that serves as a heat source for forming the molten copper-based alloy; and
one or more diffuser blocks comprising a porous structure adapted for bubbling an inert gas through the molten copper-based alloy.

16. The apparatus of claim 15, wherein an atmosphere enclosed by the melting furnace is configured to be substantially inert.

17. The apparatus of claim 15, wherein the inert gas consists essentially of argon.

18. The apparatus of claim 15, wherein the melting furnace has a cylindrical or a barrel shape having the central axis extending in a lengthwise direction thereof.

19. The apparatus of claim 15, wherein the melting furnace is configured to heat the copper-based alloy under an enclosed chamber configuration in which an outside atmosphere is substantially excluded from an atmosphere above the molten copper-based alloy.

20. The apparatus of claim 15, wherein the stream of flame is generated by an ignited stream of natural gas.
